(19) United States
(12) Patent Application Publication
(10) Pub. No.: US 2026/0339435 A1
(43) Pub. Date: Oct. 29, 2026

(54) GESTURE DETECTION ON HELD OBJECTS AND DIGIT-TO-DIGIT GESTURE EQUIVALENCE USING BIOPOTENTIAL-SIGNAL SENSORS OF A WRIST-WEARABLE DEVICE, AND SYSTEMS AND METHODS OF USE THEREOF

(71) Applicant: Meta Platforms Technologies, LLC, Menlo Park, CA (US)

(72) Inventors: Emanuele Formento, San Francisco, CA (US); Diego Adrian Gutnisky, San Francisco, CA (US); Shaker Monirul Islam, Brooklyn, NY (US); Ken Brian Koh, Foster City, CA (US); Jesse Duncan Marshall, Brookline, MA (US); Najja Marshall, New York, NY (US); Niru Nahesh, Menlo Park, CA (US); David Sussillo, Portola Valley, CA (US); Peter Walkington, Brooklyn, NY (US); Claire Warriner, Brooklyn, NY (US)

(21) Appl. No.: 19/650,251

(22) Filed: Apr. 16, 2026

Related U.S. Application Data
(60) Provisional application No. 63/794,292, filed on Apr. 24, 2025.
(60) Provisional application No. 63/980,739, filed on Feb. 11, 2026.

(51) Int. Cl. G06F 3/01; G06F 3/042; G06F 3/16

(52) U.S. Cl. CPC G06F 3/015; G06F 3/017; G06F 3/0425; G06F 3/16

(57) ABSTRACT

An example method includes, while a hand of a user is holding a physical object having a surface, in accordance with determining, using data from one or more biopotential-signal sensors of a wrist-wearable device worn by the user, that the user is performing a gesture on the surface, causing performance of an action at the wrist-wearable device. And the example method further includes, in accordance with a determination, using additional data from the one or more biopotential-signal sensors of the wrist-wearable device worn by the user, that the user is performing a digit-to-digit gesture using the hand, causing performance of the action at the wrist-wearable device or the communicatively coupled device.

### CROSS-REFERENCE TO RELATED APPLICATIONS

This application claims priority to U.S. Provisional Patent Application No. 63/794,292, entitled “Wearable Devices for Detecting Subtle Gestures Performed During Different States, and Systems and Methods of Use Thereof”, filed Apr. 24, 2025, and U.S. Provisional Patent Application No. 63/980,739, entitled “Wearable Devices for Detecting Subtle Gestures Performed During Different States, and Systems and Methods of Use Thereof”, filed Feb. 11, 2026, both of which are hereby incorporated by reference in their entirety.

### TECHNICAL FIELD

This relates generally to subtle gesture detection at wearable devices, and more specifically, wearable devices that detect subtle gestures based on low-movement isometric finger flexion or finger taps on an object.

### BACKGROUND

Augmented-reality devices have grown in popularity and augmented-reality experiences have expanded into more aspects of life. There is a need for augmented-reality devices that are able to keep up with busy lives of users and augmented-reality experiences that are available to users while the users interact with their physical surroundings.

As such, there is a need to address one or more of the above-identified challenges. A brief summary of solutions to the issues noted above are described below.

### SUMMARY

The systems and methods disclosed herein provide subtle gesture detection. For example, the systems and methods disclosed herein detect low-movement thumb, index finger, and middle finger pulsed-flexion clicks (single, double, or press-and-hold events) that can be performed discreetly whether at rest, on-the-go, or when a user's hands are busy holding an object. The systems and methods disclosed herein allow for a user to perform subtle gestures that are socially acceptable compared to overt gestures such as pinches or thumb swipes (e.g., in-air hand gestures, unencumbered hand gestures, digit-to-digit gestures that include contact between two respective digits of a user's hand). For example, the systems and methods disclosed herein allow a user to privately and/or discretely perform subtle gestures to interact with their devices (and/or augmented reality user interfaces) when overt gestures would be uncomfortable or distracting to perform (e.g., when a user is in a public setting, profession event, public event, engaged in a background activity like jogging, etc.). Additionally, the systems and methods disclosed herein allow a user to perform (subtle) gestures when their hands are not available to perform overt gestures because they are holding an object such as a coffee cup (e.g., hand encumbered). In particular, the systems and methods disclosed herein allow the user to perform hands-encumbered interactions (e.g., operations performed while holding objects) to allow users to interact with their devices and/or augmented reality interfaces using alternative methods that minimize the users'required digit movement for performing hand gestures. In some embodiments, subtle gestures require less movement of one or more digits of the user than corresponding overt gestures.

The system and method disclosed herein utilize one or more neuromuscular-signal sensors to detect neuromuscular signals without requiring a user to make overt movements, in accordance with some embodiments. For example, some systems and methods disclosed herein can detect neuromuscular signals when a user applies a force against a surface resulting in muscle activation without changes in muscle length or joint angle (isometric contraction). Similarly, the systems and methods disclosed herein can detect neuromuscular signals when a user holds an object resulting in finger flexor muscles to activate to close the fingers around the object (flexion) at a force level proportional to the weight of the object. While the user holds an object, application of brief pulses of additional forces with the thumb, index finger, middle finger, and/or other fingers of the user can result in the generation of neuromuscular signals (with little to no movement (e.g., isometric flexion)) that are detectable by the systems and methods disclosed herein, allowing for discreet device interaction without compromising the user's grip on the object. In some embodiments, the systems and methods disclosed herein can similarly detect neuromuscular signals when a user maintains a loose fist (in the absence of holding an object) for discreet interactions (e.g., finger flexion is subtly and comfortably performed by pressing into the hand itself).

The systems and methods disclosed herein provide simple, ready-to-use controls that allow users to interact with augmented reality devices by leveraging, for example, isometric flexion in situations that require subtlety, such as when a user is engaged in background activity, and/or when a user's hands are encumbered (e.g. holding objects, carrying bags, or otherwise unable to perform overt gestures). For example, the systems and methods disclosed herein allow for the detection of subtle single press, double press, or press-and-hold flexion events of the thumb, index finger, middle finger, and/or other fingers that can be performed when a user's hand is empty or encumbered. In some embodiments, subtle gestures can include sequences of pulses of neuromuscular activity above a baseline level that match predetermined temporal patterns. Such temporal patterns can be effector-agnostic, meaning the sequences are detectable regardless of which finger or wrist muscle of the user generates the pulses, allowing users to select which muscles to activate depending on preference and context. In some embodiments, the subtle detection of gestures is time-boxed to a particular scenario and/or potentially gated by AR context cues as discussed below. In some embodiments, gesture detection can be based on detecting sequences of pulses of neuromuscular activity that match predetermined temporal patterns. The length and complexity of such temporal patterns can be configured based on false positive requirements of different applications. For example, applications requiring higher security or accuracy may utilize longer or more complex temporal patterns, while applications with lower false positive requirements may utilize shorter or simpler patterns.

One example of a method for subtle gesture detection is described herein. The method includes detecting a first set of neuromuscular signals via one or more neuromuscular-signal sensors of a wearable device that is donned on a body portion of a user. The method includes, in accordance with a first indication, based on the first set of neuromuscular signals, that the body portion of the user is in a first state, monitoring a second set of neuromuscular signals via the one or more neuromuscular-signal sensors of the wearable device. The method includes, in accordance with a determination that i) the second set of neuromuscular signals satisfy a gesture detection threshold and ii) one or more situational criteria are satisfied, detecting a gesture performed by the user and transmitting instructions associated with the gesture to at least one communicatively coupled device. The method further includes in accordance with a second indication, based on the second set of neuromuscular signals, that the body portion of the user is in a second state, ceasing to monitor the second set of neuromuscular signals.

Another example method of performing object-type based interactions with held or otherwise hand-encumbering objects is described herein. The method includes, while a hand of a user is holding a first object, determining, using data from a camera of a head-worn device, a first object type for the first object. The method includes, causing presentation via the head-worn device, of a first action associated with the first object type. The method includes, in response to an indication, based on data from a wrist-wearable device, that the user performed a gesture using the hand that is holding the first object, cause execution of the first action. The method includes, while the hand of the user is holding a second object distinct from the first object, determining, using other data from the camera of the head-worn device, a second object type for the second object, the second object type being distinct from the first object type. The method further includes causing presentation via the head-worn device, of a second action associated with the second object type. And the method further includes, in response to an indication, based on data from the wrist-wearable device, that the user performed the gesture using the hand that is holding the second object, cause execution of the second action.

Another example method of performing gestures directed to held objects that correspond to respective digit-to-digit gestures is described herein. The method includes, while a hand of a user is holding a physical object having a surface, in accordance with a determination, using data from one or more biopotential-signal sensors of a wrist-wearable device worn by the user, that the user is performing a gesture on the surface, causing performance of an action at the wrist-wearable device or a communicatively coupled device. And the method includes, in accordance with a determination, using additional data from the one or more biopotential-signal sensors of the wrist-wearable device worn by the user, that the user is performing a digit-to-digit gesture using the hand, causing performance of the same action at the wrist-wearable device or the communicatively coupled device.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1C illustrate a system for detecting subtle gestures performed by a user donning a wearable device, in accordance with some embodiments.

FIGS. 2A-2H illustrate example subtle gestures detected by a subtle gesture detection system, in accordance with some embodiments.

FIGS. 3A-3F illustrate a system for detecting subtle gestures performed by a user donning a wearable device and engaging in a physical activity, in accordance with some embodiments.

FIGS. 4A-4E illustrate a system for detecting subtle gestures performed by a user donning a wearable device and while encumbered, in accordance with some embodiments.

FIG. 5 shows an example method flow chart for detecting subtle gestures via a wearable device worn by a user, in accordance with some embodiments.

FIGS. 6A-6E illustrate a sequence of interactions by a user interacting with a computing system via gestures directed to an object having a first example object type, in accordance with some embodiments.

FIGS. 7A-7D illustrate an example sequence of interactions by a user interacting with a computing system via gestures directed to another object having a second example object type, in accordance with some embodiments.

FIGS. 8A-8D illustrate an example sequence of interactions by a user with a computing system via gestures directed to an object, in accordance with some embodiments.

FIGS. 9A-9E illustrate an example sequence of interactions by a user with a computing system via gestures directed to an object, in accordance with some embodiments.

FIGS. 10A-10D show example method flow charts for executing actions associated with an identified object type of an object held in the hand of a user, based on user performance of a gesture, in accordance with some embodiments.

FIGS. 11A, 11B, 11C-1, and 11C-2 illustrate example MR and AR systems, in accordance with some embodiments.

In accordance with customary practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with diverse types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and/or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single-or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are several types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors (used interchangeably with neuromuscular-signal sensors); (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

The systems and methods described below allow a user to interact with their AR devices through the use of subtle gestures. The subtle (hand) gestures generate detectable neuromuscular signals based on muscle activation without changes to the muscle length and/or joint angle. Unlike overt movements, such as pinches (e.g., finger-thumb contact, finger-palm contact, etc.) swipe gestures, etc., subtle gestures can be performed discreetly.

An example scenario in which the systems and methods described herein can be used includes a newly promoted executive juggling off-site client meetings with managing her team at the home office. In this scenario, the system and method disclosed herein allow the newly promoted executive to monitor incoming notifications in real time without interrupting her current meeting. Example controls in this scenario include expanding incoming text messages to read more, discreetly rejecting a call that comes at an inopportune time, sending suggested text responses, etc.

Another example scenario in which the systems and methods described herein can be used includes a home cook preparing a meal can have her hands occupied with tools, utensils, or ingredients while being read and/or viewing a recipe presented by a wearable device. In this scenario, the system and method disclosed herein allow the home cook to pause and/or rewind the presented content. Example controls in this scenario include quickly accessing (e.g., starting/stopping) kitchen timers, accessing conversion tables for common kitchen units, viewing images of a completed dish, etc.

In yet another example scenario in which the systems and methods described herein can be used includes a fitness enthusiast in the middle of a workout with their hands occupied with weights or other gym equipment. In this scenario, the system and method disclosed herein allow the fitness enthusiast to pause and/or stop their workout, change music, log an exercise, etc. Example controls in this scenario include quickly accessing to workout routines, pulling up, or dismissing health metrics, capturing workout segments such as laps/repetitions.

In a further example scenario in which the systems and methods described herein can be used includes a traveler navigating an unfamiliar airport, train station, or destination with their hands occupied with luggage and travel documents. In this scenario, the system and method disclosed herein allow the traveler to quickly access language translations, pull up, or dismiss directions, check on flight status, etc.

The systems and methods described disclosed herein allow for detection of subtle gestures, on-the-go gestures, and/or encumbered hands gestures. Subtle detection of gestures can include a hand resting palm-down on a thigh while seated, a hand resting against a thigh while standing, a hand in a loose fist while seated, and/or a hand in a loose fist while standing. On-the-go detection of gestures can include a loose fist at a side while waking, a loose fist in front of a user while jogging, and/or a loose fist while looking at a wrist-wearable device or other wearable device. Encumbered hands detection of gestures can include the user holding a small-weight object in their hand (e.g. pen, keys, coins, candy, a flower, etc.), the user holding a medium-weight object in their hand or a power grip (e.g. objects less than a predetermined weight (e.g., 2 lbs, 4 lbs, 5 lbs, etc.), such as a coffee cup, an umbrella, trekking/skiing poles, a tote bag, a tennis racket, etc.), the user holding a heavy-weight object in their hand or a power grip (e.g. objects greater than the predetermined weight, such as grocery bags, a car seat, training weights, etc.), the user using their hands for body support (e.g., riding a bike, doing pull-ups, holding a subway pole, etc.), and/or the user doing a dynamic background activity (e.g., serving a tennis ball, mountain biking, walking an unruly dog, etc.). The different detection methods are described in detail below.

### Subtle Gesture Detection

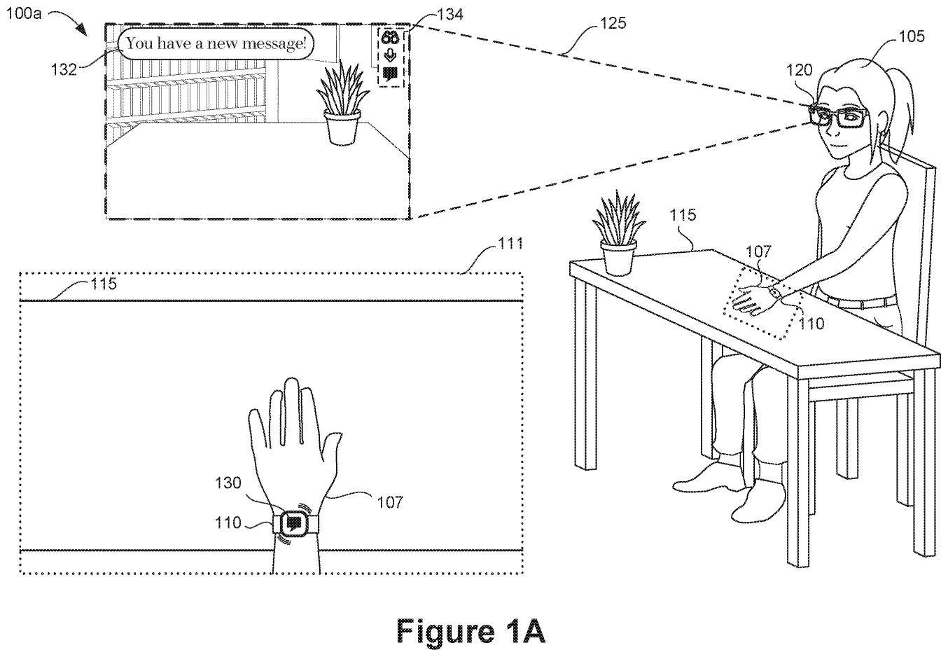

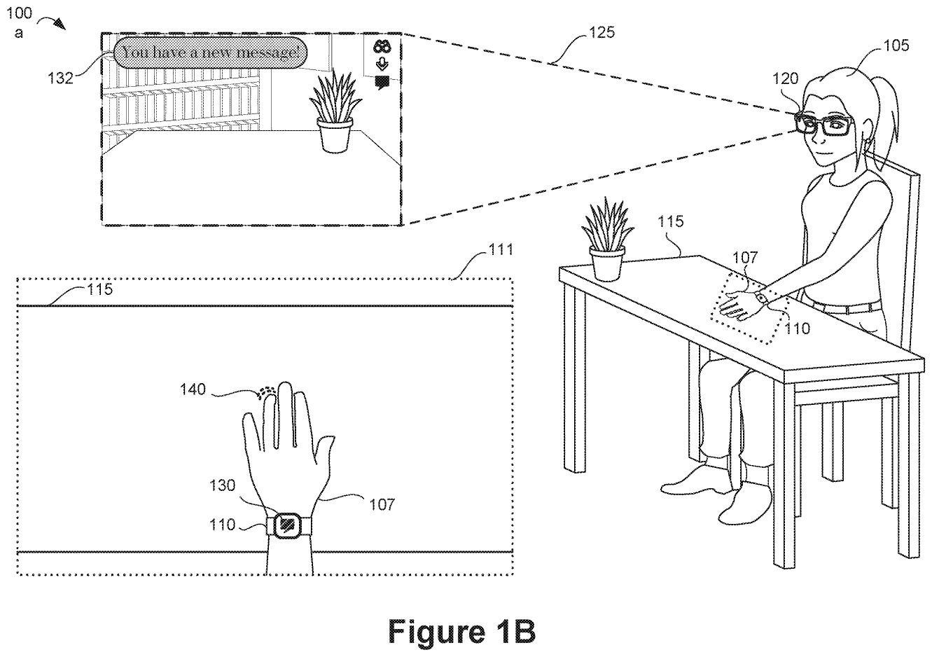

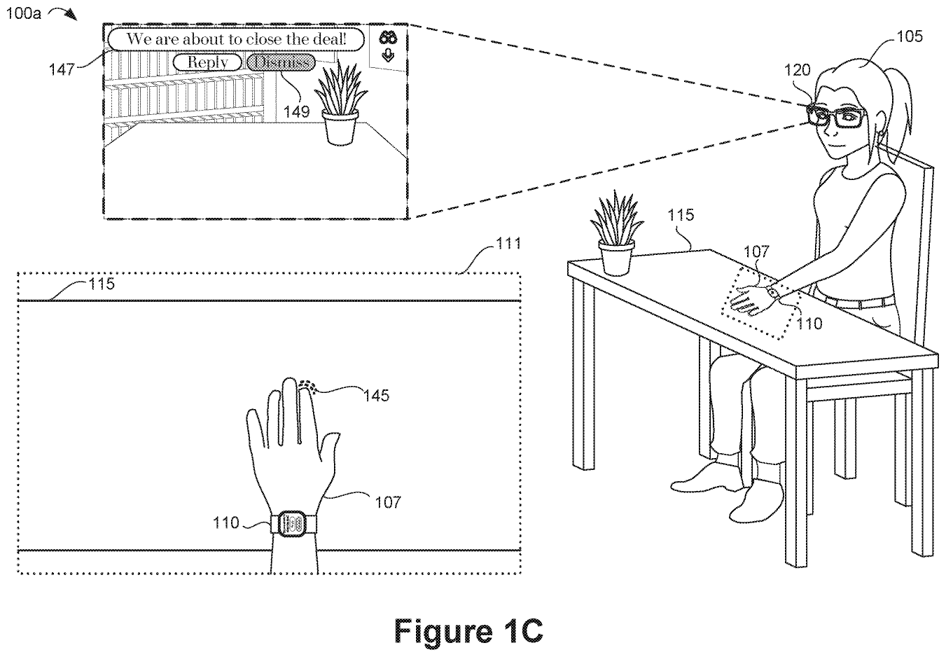

FIGS. 1A-1C illustrate a system for detecting subtle gestures performed by a user donning a wearable device, in accordance with some embodiments. The subtle gesture detection system 100 allows for the detection of subtle gestures performed by a user 105 wearing or donning one or more wearable devices. Subtle gestures, as described herein, in some embodiments, are imperceptible or nearly imperceptible movements (or isometric muscular actions) of a portion of the body of the user 105 that are associated with one or more executable controls. An imperceptible or nearly imperceptible movement includes little or no movement of a portion of the body (e.g., an isometric flexion) of the user 105 that generates detectable signals for use in discreet device interaction, as described in detail below. In some embodiments, the subtle gestures are an extension of, and/or an alternative to, the hand gestures described above. For example, in-air gestures, surface-contact gestures, and/or other gestures that can be detected and determined based on movements of a hand can be performed as subtle gestures.

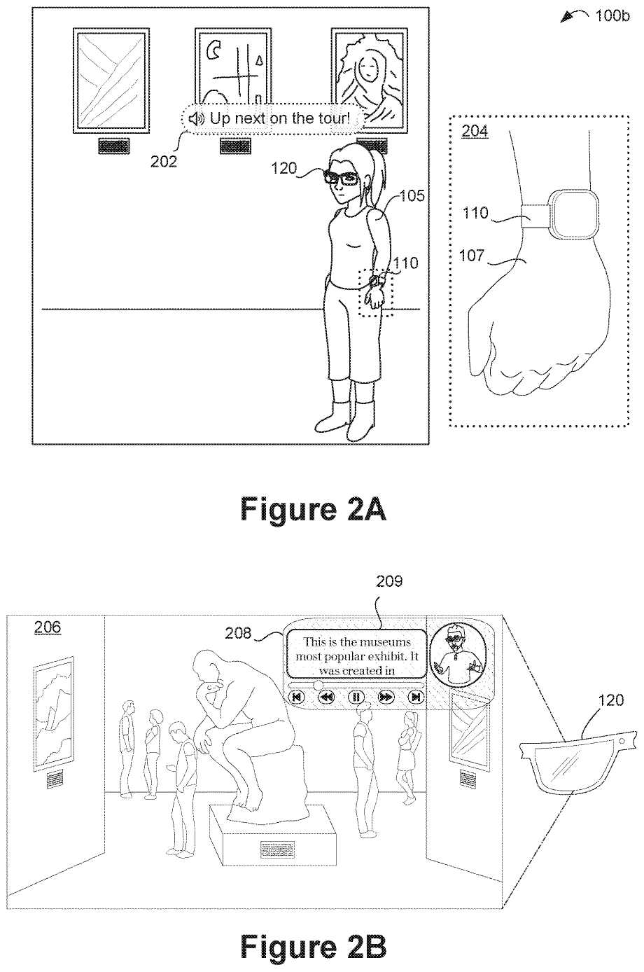

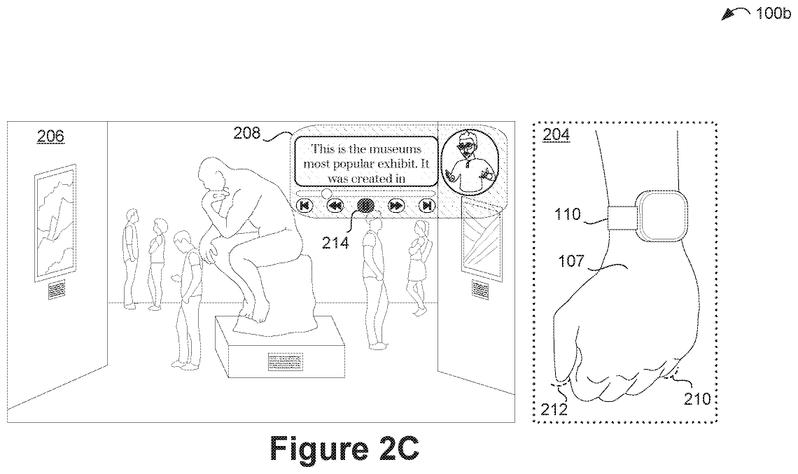

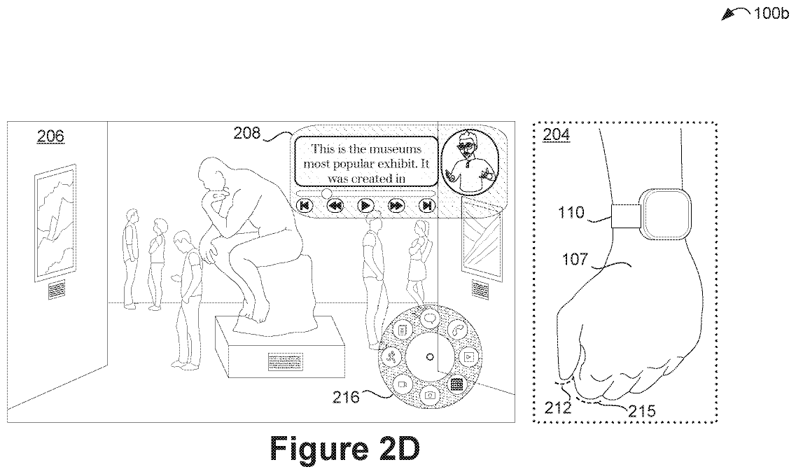

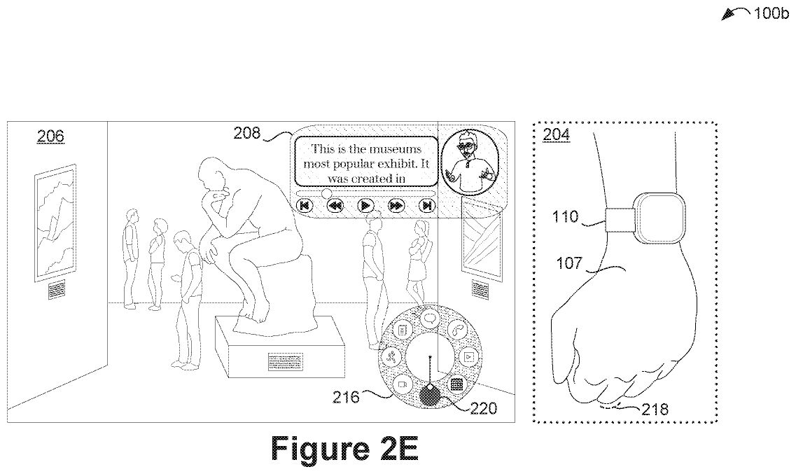

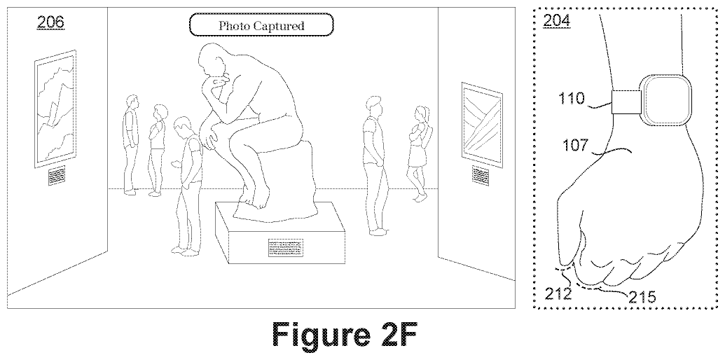

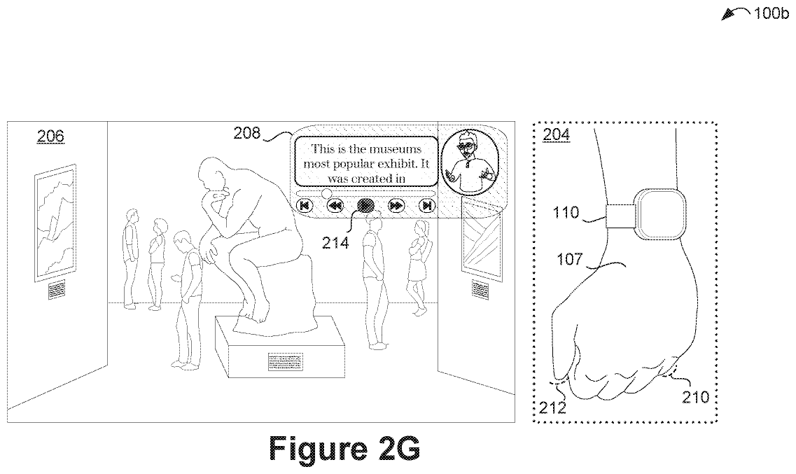

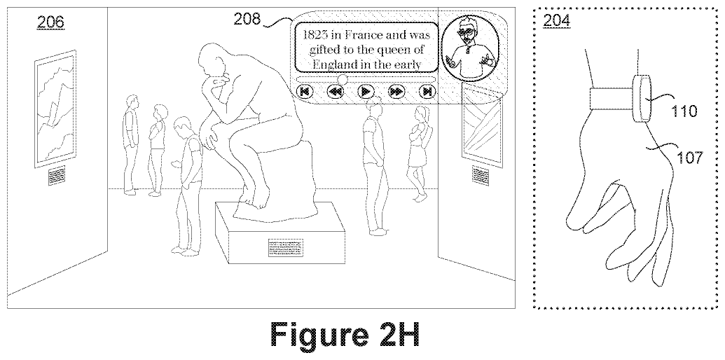

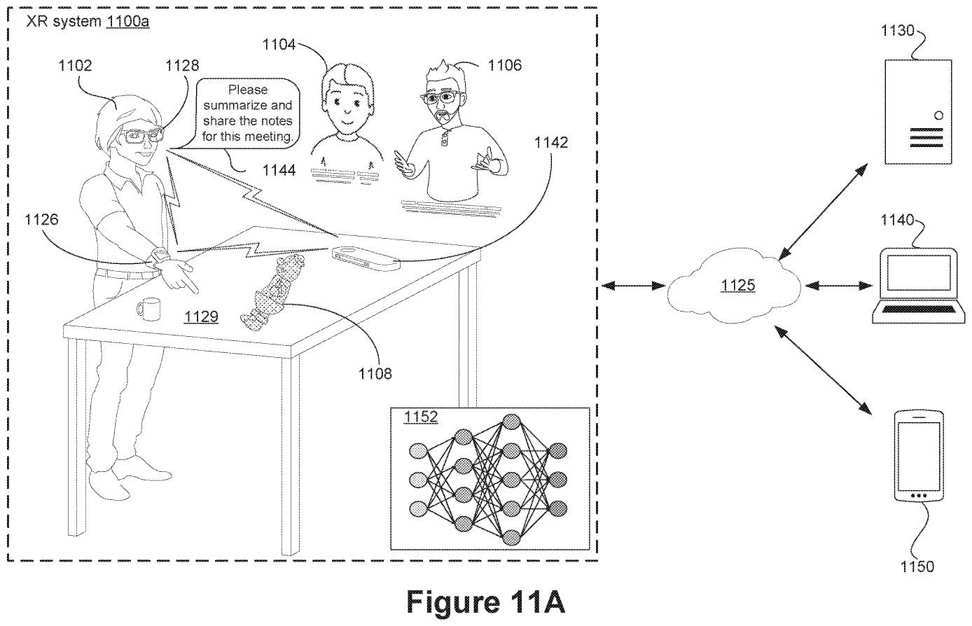

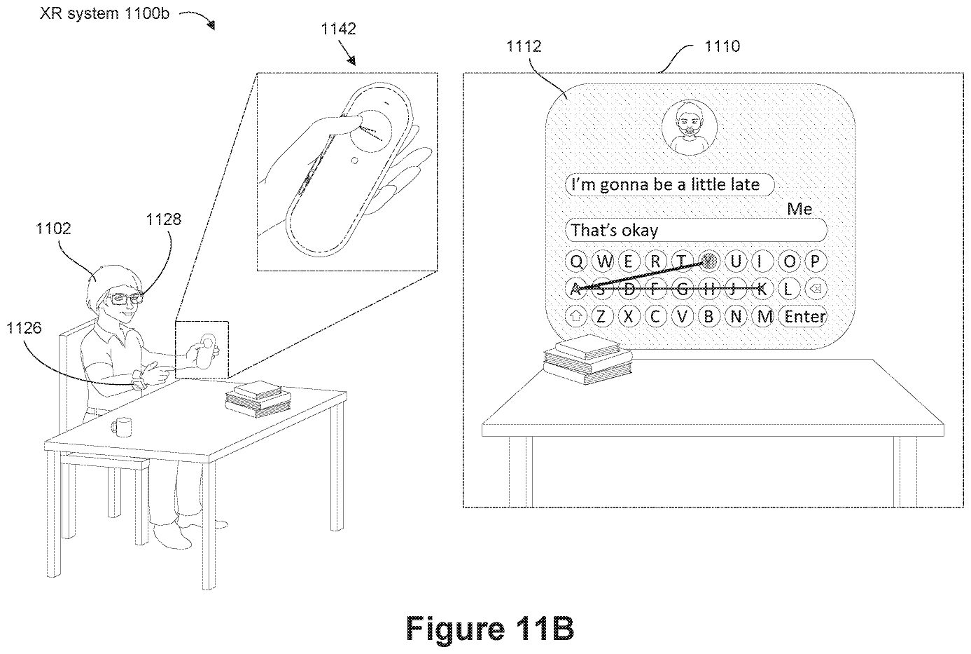

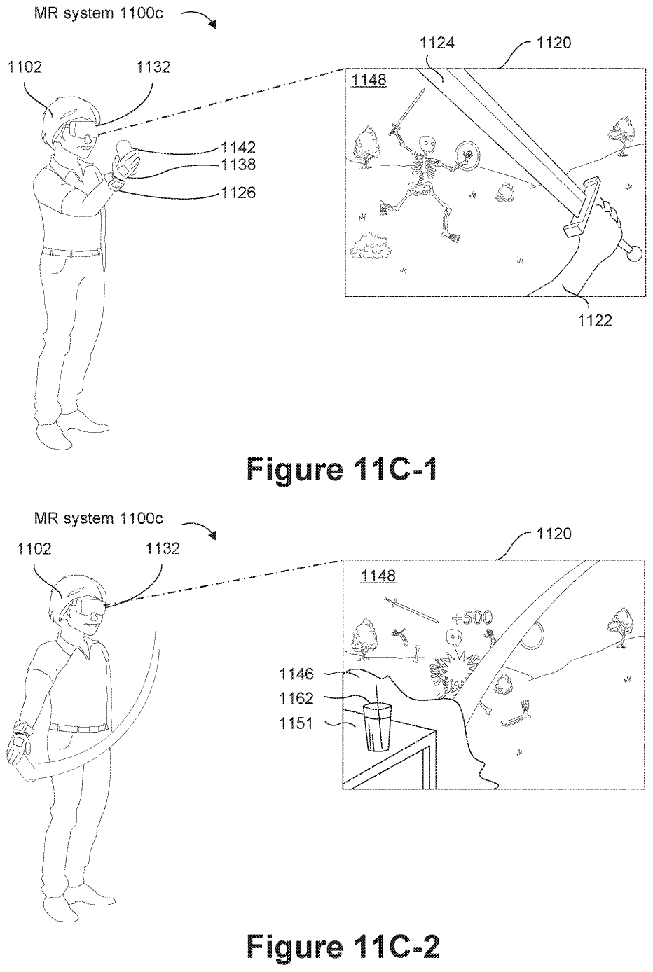

The subtle gesture detection system 100 can include one or more wearable devices worn or donned by a user 105. For example, as shown in FIGS. 1A-1C, the subtle gesture detection system 100 shows the user 105 is donning a wrist-wearable device 110 and a head-wearable device 120. The subtle gesture detection system 100 can be part of any AR system and/or MR system described below in reference to FIGS. 11A-11C-2. For example, the subtle gesture detection system 100 can include a wrist-wearable device 1126 and/or a head-wearable device (e.g., AR device 1128) donned by the user 105, as well as an HIPD 1142, a computer 1140, a mobile device 1150, and/or other electronic devices described herein. In some embodiments, each of the electronic devices are communicatively coupled via network (e.g., network 1125; FIG. 11A).

Turning to FIG. 1A, the user 105 is at a table 115 while wearing the wrist-wearable device 110 and the head-wearable device 120. The user 105 has their hand 107 on table 115, as shown by magnified view 111. FIG. 1A also shows a representation of a field-of-view 125 of the user 105 through the head-wearable device 120. In some embodiments, the head-wearable device 120 presents one or more icons 134 to inform the user 105 of one or more active components. For example, the one or more icons 134 include a glasses icon to inform the user 105 that an imaging device of the head-wearable device 120 is active, a microphone icon to inform the user 105 that a microphone is active, and a message icon to inform the user 105 that a message was received. Additionally, messages received at the wrist-wearable device 110, the head-wearable device 120, a mobile device (not shown), and/or another one of the user 105's electronic devices can be represented as a notification at the wrist-wearable device 110 (e.g., wrist-wearable device message notification 130), the head-wearable device 120 (e.g., head-wearable device message notification 132), and/or other communicatively coupled device.

The user 105 is shown in a public setting, such as a library, classroom, a coffee shop, etc., and/or participating in a social activity, such as a meeting, a conference, a video call, etc. Because the user 105 is in a public setting and/or participating in a social activity, it may not be socially acceptable, professionally acceptable, practical, and/or convenient for the user 105 to physically interact (or perform overt gestures, such as visible finger pinches, pointing, digit-to-digit gestures, etc., to interact) with the wrist-wearable device 110, the head-wearable device 120, a mobile device (not shown), and/or another one of their electronic devices. For example, the user 105 may be in a work meeting when a message is received at the wrist-wearable device 110, the head-wearable device 120, and/or another communicatively coupled device, and, not wanting to be a distraction to others in the meeting, and also wishing to minimize their own apparent distractedness to others, the user 105 does not directly reach for one of their devices to review the message.

In FIG. 1B, the user 105 uses the subtle gesture detection system 100 to interact with the received message. In some embodiments, the subtle gesture detection system 100 utilizes subtle EMG interactions to allow the user 105 to monitor incoming notifications in real time without interrupting ongoing activities and/or making overt movements (e.g., performing a digit-to-digit gesture). For example, the user 105 can perform subtle phalange movements 140 that, when detected by the subtle gesture detection system 100, causes selection of the message (e.g., as shown by selection of the wrist-wearable device message notification 130) and the head-wearable device message notification 132). For purposes of this disclosure, a phalange, in some embodiments, is used interchangeably with a finger or a thumb. The subtle gesture detection system 100 can detect subtle gestures as described below.

In some embodiments, the subtle gesture detection system 100 detects a first set of neuromuscular signals via one or more neuromuscular-signal sensors of the wrist-wearable device 110 that is donned on a body portion of the user 105. The subtle gesture detection system 100 determines, based on the first set of neuromuscular signals, whether the body portion of the user 105 is in a first state. In some embodiments, the first state includes muscle activation without changes in muscle length or joint angle. For example, the first state can be present when force is applied against a surface, resulting in muscle activation without changes in muscle length or joint angle (isometric contraction). In some embodiments, the first state includes muscle activation of a phalange flexor at a force magnitude. For example, the first state can be present when the user 105 is holding something and the phalange flexor muscles activate to close the fingers around the object (flexion) at a force level proportional to the weight of the object (e.g., force level proportional to the weight of a held cup). In some embodiments, the first state includes a maintained position of the body portion of the user. For example, the first state can be present when the user 105 holds their hand in a loose fist position in the absence of an object for covert interactions, such as phalange flexion that is subtly and comfortably performed by pressing into the hand 107 itself.

In some embodiments, before the subtle gesture detection system 100 detects the first set of neuromuscular signals, the subtle gesture detection system 100 receives an indication of an event initiated at or an ongoing event performed at the wrist-wearable device 110, head-wearable device 120, and/or other communicatively coupled device. For example, the subtle gesture detection system 100 can detect the first set of neuromuscular signals in response to receiving an indication that a message was received, a schedule notification, presence of a predetermined status (e.g., busy, not available, etc.), an ongoing call, on ongoing meeting, application activity, and/or any new event or indication of ongoing activity.

The subtle gesture detection system 100, in accordance with an indication, based on the first set of neuromuscular signals, that the body portion of the user 105 is in the first state, monitors a second set of neuromuscular signals via the one or more neuromuscular-signal sensors of the wrist-wearable device 110. In some embodiments, the subtle gesture detection system 100 obtains the second set of neuromuscular signals while the body portion of the user 105 is in the first state. For example, the subtle gesture detection system 100 can obtain the second set of neuromuscular signals while the hand 107 of the user 105 is disposed on the table 115, the hand 107 of the user 105 is held in a loose fist position, and/or other first state described herein. In some embodiments, the second set of neuromuscular signals are representative of a flexion event performed by one or more phalanges. For example, the second set of neuromuscular signals can be representative of subtle single presses, subtle double presses, and/or subtle press-and-hold flexion events of one or more phalanges (e.g., thumb, index finger, middle finger, ring finger, pinky finger pinch and/or pinch-and-hold subtle gestures that can be performed when a hand 107 of the user 105 is empty or encumbered).

The subtle gesture detection system 100 can determine whether the second set of neuromuscular signals satisfy a gesture detection threshold and/or one or more situational criteria. The subtle gesture detection system 100, in accordance with a determination that the second set of neuromuscular signals satisfy a gesture detection threshold and/or one or more situational criteria, detects a subtle gesture performed by the user 105 and transmits instructions associated with the subtle gesture to at least one communicatively coupled device. For example, the subtle phalange movement 140 can generate neuromuscular signals and the subtle gesture detection system 100, after detecting the neuromuscular signals generated by the subtle phalange movement 140, transmits instructions associated with the subtle phalange movement 140 (e.g., selection of the wrist-wearable device message notification 130 and/or the head-wearable device message notification 132).

In some embodiments, the subtle gesture detection system 100 determines that the second set of neuromuscular signals satisfy the gesture detection threshold by detecting at least two repeated neuromuscular signals of the second set of neuromuscular signals (e.g., a subtle double press gesture as shown by subtle phalange movements 140). In some embodiments, the subtle gesture detection system 100 determines that the second set of neuromuscular signals satisfy the gesture detection threshold by detecting a sequence of pulses of neuromuscular activity above a baseline level, wherein the sequence corresponds to a predetermined temporal pattern. The predetermined temporal pattern can be effector-agnostic such that the sequence of pulses is detectable regardless of which finger or wrist muscle of the user generates the sequence of pulses. In some embodiments, the predetermined temporal pattern comprises a personalized rhythmic sequence associated with the user, such as a user-defined pattern of pulses and spaces (e.g., pulse-pulse-pulse-space-pulse). Alternatively, or in addition, in some embodiments, the subtle gesture detection system 100 determines that the second set of neuromuscular signals satisfy the gesture detection threshold by determining one or more weights for neuromuscular signals of the second set of neuromuscular signals and determining that a weighted neuromuscular signal of the second set of neuromuscular signals satisfies the gesture detection threshold. This allows the subtle gesture detection system 100 to account for increases in background muscle activity, which can result in less reliable event detection, by progressively adding support for higher weights and more dynamic background activity. Phalange flexion events may have higher false positive rates than motion-based pinch and release events and, to address the potentially higher false positive rates, the subtle gesture detection system 100 can context-gate interactions as discussed below in reference to the one or more situational criteria.

In some embodiments, the subtle gesture detection system 100 determines that one or more situational criteria are satisfied based on the presence of one or more context-based cues and/or AR context cues. For example, a context-based cue can be the occurrence of an event or scenario (e.g., a context-gate interaction, such as receiving a message, receiving a notification, receiving a call, participating in a meeting, application activity (e.g., workout application, video streaming application, etc.), and/or any event at the wrist-wearable device 110, head-wearable device 120, and/or other communicatively coupled device. In some embodiments, the situational criteria can include detection of respective neuromuscular signals within a predetermined threshold period of time (e.g., after the occurrence of a scenario or event). In some embodiments, the subtle gesture detection system 100 determines that one or more situational criteria are satisfied based on sensor data received from a communicatively coupled device and, determining, based on the sensor data, satisfaction of the one or more situational criteria are satisfied. For example, the sensor data can include image data from the head-wearable device 120 and satisfaction of the situational criteria can be based on the context-based cue present in the image data (e.g., the user is working out, the user is cooking, etc.). Alternatively, or in addition, in some embodiments, the subtle gesture detection system 100 determines that one or more situational criteria are satisfied based on computer vision based cues, detection of gesture patterns (e.g., double-press flexion, flexion indicative of an intended pinch, etc.), and/or or use of “haptic handshake” confirmation of a device wake command (e.g., haptic buzz queries whether a command has been given and command is repeated to confirm).

In FIG. 1C, the head-wearable device 120 presents, in response to the subtle phalange movements 140, the received message. For example, the head-wearable device 120 presents, via a display, a user interface element 147 including portions of the message. As shown in FIG. 1A-1C, the subtle gesture detection system 100 allows the user 105 to interact with incoming messages, calls, and/or other notifications without drawing additional attention onto themselves or causing a distraction.

As further shown in FIG. 1C, the user 105 keeps their hand 107 on the table 115 and the subtle gesture detection system 100 determines that the hand 107 of the user 105 is still in the first state. Because the hand 107 of the user 105 is still in the first state, the subtle gesture detection system 100 continues to monitor the second set of neuromuscular signals and determines whether the (additional) second set of neuromuscular signals satisfy a gesture detection threshold and/or one or more situational criteria. The subtle gesture detection system 100 determines that the (additional) second set of neuromuscular signals, corresponding to additional subtle phalange movements 145 performed by the user 105, satisfy a gesture detection threshold and/or one or more situational criteria and detects the corresponding subtle gesture and transmits instructions associated with the corresponding subtle gesture to at least one communicatively coupled device. For example, as shown in FIG. 1C, the additional subtle phalange movements 145, when detected by the subtle gesture detection system 100, cause the subtle gesture detection system 100 to transmit instructions for dismissing the message (e.g., a dismiss user interface element 149 is selected). Non-limiting examples of instructions or controls that the user 105 can provide to a communicatively coupled device via the performance of and detection of a subtle gesture include expanding incoming text messages to read more, accepting a call, discreetly rejecting a call, sending suggested text responses, discretely opening, or closing applications, etc.

Additionally, the subtle gesture detection system 100 can determine, based on the second set of neuromuscular signals, that the body portion of the user 105 is in a second state. The second state can be muscle activation or a position of the body portion of the user 105 that does not allow for the (accurate) detection of finger flexion. For example, the second state can be an overt hand movement of the user 105, the user 105 being unencumbered (e.g., releasing a held object), the user 105 no longer maintaining the body portion in a held position (e.g., release holding the loose fist), etc. The subtle gesture detection system 100, in accordance with an indication, based on the second set of neuromuscular signals, that the body portion of the user is in the second state, ceases to monitor the second set of neuromuscular signals. For example, after the user 105 moves their hand 107 from the table 115, the subtle gesture detection system 100 will cease to monitor the second set of neuromuscular signals.

The subtle gesture detection system 100 can return to detecting a first set of neuromuscular signals via the one or more neuromuscular-signal sensors of the wrist-wearable device 110 that is donned on the body portion of the user 105 to determine, based on the first set of neuromuscular signals, whether the body portion of the user 105 is in the first state. In some embodiments, the subtle gesture detection system 100 in response to determining, based on the first set of neuromuscular signals, that the body portion of the user 105 is in the second state, forgoes monitoring the second set of neuromuscular signals via the one or more neuromuscular-signal sensors of the wrist-wearable device 110. The subtle gesture detection system 100 can continue to detect neuromuscular signals to determine when the body portion of the user 105 enters the first state.

While the primary example in FIGS. 1A-1C shows the user 105 using the subtle gesture detection system 100 to interact with a message, the subtle gesture detection system 100 also allows the user 105 to interact with calls, imaging devices, user interfaces, applications, etc.

### On-the-Go Subtle Gesture Detection

FIGS. 2A-2H illustrates example subtle gestures detected by a subtle gesture detection system, in accordance with some embodiments. In particular, the subtle gesture detection system 100b detects subtle gestures performed by a user 105 donning a wearable device (e.g., a wrist-wearable device 110 and/or a head-wearable device 120) while on-the-go. The subtle gesture detection system 100b is analogous to the subtle gesture detection system 100a described above in reference to FIGS. 1A-1C.

In FIG. 2A, the user 105 is visiting a museum and participating in a guided tour. The guided tour can be presented to the user 105 via a speaker (e.g., a speaker of the wrist-wearable device 110, the head-wearable device 120, and/or other communicatively coupled device) and/or a display (e.g., a display of the wrist-wearable device 110, the head-wearable device 120, and/or other communicatively coupled device). For example, in FIGS. 2A and 2B, the user 105 is presented a video-guided tour (e.g., represented by tour audio 202 and tour video 209). FIG. 2A further shows a close-up view 204 of the hand 107 of the user 105 to better illustrate subtle gestures performed by the user 105. For example, the user 105 holds their hand 107 in a loose fist position. The wrist-wearable device 110 is donned on a body portion of the user 105 (e.g., their wrist) and detects a first set of neuromuscular signals via one or more of its neuromuscular-signal sensors. As described above in reference to FIGS. 1A-1C, a hand 107 held in a loose fist generates neuromuscular signals that are indicative of a body portion of the user 105 is in a first state.

FIG. 2B illustrates a field-of-view 206 of the user 105 through the head-wearable device 120. In some embodiments, the head-wearable device 120 displays one or more user interfaces including one or more user interface elements. For example, the head-wearable device 120 displays a media player user interface element 208 presenting the tour video 209, as well as one or more user interface elements for skipping, reversing, fast forwarding, pausing, playing, and/or adjusting a playback position of the tour video 209. In some embodiments, the head-wearable device 120 can present closed captions of presented video and/or audio data. Alternatively, or in addition, in some embodiments, the head-wearable device 120 presents transcriptions of audio captured via the head-wearable device 120, the wrist-wearable device 110, and/or other communicatively coupled device.

Turning to FIG. 2C, the subtle gesture detection system 100b determines that a first set of neuromuscular signals, detected by the wrist-wearable device 110 while the user 105 has their hand 107 in the loose fist position shown in FIG. 2A, is indicative of a body portion of the user 105 in a first state. The subtle gesture detection system 100b, in response to determining that the body portion of the user 105 is in the first state, monitors via the wrist-wearable device 110 (e.g., via its one or more neuromuscular-signal sensors) a second set of neuromuscular signals. For example, the wrist-wearable device 110 captures a second set of neuromuscular signals associated with subtle movements of a thumb 212 and a pinky finger 210. The subtle gesture detection system 100b determines whether the second set of neuromuscular signals satisfy a gesture detection threshold and/or one or more situational criteria. More specifically, the subtle gesture detection system 100b determines whether the set of neuromuscular signals generated by the subtle movements of the thumb 212 and the pinky finger 210 satisfy a gesture detection threshold and/or one or more situational criteria.

As further shown in FIG. 2C, the subtle gesture detection system 100b determines that the set of neuromuscular signals generated by the subtle movements of the thumb 212 and the pinky finger 210 satisfy a gesture detection threshold and/or one or more situational criteria, and detects a subtle gesture performed by the user 105 (e.g., a subtle in-air finger press (e.g., press of a finger against the (same) hand) and transmits instructions associated with the subtle gesture to at least one communicatively coupled device. For example, the subtle gesture detection system 100b, in response to detecting the subtle in-air finger press, transmits instructions to the wrist-wearable device 110, head-wearable device 120, and/or other communicatively coupled device such that a user interface element of the media player user interface element 208 is selected (e.g., a pause/resume user interface element 214 is selected).

In FIG. 2D, the user 105 maintains the loose fist such that the subtle gesture detection system 100b continues to monitor, via the wrist-wearable device 110, another set of neuromuscular signals to determine whether the other set of neuromuscular signals satisfy a gesture detection threshold and/or one or more situational criteria. For example, the subtle gesture detection system 100b determines whether the other set of neuromuscular signals generated by the subtle movements of the thumb 212 and an index finger 215 (and captured by the wrist-wearable device 110) satisfy a gesture detection threshold and/or one or more situational criteria. The subtle gesture detection system 100b, in accordance with a determination that the other set of neuromuscular signals generated by the subtle movements of the thumb 212 and an index finger 215 satisfy a gesture detection threshold and/or one or more situational criteria, detects another subtle gesture performed by the user 105 (e.g., another subtle in-air finger press) and transmits instructions associated with the other subtle gesture to at least one communicatively coupled device. For example, the subtle gesture detection system 100b, in response to detecting the other subtle in-air finger press, transmits instructions to the wrist-wearable device 110, the head-wearable device 120, and/or other communicatively coupled device such that a menu user interface element 216 is presented to the user 105 via the head-wearable device 120.

FIG. 2E shows additional subtle gestures (e.g., subtle presses by a middle finger 218 (e.g., against the user's same hand)) performed by the user 105. The subtle presses by the middle finger 218 are performed while the user 105 holds their hand 107 in the loose fist position (e.g., the first state) and generate additional neuromuscular signals that are used to determine whether a gesture detection threshold and/or one or more situational criteria are satisfied. The subtle gesture detection system 100b, in response to determining that the additional neuromuscular signals (captured by the wrist-wearable device 110) satisfy a gesture detection threshold and/or one or more situational criteria, detects a gesture associated with the subtle presses by the middle finger 218 and transmits instructions associated with the gesture to at least one communicatively coupled device. For example, as shown in FIG. 2E, the subtle presses by the middle finger 218 are used to navigate the menu user interface element 216 (e.g., a cursor moved to an imaging device user interface element 220 of the menu user interface element 216). In some embodiments, when the user 105 ceases performing the subtle presses by the middle finger 218, an application or device associated with the user interface element of the menu user interface element 216 is initiated or launched.

FIG. 2F shows an imaging device of the head-wearable device 120 activated in response to selection of the imaging device user interface element 220. While the imaging device of the head-wearable device 120 is activated, the user performs subsequent subtle gestures (e.g., subtle press of the thumb 212 and the index finger 215). The subtle press of the thumb 212 and the index finger 215 are performed while the user 105 holds their hand 107 in the loose fist position (e.g., the first state) and generate neuromuscular signals that are used to determine whether a gesture detection threshold and/or one or more situational criteria are satisfied. The subtle gesture detection system 100b, in response to determining that the neuromuscular signals generated by the subtle press of the thumb 212 and the index finger 215 (and captured by the wrist-wearable device 110) satisfy a gesture detection threshold and/or one or more situational criteria, detects a gesture associated with the subtle press of the thumb 212 and the index finger 215 and transmits instructions associated with the gesture to at least one communicatively coupled device. For example, as shown in FIG. 2F, the subtle press of the thumb 212 and the index finger 215 are used to capture image data via the imaging device of the head-wearable device 120.

FIG. 2G illustrates the user 105 performing a subtle press of the thumb 212 and the pinky finger 210 described above in reference to FIG. 2C. The subtle gesture detection system 100b in response to detecting the subtle press of the thumb 212 and the pinky finger 210, transmits instructions to the wrist-wearable device 110, head-wearable device 120, and/or other communicatively coupled device such that a user interface element of the media player user interface element 208 is selected (e.g., a pause/resume user interface element 214 is selected).

FIG. 2H illustrates the user 105 continuing the video guided tour. The user 105 moves their hand 107, which generates neuromuscular signals. The subtle gesture detection system 100b can determine that the neuromuscular signals generated by the hand 107 movement cause the body portion of the user 105 to be in a second state. The subtle gesture detection system 100b in response to determining the body portion of the user 105 is in the second state, ceases to monitor neuromuscular signals of the user 105.

While the above examples illustrate particular operations associated with one or more gestures, each gesture can be associated with different operations and/or one or more operations. Additionally, while the gestures are shown performed while the user 105 is standing still, any of the gestures described can be performed while the body portion of the user 105 is in any first state while in motion and/or stationary. For example, the above subtle gestures can be performed while the user 105 is walking and/or jogging and holding their hand 107 in the loose fist position, or while the user 105 has their hand 107 lifted so that they can see the wrist-wearable device 110 and maintain their hand 107 in the loose fist position.

### Subtle Gesture Detection During Activity

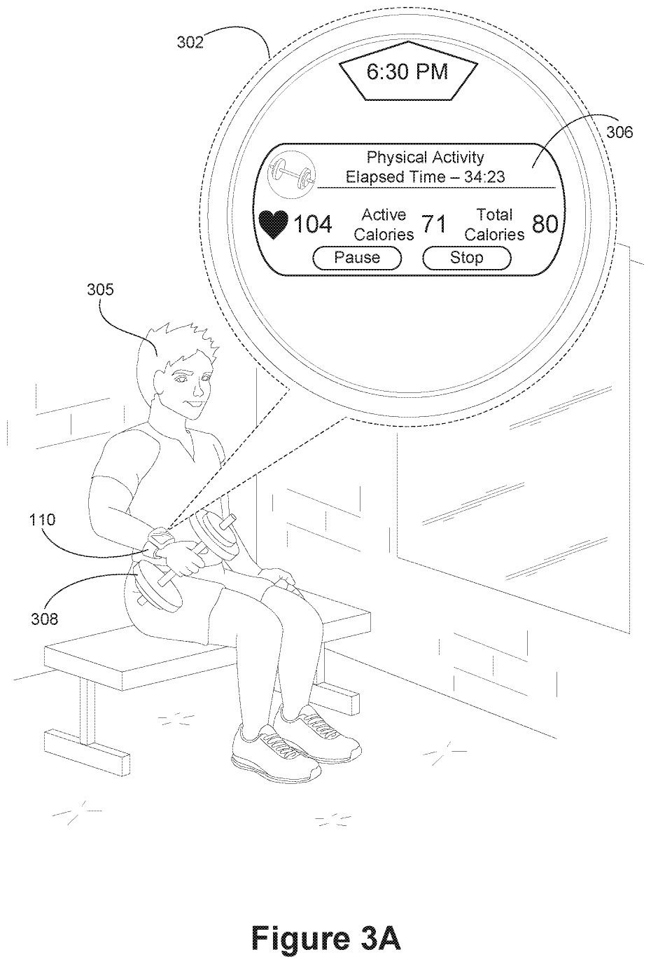

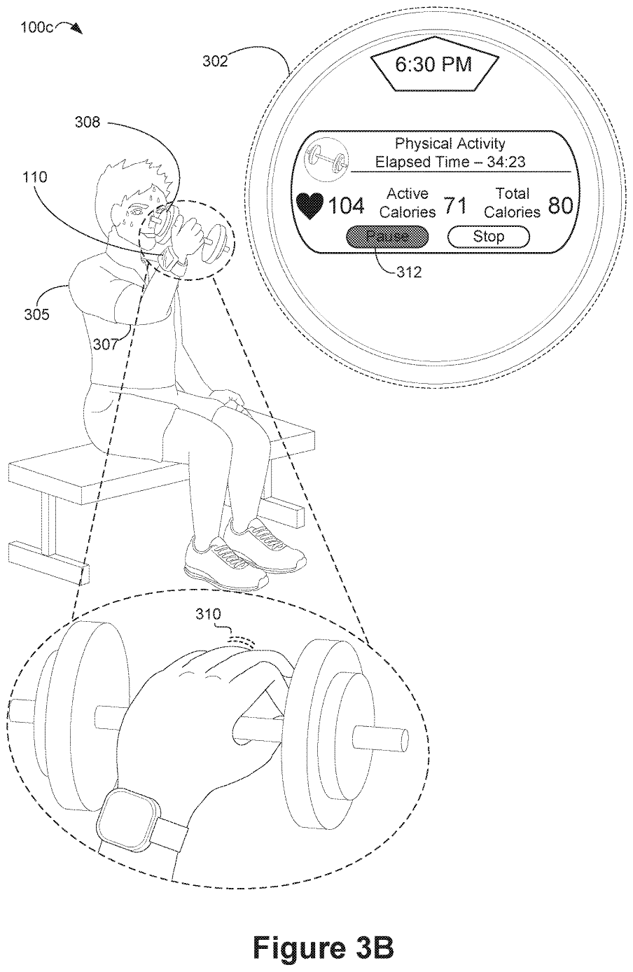

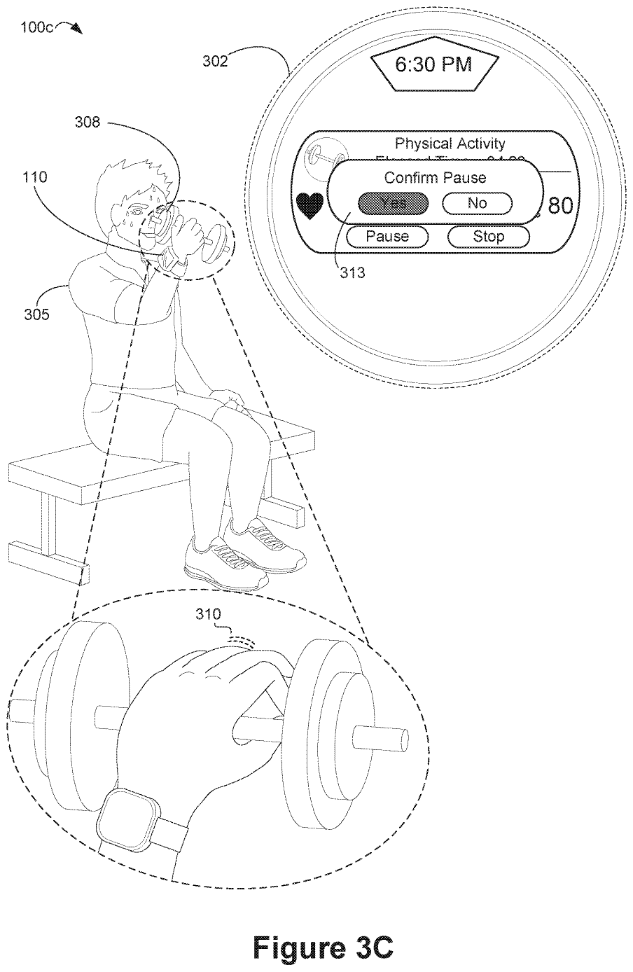

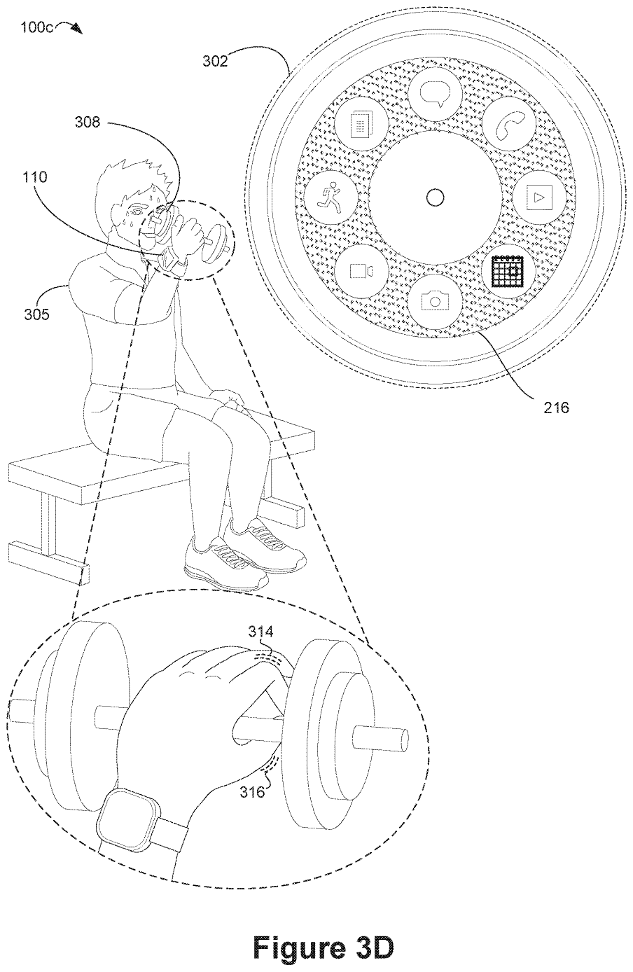

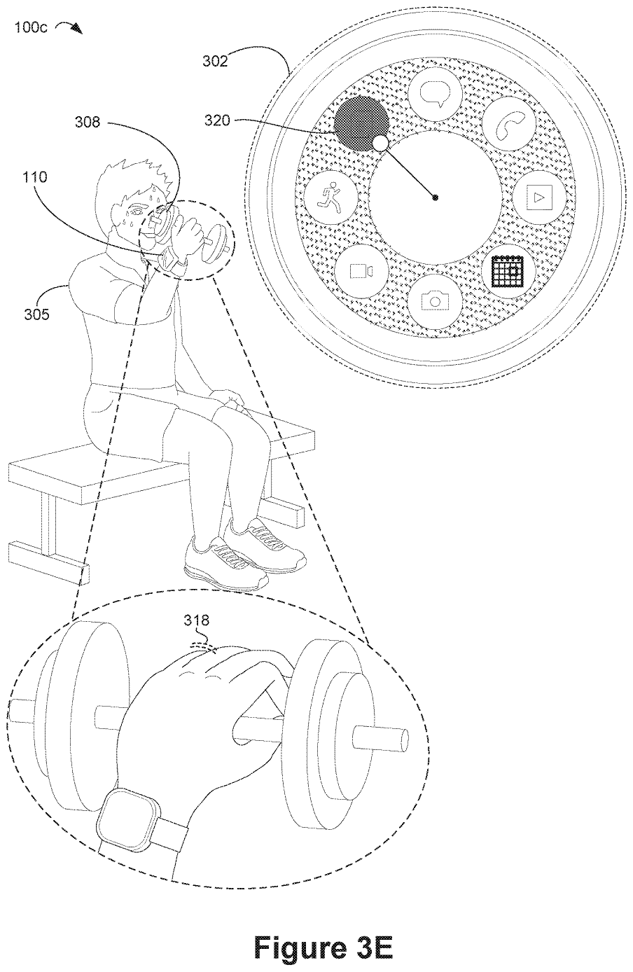

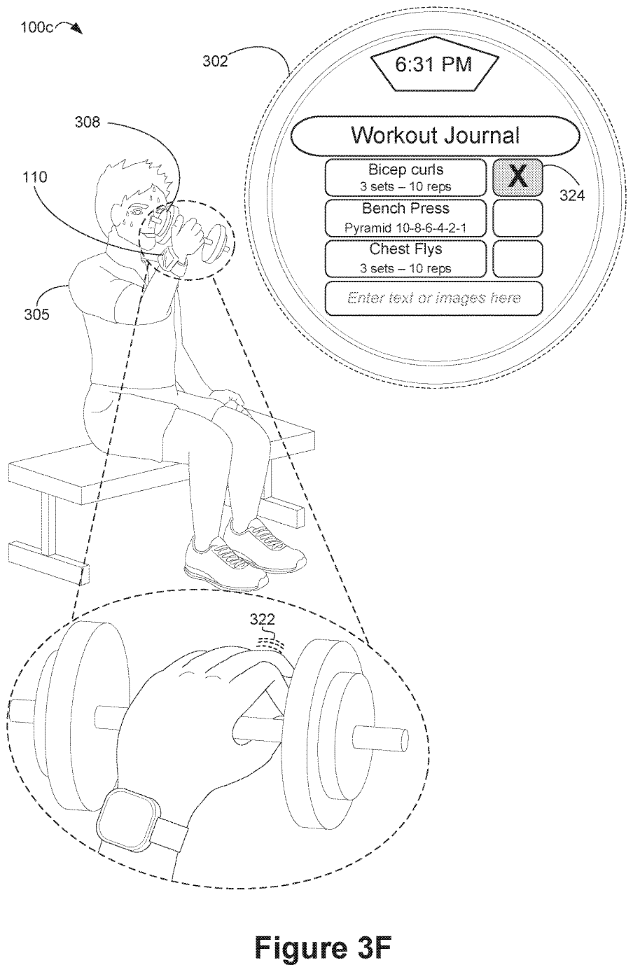

FIGS. 3A-3F illustrates a system for detecting subtle gestures performed by a user donning a wearable device and engaging in a physical activity, in accordance with some embodiments. The subtle gesture detection system 100c is analogous to the subtle gesture detection systems 100a and 100b described above in reference to FIGS. 1A-2H. The subtle gesture detection system 100c improves reliability of subtle gesture detection during increases in background muscle activity by progressively adding support for higher weights (e.g., in making gesture determinations) and/or more dynamic background activity (e.g., dynamic adjustments to gesture determinations based on activity performed by the user). Additionally, to reduce a number of false positives, subtle gesture detection system 100c can context-gate interactions. Context gates, as used herein, in some embodiments are the gesture detection thresholds and/or the one or more situational criteria. Non-limiting examples of context gates include time-boxes for a particular scenario (e.g., received notifications, calls, messages, etc.), computer vision based cues, sequential and/or patterned subtle gestures (e.g. a double-press flexion event, such as subtle flexions of a ring finger), confirmation request (e.g., a “haptic handshake” confirmation or device wake command (e.g., haptic buzz queries whether command has been given and command is repeated to confirm)).

FIG. 3A shows the user 305 at a gym donning a wearable device (e.g., a wrist-wearable device 110) and using the wrist-wearable device 110 to track their workout. For example, the wrist-wearable device 110 presents via a display 302 a workout user interface 306 including information on the current workout activity of the user 305. The subtle gesture detection system 100c detects subtle gestures performed by the user 305 while engaging in the workout (e.g., lifting a dumbbell 308).

FIG. 3B illustrates a first subtle gesture (represented by double-press flexions of the ring finger 310) performed by the user 305. While the user 305 is engaging in the workout, the subtle gesture detection system 100c detects a set of neuromuscular signals (e.g., via one or more neuromuscular-signal sensors of the wearable device 110) to determine whether a body portion (e.g., arm 307, wrist, hand, etc.) of the user 305 is in a first state. As described above, the subtle gesture detection system 100c can determine that the body portion of the user 305 is in the first state based on the set of neuromuscular signals indicating that the user 305 has closed their fingers around an object at a force level proportional to the weight of the object to hold the object (e.g., the user 305 activates their phalange flexor muscles with a force proportional to the weight of the dumbbell 308 to hold the dumbbell 308) or that the user 305 is encumbered (e.g., hands are full or occupied performing another task).

The subtle gesture detection system 100c, based on a determination that the body portion of the user 305 is in the first state, monitors an additional set of neuromuscular signals to detect potential gestures performed by the user 305 as discussed above in reference to FIGS. 1A-2H. Because the user 305 is engaged in an activity, there is increased background muscle activity that could result in false detection of gestures as described above. As such, the subtle gesture detection system 100c utilizes a gesture detection threshold and/or one or more situational criteria to decrease or prevent the detection of false positives.

For example, because the user 305 is engaged in an activity, the subtle gesture detection system 100c can determine that the gesture detection threshold is satisfied when a subtle double press gesture is detected, and ignore subtle single press gestures. Alternatively, or in addition, because the user 305 is engaged in an activity, the subtle gesture detection system 100c can determine that the gesture detection threshold is satisfied when a subtle press gesture satisfies a second force threshold greater than a first force threshold. For example, while the user 305 is engaged in an activity, the user 305 may be required to press down with a greater force for the subtle gesture detection system 100c to detect a gesture than when the user 305 is seated or standing still. In some embodiments, the second force threshold is proportional to an object held by the user 305. For example, the second force threshold can be adjusted based on the user 305 holding the dumbbell 308 (e.g., a first adjusted second force threshold) or a coffee cup (e.g., a second adjusted second force threshold, less than the first adjusted second force threshold).

Similarly, because the user 305 is engaged in an activity, the subtle gesture detection system 100c can determine that one or more situational criteria are satisfied based on an indication that context-based gates are satisfied. For example, the subtle gesture detection system 100c can determine that one or more situational criteria are satisfied based on the user 305 performing a subtle gestures within a predetermined time window (e.g., 5 seconds, 10 seconds, 15 seconds, etc.) after receiving a notification, message, a call, and/or other update at the wrist-wearable device 110 and/or other communicatively coupled device. Alternatively, or in addition, in some embodiments, the subtle gesture detection system 100c can determine that one or more situational criteria are satisfied based on changes or updates on an activity performed by the user 305. For example, the subtle gesture detection system 100c can determine that one or more situational criteria are satisfied based on the user 305 the user performing a subtle gesture within a rest period or break (e.g., complete a set of reps, change in heart rate, completing an exercise routine, switching between equipment, etc.) of their workout. The above examples are non-limiting, and the one or more situational criteria can be any conditional connection between an event and the performance of one or more subtle gestures.

In some embodiments, the subtle gesture detection system 100c selects different gesture detection thresholds and/or one or more situational criteria based on a particular activity (walking, running, lifting, writing, waving, etc.) performed by the user 305 and/or a current status of the user 305 (e.g., on-the-go, sedentary, busy, engaged, etc.)

Returning to FIG. 3B, the subtle gesture detection system 100c, detecting that the user 305 is engaged in an activity (and that the body portion of the user 305 is in the first state), determines, based on the additional set of neuromuscular signals corresponding to the first subtle gesture performed by the ring finger 310, whether the gesture detection threshold and/or one or more situational criteria are satisfied. The subtle gesture detection system 100c, detecting a subtle double press of the middle finger, determines that the gesture detection threshold and/or one or more situational criteria are satisfied, detects the gesture, and transmits instructions associated with the gesture to at least one communicatively coupled device. For example, the subtle gesture detection system 100c, in response to the first subtle gesture performed by the ring finger 310, transmits instructions to the wrist-wearable device 110 to pause the workout (e.g., selection of the pause user interface element 312).

FIG. 3C shows a confirmation request that can be presented to the user 305 via a device communicatively coupled with the subtle gesture detection system 100c. For example, in response to selection of the pause user interface element 312, the subtle gesture detection system 100c can cause a confirmation request user interface 313 to be presented at the display 302 of the wrist-wearable device 110. In some embodiments, the confirmation request is audio feedback, haptic feedback, and/or visual feedback. In some embodiments, the confirmation request is presented in accordance with a determination of that there is an increase in background muscle activity; an increase in signal noise and/or signal errors; the user is engaged in an activity when performing subtle gestures; and/or there is an increased risk of false positives. In some embodiments, presentation of the confirmation request is optional.

In FIG. 3D, the user 305 performs a second subtle gesture. The second subtle gesture is performed by a subtle double press (e.g., represented by double-press flexions of the thumb 316 and the middle finger 314). As shown in FIG. 3D, the subtle gesture detection system 100c can detect the subtle gesture while the user 305 is engaging in the activity (e.g., performing a dumbbell 308 rep). The subtle gesture detection system 100c detects the subtle double press based on a set of neuromuscular signals detected while the body portion of the user 305 is in the first state as discussed above in reference to FIGS. 1A-2H. The subtle gesture detection system 100c, in response to detection of the subtle double press, transmits instructions for causing the wrist-wearable device 110 to present a menu user interface element 216 on its display 302.

FIG. 3E shows the user 305 performing a third subtle gesture—double-press flexions of the pinky finger 318—to navigate menu user interface element 216 and select a note application user interface element 320. The third subtle gesture is detected by the subtle gesture detection system 100c based on another set of neuromuscular signals detected while the body portion of the user 305 is in the first state.

FIG. 3F shows the user 305 performing a fourth subtle gesture—double-press flexions of the middle finger 322—to log their workout in their journal. The subtle gesture detection system 100c, in response to determining that a set of neuromuscular signals corresponding to the fourth subtle gesture satisfy the gesture detection threshold and/or one or more situational criteria, detect the fourth subtle gesture, and transmit instructions associated with the fourth subtle gesture to at least one communicatively coupled device. For example, as shown in FIG. 3F, the user 305 performs the fourth subtle gesture to mark the bicep curls workout as complete (e.g., selection of check box user interface element 324).

### Encumbered Subtle Gesture Detection

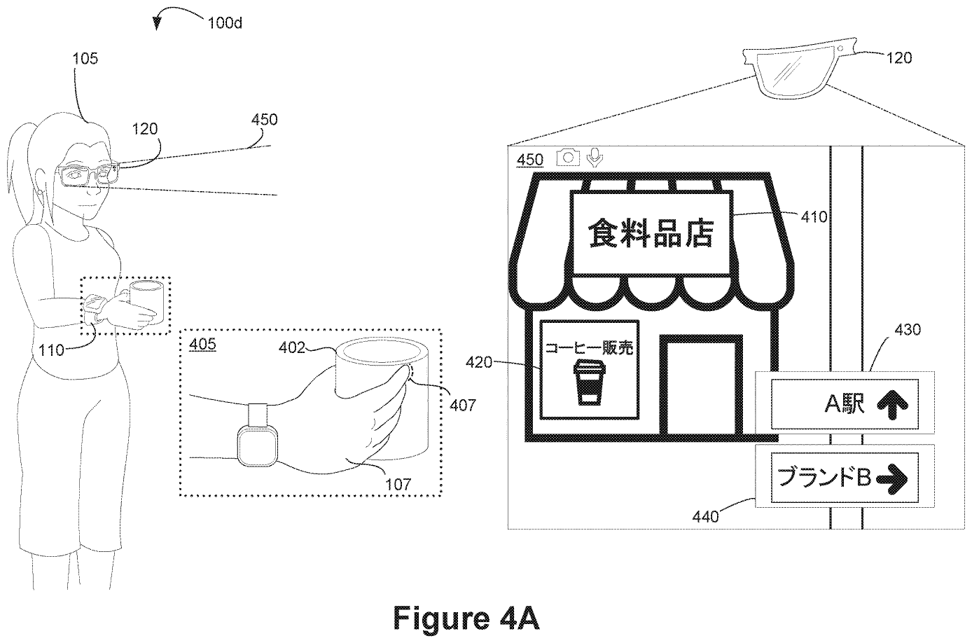

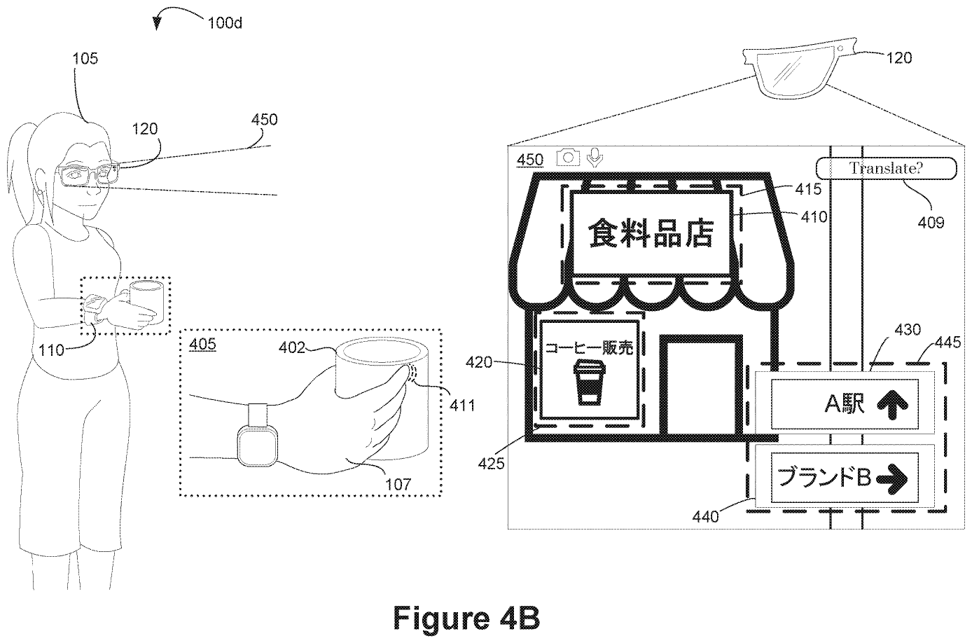

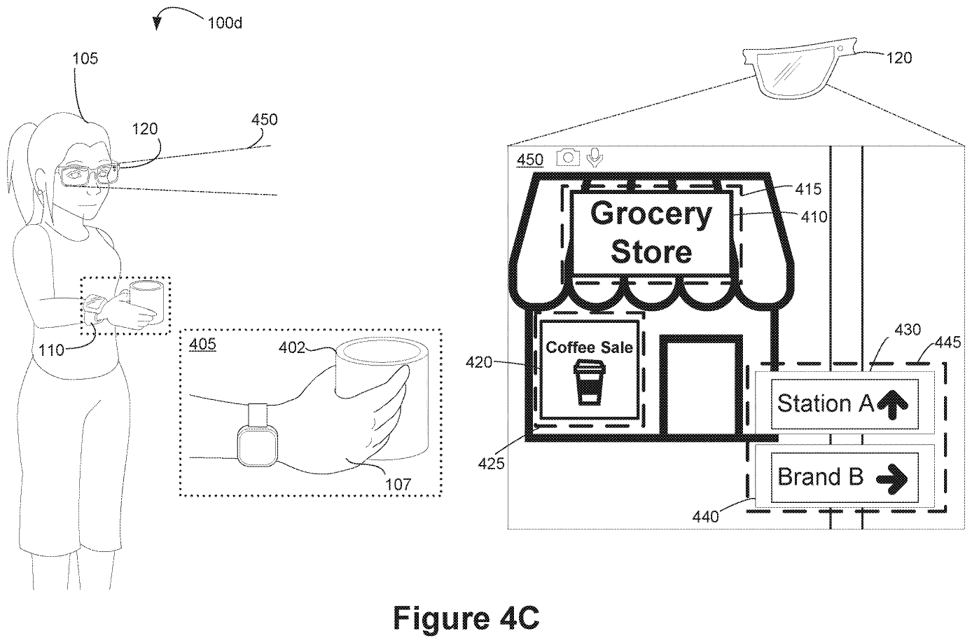

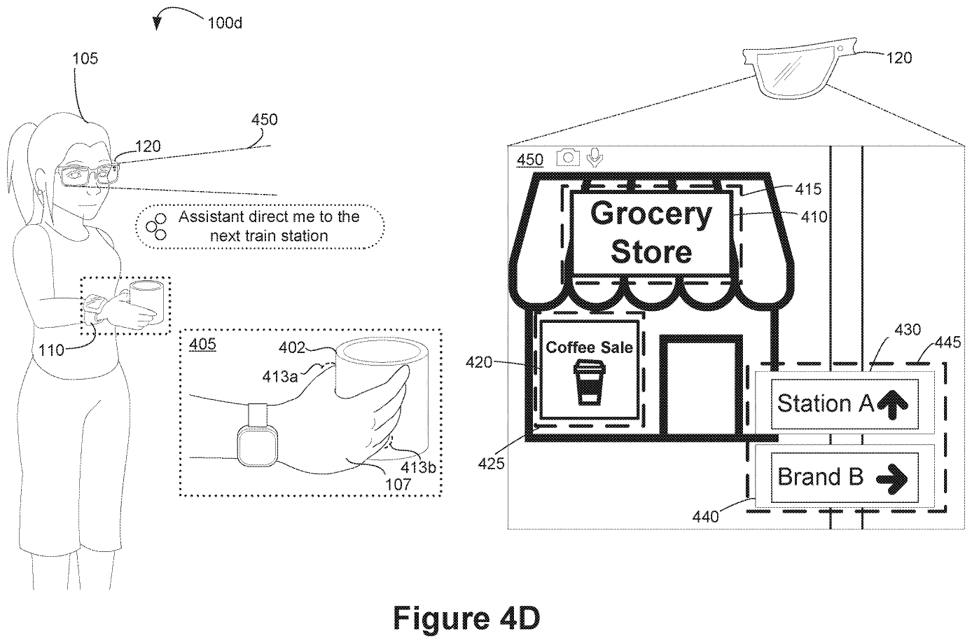

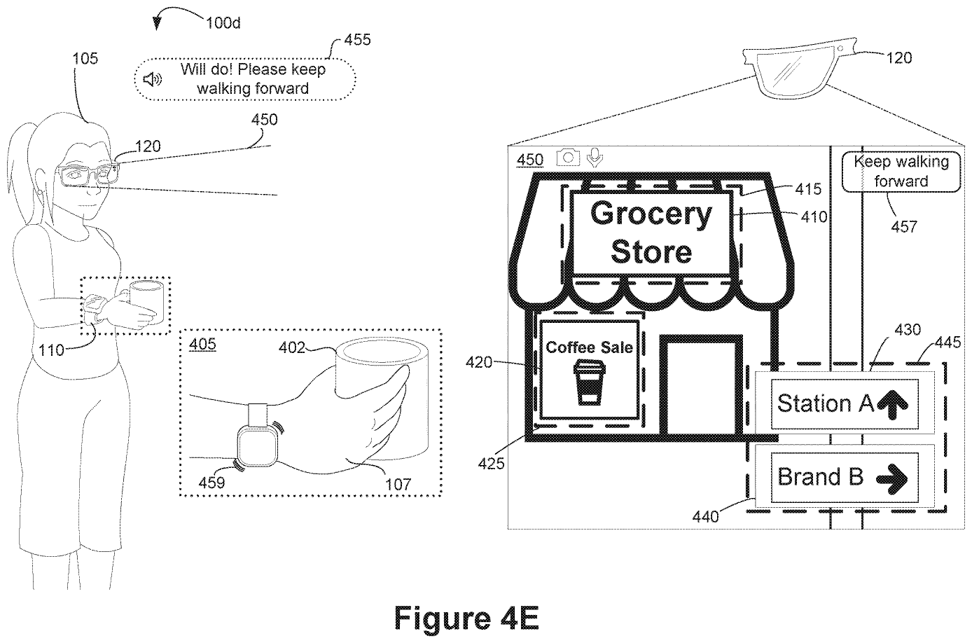

FIGS. 4A-4E illustrates a system for detecting subtle gestures performed by a user donning a wearable device and while encumbered, in accordance with some embodiments. The subtle gesture detection system 100d is analogous to the subtle gesture detection systems 100a-100c described above in reference to FIGS. 1A-3F. The subtle gesture detection system 100d illustrates detection of subtle gestures performed while the user 105 is on-the-go and holding an object, such as cup 402.

In FIG. 4A, the user 105 is traveling abroad and exploring the area. The user 105 uses their wearable devices (e.g., wrist-wearable device 110 and/or head-wearable device 120) to navigate and gain familiarity with the area. FIG. 4A shows a close-up view 405 of the hand 107 of the user 105 to better illustrate subtle gestures performed by the user 105 and a field-of-view 450 of the user 105 through the head-wearable device 120. The wrist-wearable device 110 and/or the head-wearable device 120 can provide the user 105 with audio, visual, and/or haptic feedback to assist the user 105 in their activity. In some embodiments, the wrist-wearable device 110 and/or the head-wearable device 120 include a digital or artificially intelligent (AI) assistant that can assist the user 105 in performing different tasks. In some embodiments, the AI assistant utilizes one or more models (e.g., large language models, machine learning models, etc.) to provide the user 105 with audio and/or visual feedback.

The field-of-view 450 of the user 105 shows a storefront 410, an advertisement sign 420, a first guide sign 430, and a second guide sign 440 that the user 105 is looking at. The field-of-view 450 of the user 105 also shows one or more user interface elements presented to the 105 via the head-wearable device 120. For example, the head-wearable device 120 presents to the user a camera user interface element and a microphone user interface element to notify the user 105 that an imaging device and a microphone of the head-wearable device 120 and/or the wrist-wearable device 110 are active.

The close-up view 405 of the hand 107 of the user 105 shows the user 105 performing a first subtle gesture 407 (e.g., a subtle tap performed by an index finger of the user 105). The first subtle gesture is performed on the cup 402. The wrist-wearable device 110 is donned on a body portion of the user 105 (e.g., their wrist) and detects a first set of neuromuscular signals via one or more of its neuromuscular-signal sensors, and the subtle gesture detection system 100d determines that the body portion of the user 105 is in a first state, as described above in reference to FIGS. 1A-3F. For example, the subtle gesture detection system 100d can determine, based on the first set of neuromuscular signals, that the hand 107 of the user 105 is closed on and lifting the cup 402, which puts the body portion of the user 105 in the first state. Additionally, the subtle gesture detection system 100d uses a second set of neuromuscular signals captured by the wrist-wearable device 110 while the body portion of the user 105 in the first state to detect the first subtle gesture. Additional detail on the detection of subtle gestures is provided above in reference to FIGS. 1A-3F.

FIG. 4B shows a translation confirmation request user interface element 409 presented to the user 105 in response to performance of the first subtle gesture 407. The subtle gesture detection system 100d, in response to the first subtle gesture 407, transmits instructions to the wrist-wearable device 110 and/or the head-wearable device 120 for translating the field-of-view 450 of the user 105. In some embodiments, the head-wearable device 120, in response to receiving the translation request, presents one or more translation candidate user interface elements. For example, the head-wearable device 120 presents a first bounding box 415 around the storefront 410 sign, a second bounding box 425 around advertisement sign 420, and a third bounding box 445 around the first guide sign 430 and the second guide sign 440. While the first guide sign 430 and the second guide sign 440 are shown within a single bounding box, each sign can be shown in an individual bounding box. The user 105 can provide another user input to translate a portion of the field-of-view 450 (e.g., one or more bounding boxes) or the entire field-of-view 450.

As further shown in the close-up view 405, the user 105 performs a second subtle gesture 411 (e.g., a subtle double tap performed by the index finger of the user 105). The subtle gesture detection system 100d determines that the body portion of the user 105 in the first state and uses a third set of neuromuscular signals captured by the wrist-wearable device 110 to detect the second subtle gesture 411. The subtle gesture detection system 100d, after detecting the second subtle gesture 411 transmits corresponding instructions to the wrist-wearable device 110 and/or the head-wearable device 120.

FIG. 4C shows the field-of-view 450 of the user 105 with translated text. In some embodiments, translated text is shown as an overlay within each bounding box. For example, the first bounding box 415 includes translated text “Grocery Store” for the storefront 410, the second bounding box 425 includes translated text “Coffee Sale,” the third bounding box 445 includes translated “Station A” and “Station B.”

FIG. 4D shows the user 105 performing a third subtle gesture 413 (e.g., a subtle hand squeeze performed by a pinky finger and a thumb of the user 105 (either simultaneously or sequentially)). The gesture detection system 100d detects the third subtle gesture 413 while the body portion of the user 105 in the first state and based on a fourth set of neuromuscular signals (e.g., based on flexions 413a and 413b) captured by the wrist-wearable device 110. The subtle gesture detection system 100d, after detecting the third subtle gesture 413, transmits corresponding instructions to the wrist-wearable device 110 and/or the head-wearable device 120. For example, the subtle gesture detection system 100d, after detecting the third subtle gesture 413, transmits instructions to the wrist-wearable device 110 and/or the head-wearable device 120 to initiate the AI assistant. The user 105, after initiating the AI assistant using the third subtle gesture 413, provides a voice command for requesting direction to the nearest station.

FIG. 4E shows the audio, visual, and/or haptic feedback provided to the user 105 via the wrist-wearable device 110 and/or the head-wearable device 120. The audio, visual, and/or haptic feedback, in FIG. 4E, correspond to the responses provided by the AI assistant. For example, the audio feedback 455 and the visual feedback 457 presented to the user 105 provide the user 105 with direction to the nearest station. The haptic feedback 459 can provide feedback when the user 105 is on the right track and/or when action is needed (e.g., make a turn). The AI assistant can remain active until the assigned task is completed.

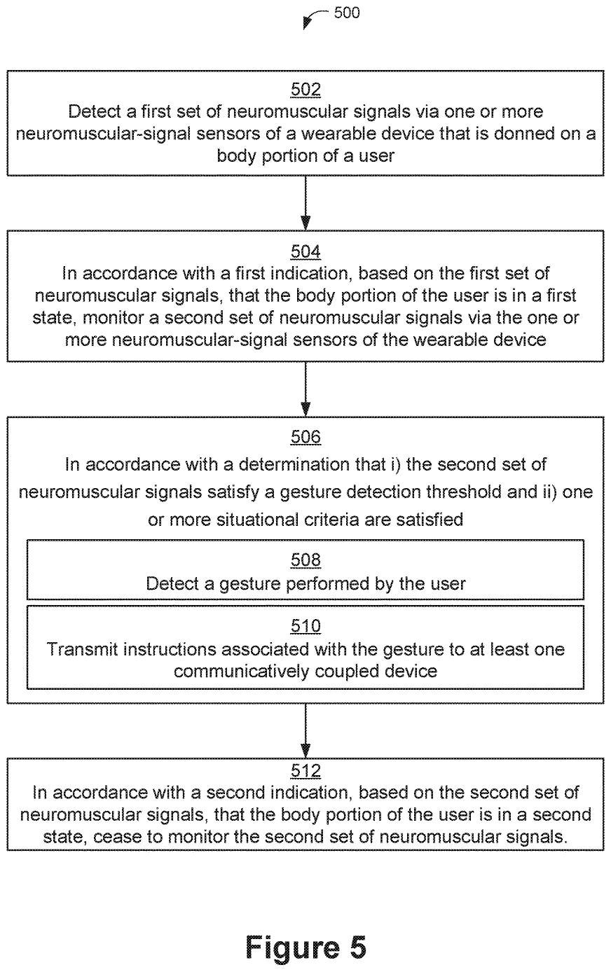

FIG. 5 shows an example method flow chart for detecting subtle gestures via a wearable device worn by a user, in accordance with some embodiments. Operations (e.g., steps) of the method 500 can be performed by one or more processors (e.g., central processing unit and/or MCU) of a wearable device (e.g., a wrist-wearable device 110) or system (e.g., any XR system of FIG. 11A-11C-2). At least some of the operations shown in FIG. 5 correspond to instructions stored in a computer memory or computer-readable storage medium (e.g., storage, RAM, and/or memory). Operations of the method 500 can be performed by a single device (e.g., a wrist-wearable device 110) alone or in conjunction with one or more processors and/or hardware components of another communicatively coupled device (e.g., a head-wearable device 120, an handheld intermediary processing device 1142, a mobile device 1150, a computer 1140, and/or any other device described below in FIG. 11A-11C-2) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by a particular component or device but should not be construed as limiting the performance of the operation to the particular device in all embodiments.

### Object Type Associated Actions via Subtle Gestures

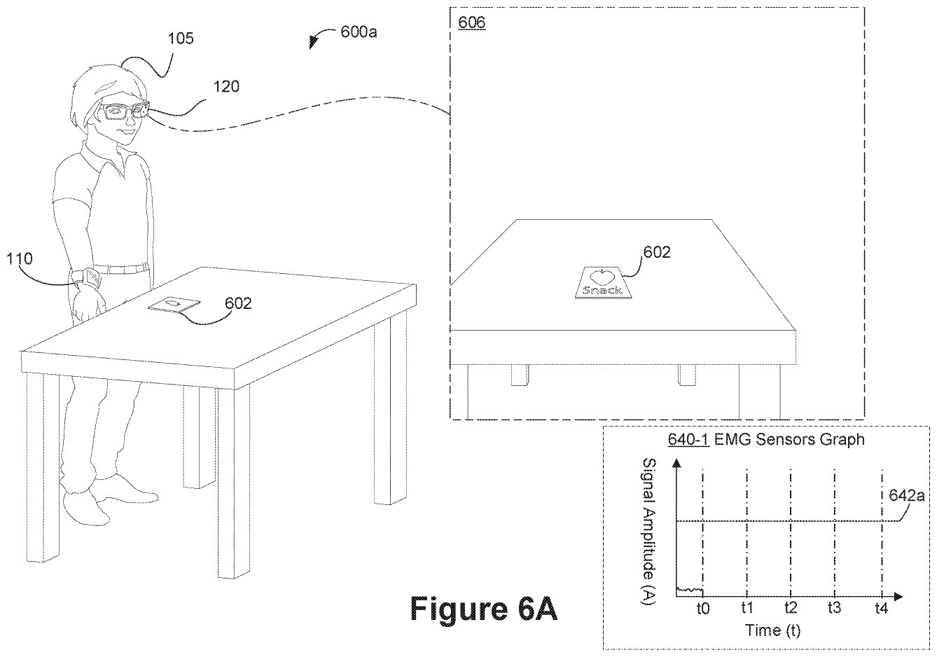

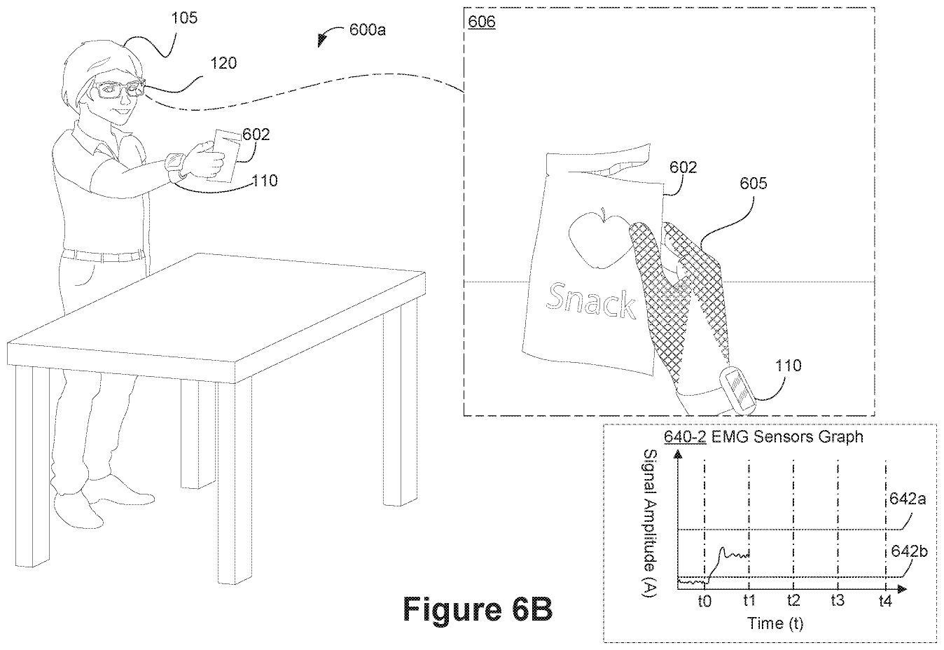

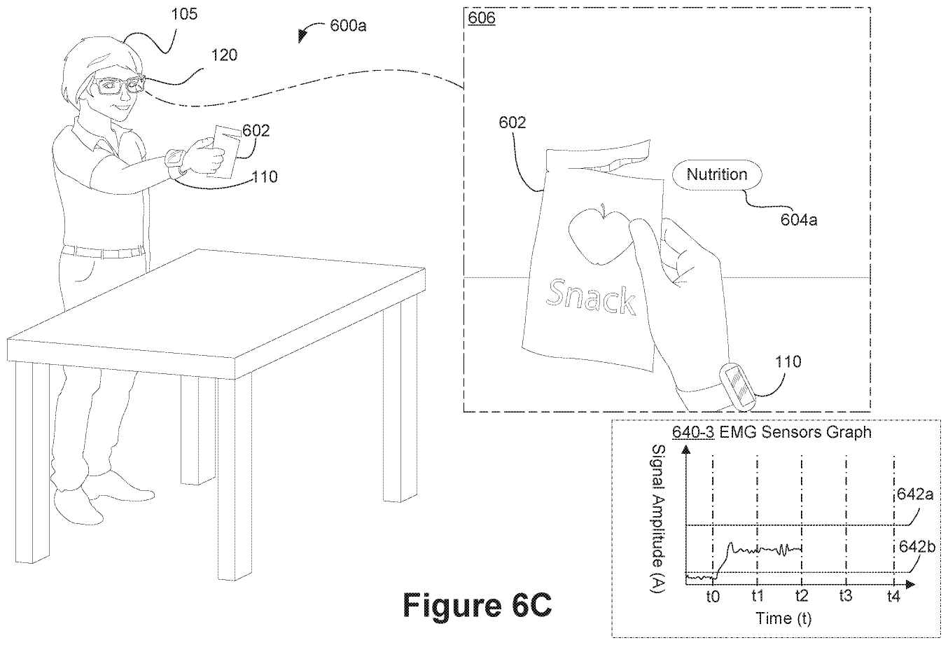

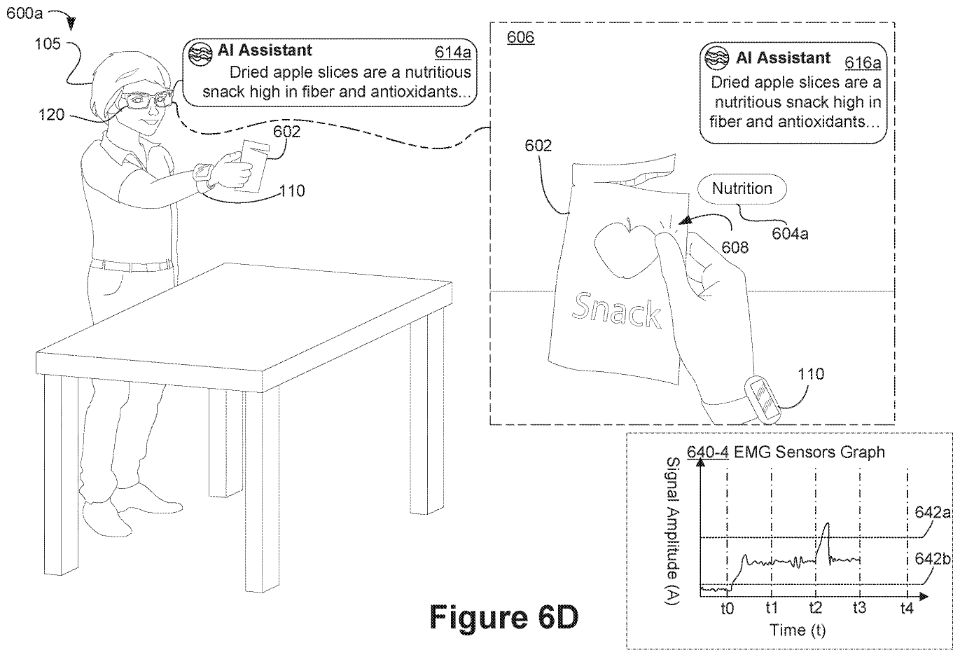

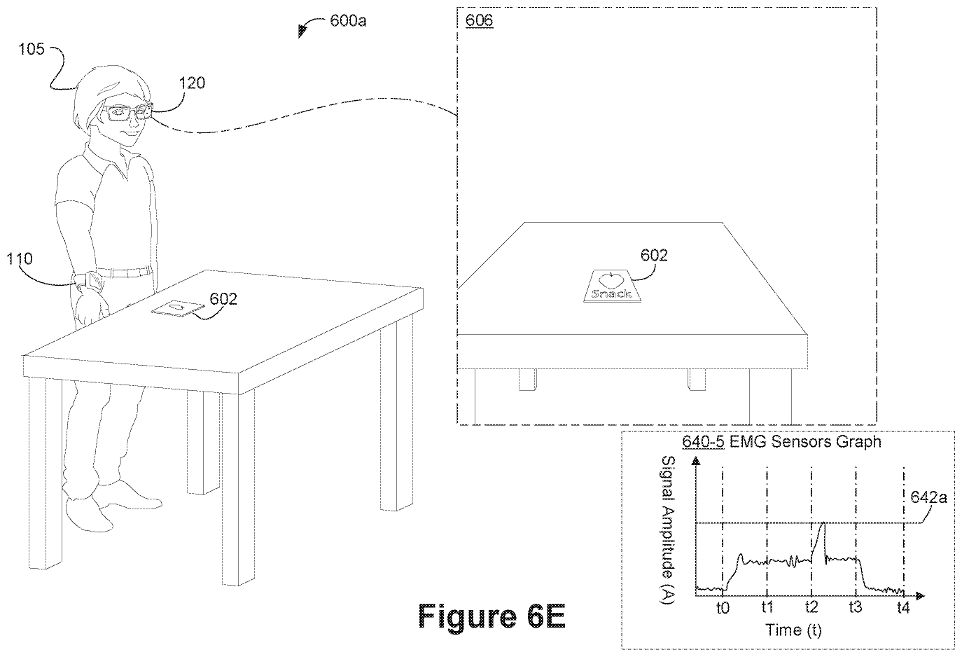

FIGS. 6A-6E illustrate a sequence of interactions by a user interacting with a computing system via gestures directed to an object (e.g., a snack item 602) having a first example object type, in accordance with some embodiments. Specifically, the sequence of interactions illustrates a user 105 performing gestures (e.g., subtle gestures) performed while the user's hand is encumbered the object that cause actions at the example computing system 600a that correspond to the object type of the object being held, the food item 602.

Turning to FIG. 6A, which illustrates a user 105 interacting with the example computing system 600a at a first point in time (t₀), in accordance with some embodiments. The user 105 is looking towards a table in front of them, which has a food item 602 on it, while the user 105 is wearing wearable devices (e.g., head-wearable device 120 and wrist-wearable device 110) that are communicatively coupled to each other and/or other devices (e.g., a mobile device 1150; FIG. 11A). The head-wearable device 120 and wrist-wearable device 110 are configured to receive sensor data via one or more sensors, such as image sensors (e.g., image sensors discussed in FIGS. 11C-1 and 11C-2, etc.) to capture image data (e.g., capture an image or capture a livestream). In accordance with some embodiments, the wrist-wearable device 110 is configured to receive additional sensor data via one or more sensors such as EMG sensors.

In some embodiments, the head-wearable device 120 includes a presentation component for presenting visual content within a field-of-view 606 of the user 105. In some embodiments, the wearable devices include, or are in electronic communication with, an AI model (e.g., an AI agent, an AI assistant, and/or a virtual assistant, a computer vision (CV) model). In some embodiments, the AI model is configured to obtain and process data captured by the one or more sensors, process the data, and/or take appropriate action based on the data, including facilitating actions related to an object being held by the user 105, which may be based on the respective object type of the object being held. For example, as shown in FIG. 6D, in response to detecting a gesture from the user using the hand that is holding the food item 602, a virtual agent (e.g., AI Assistant) can be activated to facilitate interactions with the example computing system 600a (e.g., causing execution of actions based on an object type of the object being held by the user).

In some embodiments, gestures directed to the object being held by the user can cause the example computing system 600a to execute actions that provide an output to the user 105 (e.g., virtual assistant output 614a and 616a; FIG. 6D). In some embodiments, the output to the user 105 includes at least one of an auditory or visual output and can be provided via one or multiple devices (e.g., the head-wearable device 120, wrist-wearable device 110, smartphone, etc.) individually or concurrently. In some embodiments, the example computing system 600a can be caused (e.g., via a determination of the virtual assistant) to provide different output types depending on the configuration of respective devices in the example computing system 600a. For example, in some embodiments, based on a determination that the head-wearable device 120 includes lenses without displays, a non-visual output can be provided to the user 105 via at least one of the following: (i) audio through speakers at the head-wearable device 120 or another communicatively coupled device, (ii) at the visual display 906 of the wrist-wearable device 110 or other communicatively coupled device (e.g., mobile device 1150; FIG. 11A). In some embodiments, based on another determination that at least one of the lenses of the head-wearable device 120 includes a presentation component (e.g., a monocular display, a wave-guide based projection component) for presenting visual content to the user 105, the output can be provided via the presentation component of the head-wearable device 120, as shown in FIG. 6D. That is, the example computing system 600a can be adaptable for providing output to the user 105 via various modalities based on interactions with the object being held by the user, in accordance with some embodiments.

FIG. 6A further illustrates EMG sensors graph 640 which indicates an example EMG signal amplitude detected by the EMG sensors at a respective point in time. For example, EMG sensors graph 640-1 indicates the detected EMG signal amplitude at the first point in time (t₀), when the hand of the user is unencumbered (e.g., not holding or otherwise being encumbered by an object). EMG signal baselines are used to detect whether or not the user has executed a gesture. Unencumbered EMG signal baseline 642a represents an example threshold above which EMG signals must be detected for the wrist-wearable device to detect a gesture while the user's hand is unencumbered (e.g., not holding an object). In FIG. 6A, the detected EMG signals are below the unencumbered EMG signal baseline 642a, so the signals illustrated in the EMG sensors graph 640 are not recognized as a gesture for causing performance of any operations at the example computing system 600a, in accordance with some embodiments.

FIG. 6B illustrates the example computing system 600a at a second point in time (t₁), in accordance with some embodiments. FIG. 6B further illustrates the user holding the food item 602 in the same hand that is wearing the wrist-wearable device 110. As defined herein, “holding” implies active grasping with the hand wrapped around or supporting an object (e.g., holding a cup, gripping a tool). In some embodiments, the example computing system 600a identifies that the user 105 is holding the object via one or more sensors of the head-wearable device (e.g., imaging sensors), and/or one or more sensors of the wrist-wearable device (e.g., EMG sensors). In accordance with some embodiments, a determination by one of the respective devices of the example computing system 600a that the user 105 is holding the object can cause activation of sensors of another respective device of the example computing system 600a. For example, if sensors of the wrist-wearable device 110 detect that the user 105 is holding the object, then sensors of the head-wearable device 120 can be activated to perform object type detection, in accordance with some embodiments.

As defined herein, being encumbered includes holding, as well as other situations of being occupied or restricted. For example, a user's hand may be pushing against an object that they are incapable or otherwise not inclined to be holding (e.g., an arm of a chair, a table surface, a wall) or otherwise using in a way that may not be described as holding (e.g., resting a portion of a book on a portion of the user's palm while their other hand is holding it).

FIG. 6B further illustrates EMG sensors graph 640-2 which indicates the detected EMG signal amplitude at the second point in time (t₁), when the hand of the user is now encumbered. Encumbered EMG signal baseline 642b represents an example threshold above which EMG signals must be detected for the wrist-wearable device to detect a gesture while the user's hand is encumbered with a particular object (e.g., the food item 602). In accordance with the detected EMG signals being below the encumbered EMG signal baseline 642b, the signals in the EMG sensors graph 640-2 are not recognized as corresponding to a gesture to be executed by the example computing system 600a.

In some embodiments the encumbered EMG signal baseline 642b is lower than the unencumbered EMG signal baseline 642a (e.g., a permissive gesture baseline). That is, the example computing system 600a may be permitted to detect EMG gestures of a lower amplitude while the user's hand is encumbered than when their hand unencumbered, in accordance with some embodiments.

In some embodiments, based on a determination that the user's hand is encumbered, the head-wearable device determines that the user's gaze is within a predefined angular threshold of an object held in the user's hand (e.g., within 15 degrees). In some embodiments, the head-wearable device 120 comprises additional sensors to the image sensors configured to perform object detection (externally-facing image sensors), such as inwardly-facing image sensors directed at the user's eyes, and the determination is completed via gaze detection based on data collected from these image sensors directed at the user's eyes. Based on determining that the user's gaze is within the predefined angular threshold the food item 602, the example computing system 600a can cause image data to be captured from the image sensors to determine an object type (e.g., via a CV model and/or virtual agent associated with the example computing system 600a). In some embodiments, image data is configured to be persistently captured from the image sensors at the head-wearable device 120 while it is in use. In some embodiments, image data is only captured once the devices detect that the user is holding an item. In some embodiments, object type determinations are automatically performed (e.g., in an “always active” state) and performing object type determination can occur automatically without further input from the user and/or does not require activation based on gaze detection. For example, the virtual assistant or other object-detection component of the computing system can be activated based on a determination that the user is holding an item in their hand, without requiring user gaze detection or other explicit input directed to the object. In some embodiments, where gaze detection is required for activating object-type detection by the example computing system 600a, the user's gaze must be directed to the object for a threshold amount of time for activating the object detection techniques described above.

In accordance with some embodiments, based on a determination that the hand of the user is encumbered, the example computing system 600a presents a visual overlay on the hand of the user (e.g., the visual overlay 605 shown in FIG. 6B), the visual overlay indicating an encumbered status of the hand of the user. In some embodiments, a different visual overlay can be presented on the hand of the user when it becomes unencumbered by the physical object that was encumbering it.

In accordance with some embodiments, the determination of an object type involves applying the captured image data to a computer vision (CV) machine-learning model. In accordance with some embodiments, the object type includes a set of properties of the object that the user 105 is holding or is otherwise encumbering the hand of the user. For example, the properties may include the object's functional identity (e.g., food, beverage, piece of literature or media, etc.) or other features of the object (e.g., visible labels, the language of visible labels, color, size, shape, etc.). For example, in FIG. 6B, the wearable devices detect via EMG sensors that the user is holding a food item 602. In accordance with some embodiments, the example computing system 600a may determine, based on data from one or more sensors of the head-wearable device 120, that the user 105 is gazing at the food item 602 in the user's hand, and activates a virtual agent associated with the example computing system 600a, which determines the object type as food, specifically dried apple slices.

FIG. 6C illustrates the example computing system 600a at a third point in time (t₂), in accordance with some embodiments. FIG. 6C further illustrates the user still holding the food item 602 in the same hand that is wearing the wrist-wearable device 110 at the third point in time.

In some embodiments, an active virtual assistant after determining an object type associated with the object held in the user's hand, determines an associated action, based on the object type. In some embodiments, a respective virtual assistant of a plurality of different virtual assistants associated with the example computing system 600a may become activated based on the determined object type. In FIG. 6C, the virtual assistant has determined the object type to be food, specifically dried apple slices. Based on this object type (e.g., food item), the virtual assistant determines an associated action 604 (e.g., providing nutrition information for the food item), and presents this associated action 604 to the user (e.g., presenting a user interface element 604a corresponding to a nutrition action via a presentation component of the head-wearable device). In some embodiments, one or more of the associated actions of the respective object types are predefined (e.g., “log calories” for the nutrition object type), and the virtual assistant is configured to select one or more of the predefined associated actions after determining the object type.

FIG. 6C further illustrates EMG sensors graph 640-3 which indicates the detected EMG signal amplitude at the second point in time (t₂), when the hand of the user is still encumbered. The detected EMG signals are still below the encumbered EMG signal baseline 642b, so the device has not detected a gesture.

FIG. 6D illustrates the example computing system 600a at a third point in time (t₃), in accordance with some embodiments. FIG. 6D further illustrates the user still holding the food item 602 in the same hand that is wearing the wrist-wearable device.

In some embodiments, after presenting an associated action and in response to an indication, based on data from the wrist-wearable device, that the user has performed a gesture using the hand that is holding the object, the example computing system 600a causes execution of a particular action associated with the gesture and the object type (e.g., providing nutritional information about a food object being held). In some embodiments, the indication is based on measured EMG sensor data from the wrist-wearable device that exceeds an encumbered EMG signal baseline specific to the held object. In some embodiments, the gesture is a subtle gesture, involving applying force to the object using one or more digits of the hand. For example, subtle gestures may include the user tapping or pressing one or multiple fingers of the user's hand holding the object against the object with force above a certain threshold. In some embodiments, a subtle gesture is an isometric gesture that does not include the user lifting their gesturing digit away from the object being held. For example, in FIG. 6D after presenting the indication of the user interface element 604a corresponding to a nutrition action via the presentation component of the head-wearable device, the wrist-wearable device detects that the user has performed a subtle gesture wherein the user has performed a thumb press 608 their thumb against the food item 602. The devices executed the associated action of providing nutrition information for the food item.

In some embodiments, executing the associated action comprises the virtual assistant providing an output to the user based on the associated action. The method of providing the virtual assistant output to the user 105 includes at least one or an auditory or visual output and can be provided via one or multiple devices (e.g., the head-wearable device 120, wrist-wearable device 110, smartphone, etc.) individually or concurrently. For example, in FIG. 6D, the virtual assistant presents audio output 614a via speakers in the head-wearable device and visual output 616a via the presentation component of the head-wearable device 120 to the user 105. The outputs provide nutrition information for the dried apple slices (e.g., “Dried apple slices are a nutritious snack high in fiber and antioxidants . . . ”). In some embodiments, the output provided to the user is based on the components of the example computing system 600a.

FIG. 6D further illustrates EMG sensors graph 640-4 which indicates the detected EMG signal amplitude at the fourth point in time (t₃), when the hand of the user is encumbered and performing a subtle gesture. The detected EMG signals resulting from the subtle gesture (e.g., the user performing a thumb press 608 against the food item 602) are above the encumbered EMG signal baseline 642b, so the device has detected the gesture and executed the displayed associated action.

In some embodiments, the gesture detection in the context of FIGS. 6A-6E can be based on detecting sequences of pulses of neuromuscular activity above a baseline level that match predetermined temporal patterns. For example, the unencumbered EMG signal baseline 642a and the encumbered EMG signal baseline 642b represent example baseline levels above which pulses of neuromuscular activity must be detected for the example computing system 600a to recognize a gesture. The length and complexity of such temporal patterns can be configured based on false positive requirements of different applications. For example, applications requiring higher security or accuracy may utilize longer or more complex temporal patterns, while applications with lower false positive requirements may utilize shorter or simpler patterns. In some embodiments, the temporal patterns can be personalized to include arbitrary patterns of pulses or rhythmic sequences associated with the user.

FIG. 6E illustrates the example computing system 600a at a fifth point in time (t₄), in accordance with some embodiments. FIG. 6E further illustrates the user no longer holding the food item 602, having placed the food item on the table in front of the user.

In some embodiments, based on a determination that the user is no longer holding the item, the devices will cease execution of the associated action. This determination may be based on EMG data captured by EMG sensors or image data captured from image sensors. For example, in FIG. 6E the devices determine that the user's hand is no longer encumbered and cease execution of the associated action of providing visual output 616a and audio output 614a. In some embodiments, the example computing system 600a may continue performing an aspect of the action until it detects another user input to cease performing the aspect of the action. In some embodiments this input from the user comprises at least one of an in-air gesture from the unencumbered hand of the user, a gesture from the encumbered hand of the user (e.g., subtle gesture), an audio input (e.g., “Stop”), and/or a force-based input (e.g., tapping the head-wearable device).

FIG. 6E further illustrates EMG Sensors graph 640-5 which indicates the detected EMG signal amplitude at the second point in time (t₄), when the hand of the user is no longer encumbered. In accordance with some embodiments, based on determining that the user is no longer holding the object of the first object type, the example computing system 600a ceases to continue recognizing gestures associated with EMG signals that satisfy the encumbered EMG signal baseline 642b.

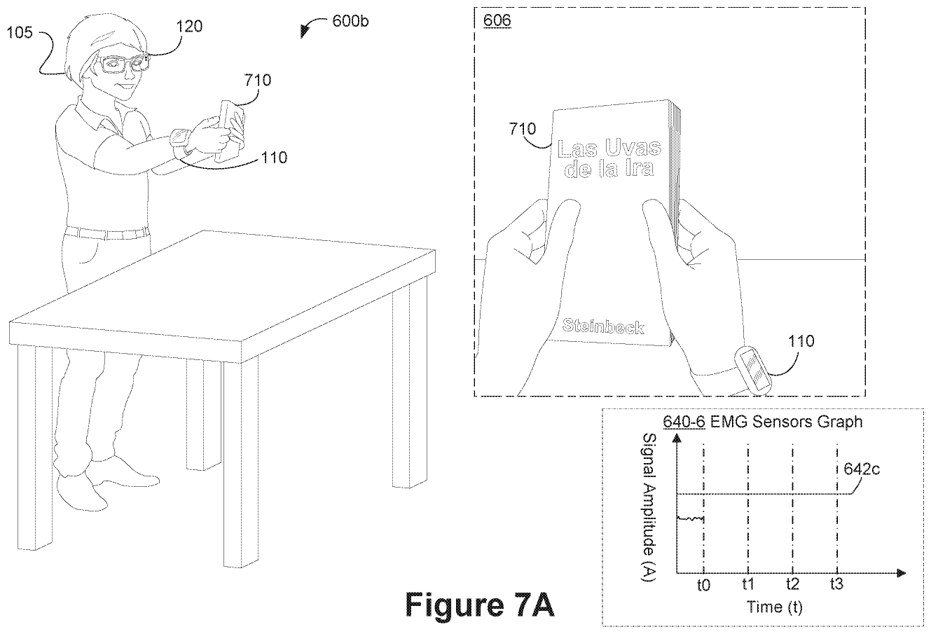

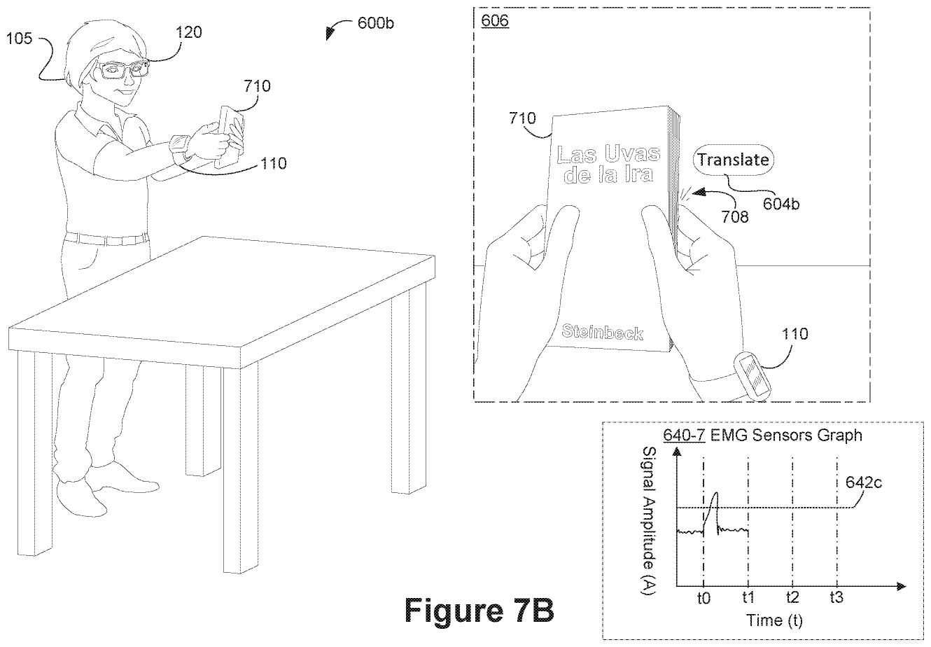

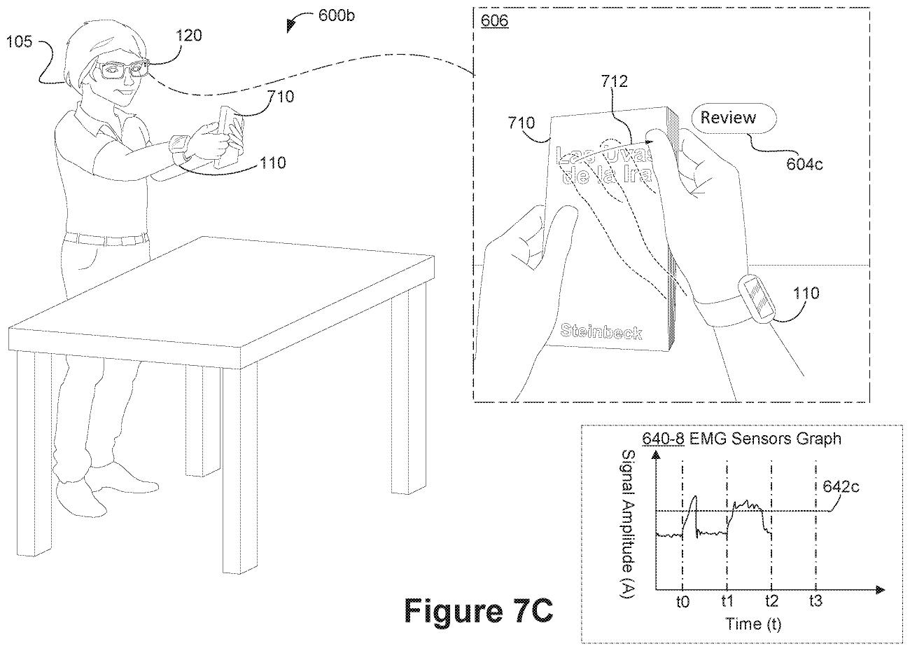

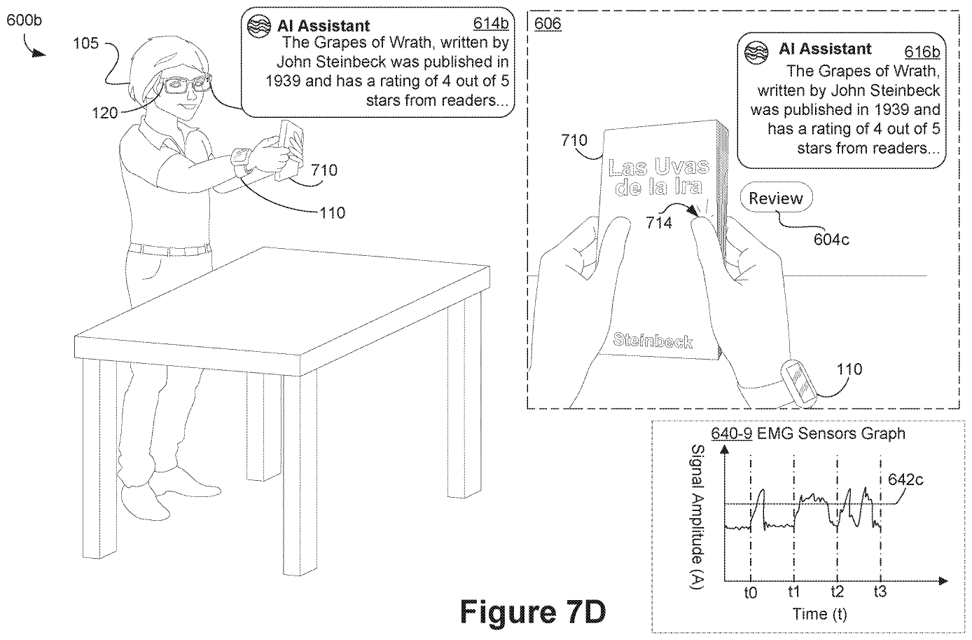

FIGS. 7A-7D illustrate an example sequence of interactions by a user 105 interacting with an example computing system 600b via gestures directed to another object having a second example object type, in accordance with some embodiments. Specifically, the sequence of interactions with the example computing system 600b shows the user 105 performing gestures for invoking different actions with respect to a held object (e.g., a book 710), and transitioning between presenting different user interface elements associated with different respective actions associated with the object type of the book 710.

Turning to FIG. 7A, which illustrates the example computing system 600b at a first point in time (t₀), in accordance with some embodiments. In accordance with some embodiments, the example computing system 600b can include some or all of the components and/or devices of the example computing system 600a described with respect to FIGS. 6A to 6E. In accordance with some embodiments, the user 105 is holding a book 710 while wearing the wrist-wearable device 110 and the head-wearable device 120. The user 105 is standing at a table while holding the book 710 in the hand that is wearing the wrist-wearable device 110. The book 710 has visible text in a foreign language on it, specifically “Las Uvas de la Ira” by Steinbeck, as shown in the field-of-view 606.

FIG. 7A further illustrates EMG sensors graph 640-6 which indicates an example EMG signal amplitude detected by the EMG sensors at a respective point in time. For example, EMG sensors graph 640-6 indicates the detected EMG signal amplitude at the first point in time (t₀), when the hand of the user is encumbered by the book 710. EMG signal baselines are used to detect whether the user has executed a gesture. Encumbered EMG signal baseline 642c represents an example threshold above which EMG signals must be detected for the wrist-wearable device 110 to detect a gesture while the user's hand is encumbered by the book 710. Since the detected EMG signals are below the encumbered EMG signal baseline 642c, the example computing system 600b does not recognize the detected signals as corresponding to an action for interacting with the example computing system 600b.

FIG. 7B illustrates the example computing system 600b at a second point in time (t₁), in accordance with some embodiments. FIG. 7B further illustrates the user 105 still holding the book 710 in both hands, including the hand that is wearing the wrist-wearable device 110.

In some embodiments, based on detecting that the hand of the user 105 that is wearing the wrist-wearable device 110 is encumbered by an object and responsive to a user input, the example computing system 600b causes invocation of the virtual assistant. In some embodiments, this user input comprises at least one of an in-air gesture from the unencumbered hand of the user, a gesture from the encumbered hand of the user (e.g., subtle gesture), an audio input (e.g., “Activate AI Assistant please”), and/or a force-based input (e.g., tapping the head-wearable device). In some embodiments the user input may be detected at the head-wearable device 120, the wrist-wearable device 110, or another device communicatively coupled to the head-wearable device 120 or the wrist-wearable device 110. For example, in FIG. 7B, after the devices have detected that the user's hand is encumbered by an object, the wrist-wearable device detects that the user has performed a subtle gesture wherein the user has executed an index finger press of the hand wearing the wrist-wearable device 110 against the surface of the book 710. In accordance with some embodiments, this invokes (e.g., activates) the virtual assistant, and using image data captured from the image sensors, an object type is determined (e.g., by a CV model of the example computing system 600b). In some embodiments, prior to the invocation of the virtual assistant, image data is not captured from the image sensors at the head-wearable device.

In FIG. 7B, the wrist-wearable device 110 detects via EMG sensors that the user is holding a book 710, and the example computing system 600b detects that the user has performed an input to activate the virtual assistant, via an EMG-detectable gesture (e.g., the index finger press 708 against the book 710). Based on detecting the EMG-detectable gesture 708, the example computing system 600b is caused to activate an AI model (e.g., as part of a virtual AI agent) for determining the object type as a book or other piece of reading material, specifically Grapes of Wrath by Steinback, written in Spanish (e.g., by applying imaging data about the object to a CV machine-learning model), in accordance with some embodiments. In accordance with some embodiments, based on the determined object type and the presence of foreign language text visible on the book 710 (e.g., text in a language that is not the user's native language), the system causes presentation, via the head-wearable device 120, of a user interface element 604b corresponding to a translation action associated with the first object type. The user interface element 604b corresponding to a translation action is presented by the head-wearable device 120. In accordance with a determination that another book has a title that corresponds to the user's native language, a different suggested action may be presented as the suggested action that the user may select, instead of the user interface element 604b corresponding to a translation action.

FIG. 7B further illustrates EMG sensors graph 640-7 which indicates the detected EMG signal amplitude at the second point in time (t₁), when the hand of the user is encumbered and performing a subtle gesture. The detected EMG signals resulting from the subtle gesture (e.g., the user performing an index finger press 708 against the book 710) are above the encumbered EMG signal baseline 642c. In some embodiments, based on detecting the EMG signal above the encumbered EMG signal baseline 642c, the device recognizes the gesture as corresponding to interaction with the example computing system 600b.

FIG. 7C illustrates the example computing system 600b at a third point in time (t₂), in accordance with some embodiments. The user 105 is still holding the book 710 in both hands at the third point in time, including the hand that is wearing the wrist-wearable device 110.

In some embodiments, after determining the object type for an object, the virtual agent causes presentation (e.g., via a visual presentation component of the head-wearable device 120) of more than one associated action. In some embodiments, each action is displayed concurrently and associated with a different gesture, and the example computing system 600b causes performance of the action that corresponds to a subsequent gesture of the user 105.

In some embodiments, the example computing system 600b is configured to present actions associated with the held object one at a time, and the user 105 is capable of performing an action-transition gesture (e.g., a left or right thumb swipe) to change the action presented by the example computing system 600b. For example, in FIG. 7C, the wrist-wearable device detects via EMG sensors that the user has performed an input (e.g., a swipe gesture 712) to cease presenting the user interface element 604b corresponding to a translation action, and to present a user interface element 604c corresponding to a review action. In some embodiments, the action-transition gesture comprises at least one of an in-air gesture from the unencumbered hand of the user, a gesture from the encumbered hand of the user (e.g., a swiping gesture with at least one digit of the encumbered hand), an audio input (e.g., “Show me a different action”), and/or a force-based input (e.g. tapping the head-wearable device).

As shown in the EMG sensors graph 640-8 which indicates the detected EMG signal amplitude at the second point in time (t₂), the detected EMG signals resulting from the swipe gesture 712 satisfy the encumbered EMG signal baseline 642c. Based on the swipe gesture 712 satisfying the encumbered EMG signal baseline 642c, the example computing system 600b recognizes the swipe gesture 712 as corresponding to an interaction with the example computing system 600b transitioning between different user interfaces representing different respective actions.

FIG. 7D illustrates the example computing system 600b at a fourth point in time (t₃) after the user performs the swipe gesture 712 to transition between different user interface elements corresponding to different respective actions, in accordance with some embodiments. While the user interface element 604c corresponding to the review action is being presented, the user 105 performs a tap gesture 714 directed to the held object (e.g., the book 710), which causes the example computing system 600b to invoke an AI assistant for performing the review action, and present a user interface element 616b that includes a review of the book 710. As shown in the EMG sensors graph 640-9, the tap gesture satisfies the encumbered EMG signal baseline 642c.

In some embodiments, executing the associated action comprises providing an output to the user 105 based on the associated action. The method of providing the output to the user 105 includes at least one of an auditory or visual output and can be provided via one or multiple devices (e.g., the head-wearable device 120, wrist-wearable device 110, smartphone, etc.) individually or concurrently. For example, in FIG. 7D, audio output 614b is presented via speakers in the head-wearable device 120 in conjunction with presenting the visual output, including the user interface element 616b (e.g., “The Grapes of Wrath, written by John Steinbeck was published in 1939 and has a rating of 4 out of 5 stars from readers . . . ”).

In some embodiments, the gesture detection in the context of FIGS. 7A-7D can utilize effector-agnostic temporal patterns, such that the sequence of pulses is detectable regardless of which finger or wrist muscle of the user generates the pulses. For example, the tap gesture 714 and the index finger press 708 can each generate pulses of neuromuscular activity that match a predetermined temporal pattern, and the example computing system 600b can detect the temporal pattern regardless of which specific finger the user 105 uses to generate the pulses. In some embodiments, the predetermined temporal pattern comprises a personalized rhythmic sequence associated with the user, such as a user-defined pattern of pulses and spaces (e.g., pulse-pulse-pulse-space-pulse). This flexibility allows the user 105 to interact with the example computing system 600b using whichever finger is most convenient given their current grip on the book 710 or other held object.

### Object Type Agnostic Actions via Subtle Gestures

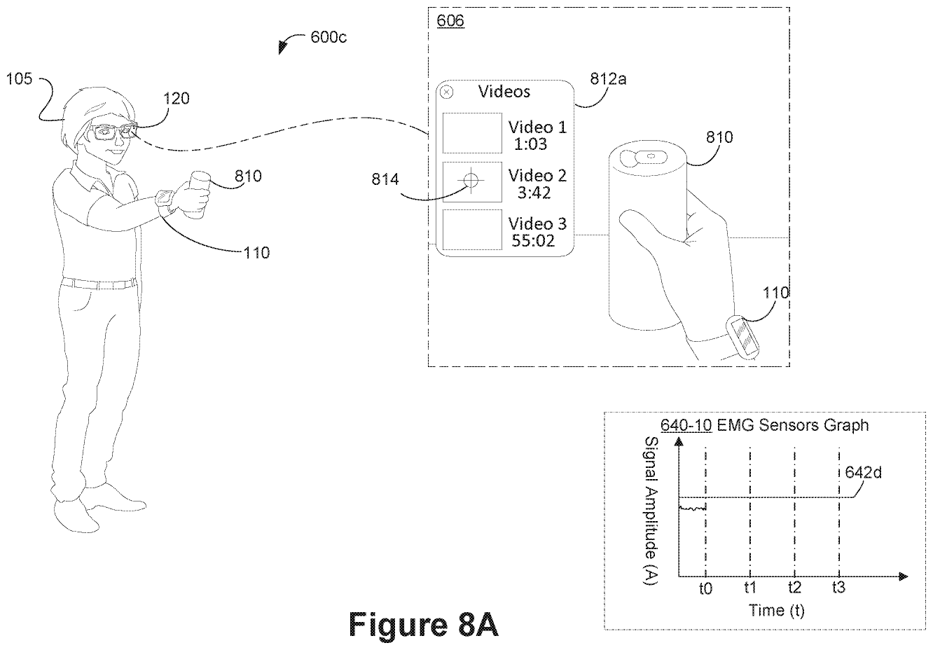

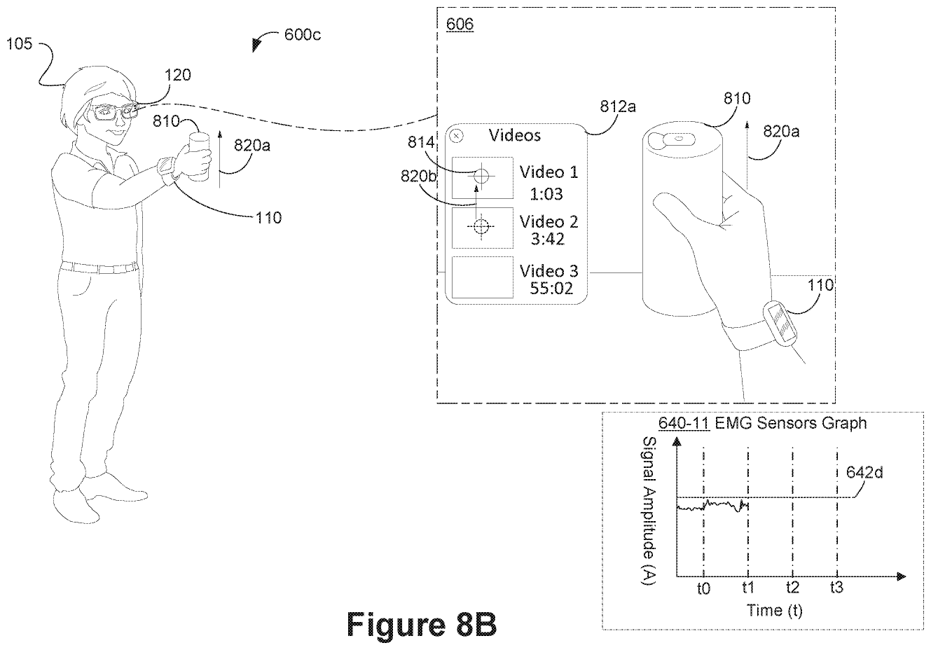

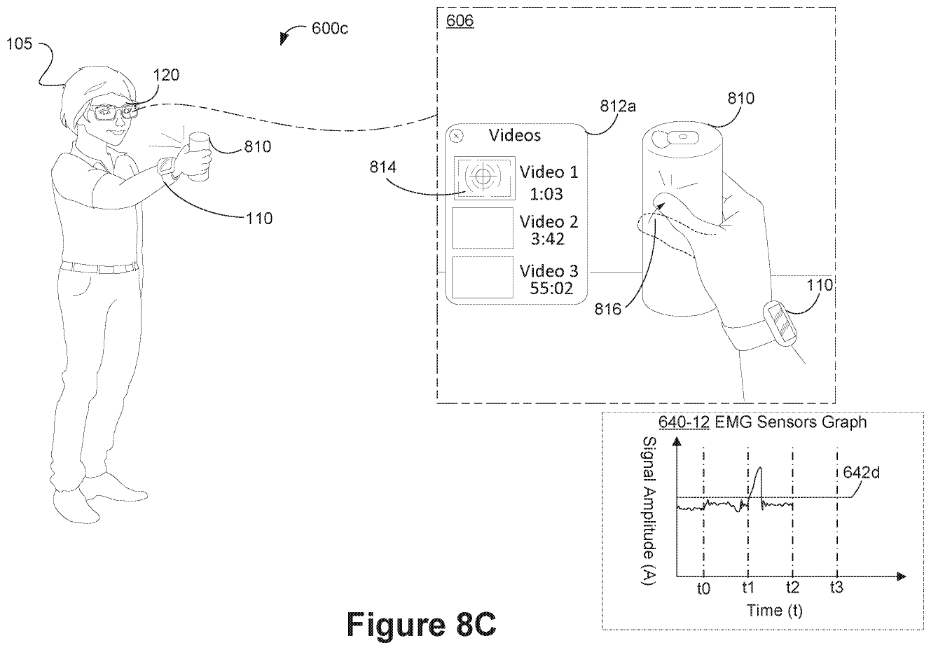

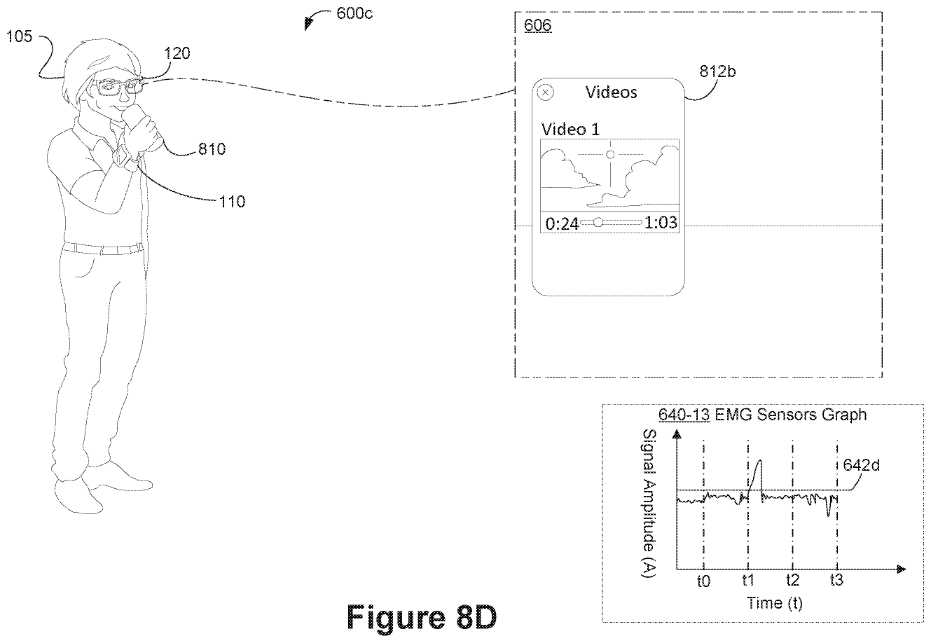

FIGS. 8A-8D illustrate an example sequence of interactions by a user with an example computing system 600c via gestures directed to an object, in accordance with some embodiments. For example, the figures depict the user 105 interacting with display interfaces presented by an AR device of an example computing system 600c while holding and using an object, in accordance with some embodiments.

Turning to FIG. 8A, which illustrates the example computing system 600c at a first point in time (t₀), including a user 105, in accordance with some embodiments. The user 105 is looking forwards, while holding a can 810 out in front of them, in the same hand that is wearing the wrist-wearable device. As defined herein, “holding” implies active grasping with the hand wrapped around or supporting an object (e.g., holding a cup, gripping a tool).

In accordance with some embodiments, the user 105 is wearing wearable devices (e.g., head-wearable device 120 and wrist-wearable device 110) that are communicatively coupled to each other and/or other devices (e.g., a mobile device 1150; FIG. 11A). The head-wearable device 120 and wrist-wearable device 110 are configured to receive sensor data via one or more sensors such as image sensors (e.g., image sensors discussed in FIGS. 11C-1 and 11C-2, etc.) to capture image data (e.g., capture an image or capture a livestream). In accordance with some embodiments, the wrist-wearable device 110 is configured to receive additional sensor data via one or more sensors such as EMG sensors. In some embodiments, the wearable devices include, or are in electronic communication with, an AI model (e.g., an AI agent, an AI assistant, and/or a virtual assistant). In some embodiments, the AI Assistant model can receive data captured by the one or more sensors, process the data, and/or take appropriate action based on the data.

In some embodiments, a component of the example computing system 600c (e.g., including a virtual agent) executes actions that produce an output (e.g., alterations to display component 812; FIGS. 8A-8D) to the user 105. The method of providing the output to the user 105 includes at least one or an auditory or visual output and can be provided via one or multiple devices (e.g., the head-wearable device 120, wrist-wearable device 110, smartphone, etc.) individually or concurrently. For example, in some embodiments the head-wearable device 120 includes lenses without displays and virtual assistant output is provided to the user 105 via at least one of the following: (i) audio through speakers at the head-wearable device 120 or another communicatively coupled device, (ii) at the visual display 906 of the wrist-wearable device 110 or other communicatively coupled device (e.g., mobile device 1150; FIG. 11A). However, in some embodiments at least one of the lenses of the head-wearable device 120 includes a field-of-view 606 viewable by the user 105 and the output is provided at the display of the head-wearable device, as shown in FIGS. 8A-8D. In some embodiments, producing an output comprises altering a previously presented output.

FIG. 8A further illustrates an output, in the form of a display component 812 currently being presented to the user 105 via the field-of-view 606 of the head-wearable device 120. The display component 812 is a video selection interface 812a, which shows three different videos available to the user 105 to select and watch. A cursor 814 is also displayed to the user within the display component 812.

FIG. 8A further illustrates EMG sensors graph 640 which indicates an example EMG signal amplitude detected by the EMG sensors at a respective point in time. For example, EMG sensors graph 640-10 indicates the detected EMG signal amplitude at the first point in time (t₀), when the hand of the user is encumbered. Encumbered EMG signal baseline 642d represents an example threshold above which EMG signals must be detected for the wrist-wearable device to detect a gesture while the user's hand is encumbered with a particular object (e.g., the can 810). The detected EMG signals are below the encumbered EMG signal baseline 642d, so the device has not detected a gesture.

FIG. 8B illustrates the example computing system 600c at a second point in time (t₁), in accordance with some embodiments. FIG. 8B further illustrates the user 105 still holding the can 810 in the same hand that is wearing the wrist-wearable device 110.

In some embodiments, based on a determination that the user's hand that is wearing the wrist-wearable device is encumbered, the example computing system 600c (e.g., via a virtual agent) detects motion of the encumbered hand and moves a cursor 814 within the field-of-view 606 based on the detected motion. In some embodiments, the motion is detected via motion data captured from one or more Inertial Measurement Unit (IMU) sensors. In some embodiments, these IMUs are incorporated in the wrist-wearable device. In some embodiments, the speed and direction of the motion of the encumbered hand corresponds to the speed and direction of the motion of the cursor 814 within the field-of-view 606. For example, in FIG. 8B, the system 600 has determined that the user's hand is encumbered, and it detects an upwards motion 820a of the user's encumbered hand. The system 600 provides an output to the user 105 based on the detected upwards motion 820a of the user's encumbered hand causing an upwards motion 820b of the cursor 814 on the video selection interface 812a that corresponds to the speed and direction of the upwards motion 820a of the user's encumbered hand.

FIG. 8B further illustrates EMG sensors graph 640-11 which indicates the detected EMG signal amplitude at the second point in time (t₁), when the hand of the user is still encumbered. EMG signal baselines are used to detect whether or not the user 105 has executed a gesture. Encumbered EMG signal baseline 642d represents an example threshold above which EMG signals must be detected for the wrist-wearable device to detect a gesture while the user's hand is encumbered. The detected EMG signals are below the encumbered EMG signal baseline 642d, so the device has not detected a gesture.

FIG. 8C illustrates the computing system at a third point in time (t₂) when the user 105 is performing a thumb tap 816 gesture directed to the can 810 to cause selection of a video being presented by the display component 812, in accordance with some embodiments. FIG. 8C further illustrates the user 105 still holding the can 810 in the same hand that is wearing the wrist-wearable device 110, such that the encumbered EMG signal baseline 642d is still the active gesture detection baseline.

In accordance with some embodiments, in response to an indication, based on data from the wrist-wearable device, that the user has performed a thumb tap 816 gesture directed to the object being held (e.g., the can 810), the devices execute an action. In some embodiments, the executed action may involve interacting with a particular user interface element based on the location of a cursor at the time the subtle gesture is detected (e.g., selecting a particular user interface element, causing presentation of a new user interface element, minimizing a particular user interface element, etc.). For example, in FIG. 8C the wrist-wearable device detects that the user 105 has performed a subtle gesture wherein the user 105 has pressed tapped their thumb against the can 810. The devices executed the action of selecting a video within the video selection interface 812a based on the location of the cursor 814 at the time the subtle gesture was detected.

FIG. 8C further illustrates EMG sensors graph 640-12 which indicates the detected EMG signal amplitude at the third point in time (t₂), when the hand of the user is still encumbered and performing a subtle gesture. The detected EMG signals resulting from the subtle gesture (e.g. the user 105 performing a thumb tap 816 against the can 810) are above the encumbered EMG signal baseline 642d, so the device has detected the gesture and executed the action of selecting a video within the video selection interface 812a.

FIG. 8D illustrates the example computing system 600c at a fourth point in time (t₃), in accordance with some embodiments. FIG. 8D further illustrates the user 105 now drinking from the can 810, which is still being held in the hand of the user which is wearing the wrist-wearable device.

In accordance with some embodiments, FIG. 8D illustrates an updated display component 812 in accordance with the execution of the action of selecting a video within the video selection interface. The field-of-view 606 now presents a video player interface 812b playing the selected video.

In some embodiments, the example computing system 600c is configured to identify that an action of the user while the hand that is wearing the wrist-wearable device is encumbered is not an intentional gesture (e.g., subtle gesture) to interact within an AR context but instead interacting with the object in a real-world context. In some embodiments, based on determining that the user is interacting with the object in the real-world context, the example computing system 600c is configured to forgo performance of any action corresponding to the detected gesture. In some embodiments, this determination is based at least in part on detected EMG signals from the wrist-wearable device. For example, in FIG. 8D, the example computing system 600c determines that the user lifting and drinking from the can is not an intentional gesture, based in part on the detected EMG signals from the wrist-wearable device and therefore does not execute an action based on this movement of the user's hand.

FIG. 8D further illustrates EMG sensors graph 640-13 which indicates the detected EMG signal amplitude at the fourth point in time (t₂), when the hand of the user is still encumbered and lifting the can 810, so that the user 105 can drink from it. In accordance with some embodiments, the detected EMG signals resulting from the user 105 interacting with the object (e.g. the user 105 drinking from the can 810) are below the encumbered EMG signal baseline 642d, so the example computing system 600c does not detect a gesture and no action is executed so the previously selected video continues to play within the video player interface 812b being presented to the user 105.

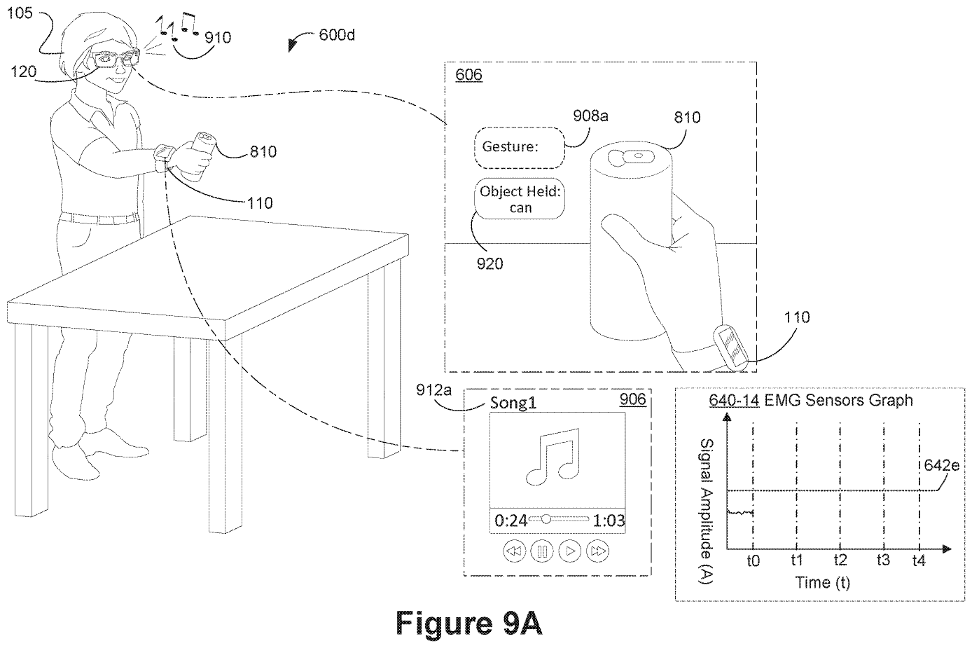

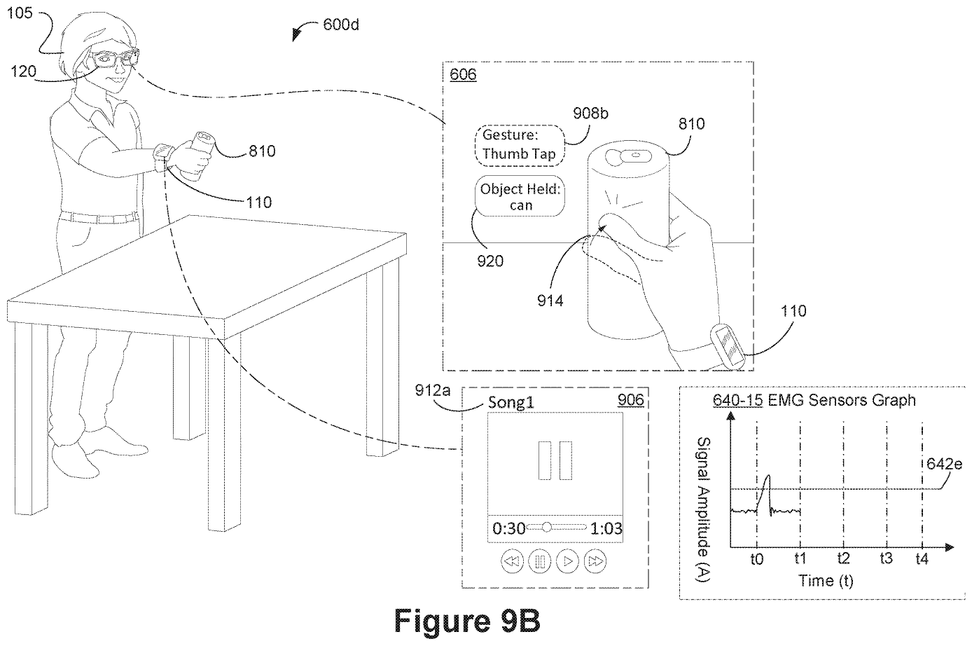

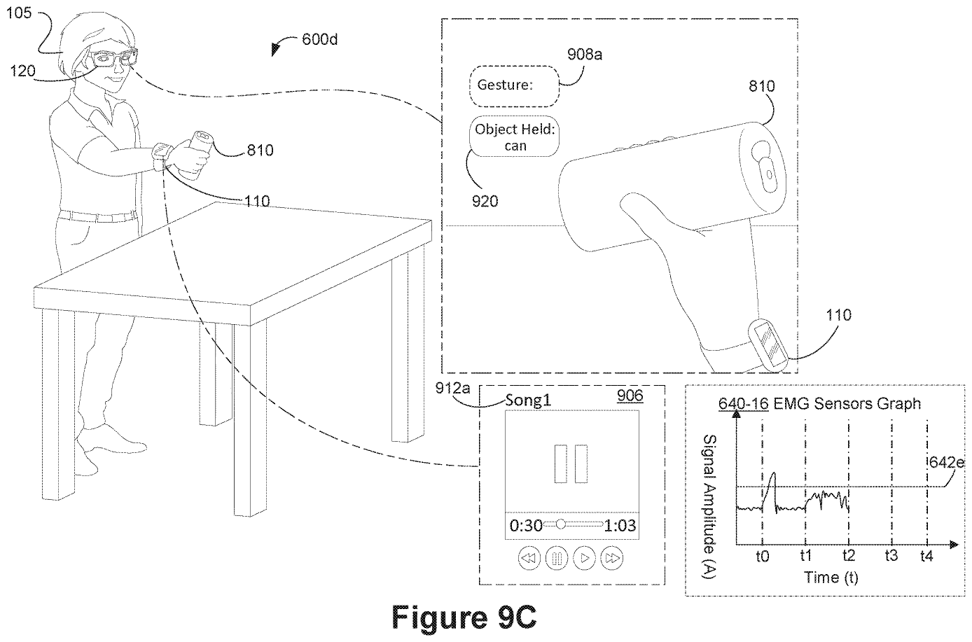

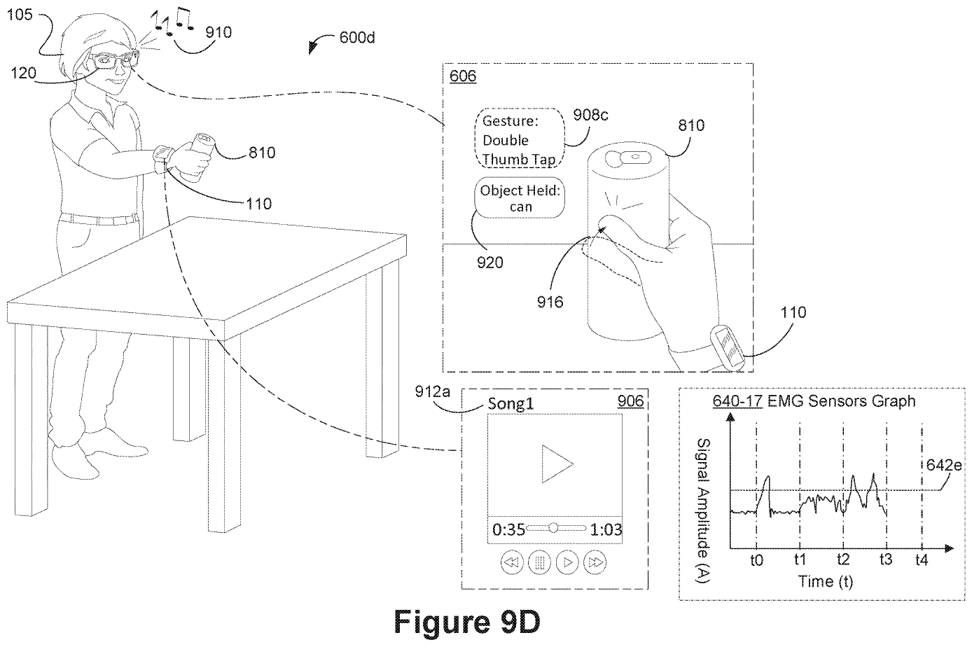

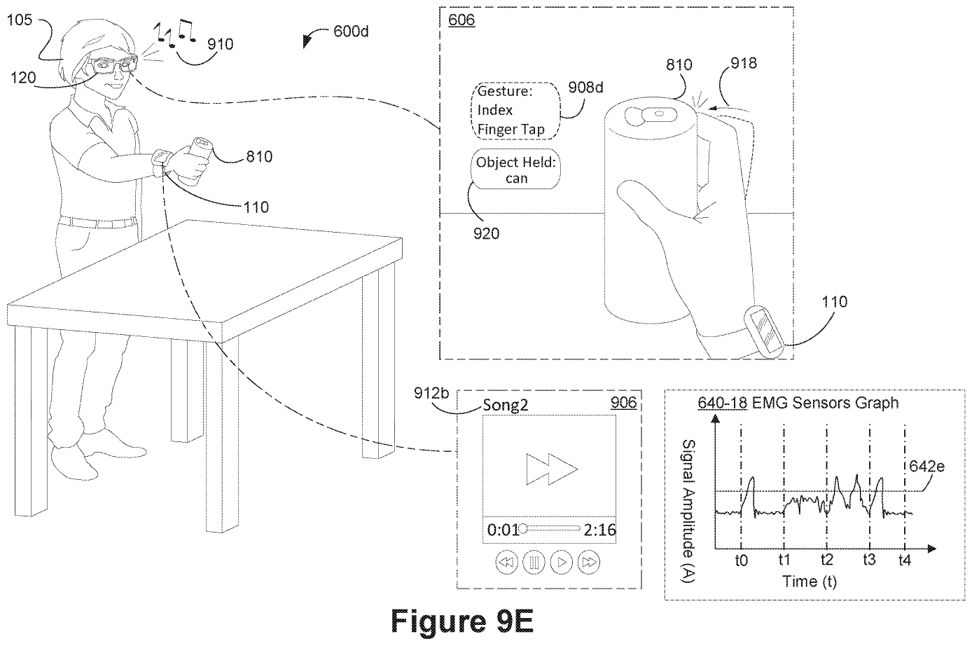

FIGS. 9A-9E illustrate an example sequence of interactions by a user 105 with an example computing system 600d via gestures directed to an object, in accordance with some embodiments. Specifically, the sequence of interactions with the example computing system 600d shows the user 105 performing gestures for invoking different actions (e.g., object-type agnostic actions) with respect to a held object (e.g. a can 810), and interacting with the example computing system 600d to alter the system's output (e.g. audio output 910 and a visual display 906) (e.g., play, pause, and skip songs playing via the head-wearable device 120).

As defined herein, object-type agnostic actions are actions that the user can cause by interacting with a physical object that are not specific to the object that the hand of the user is holding or otherwise encumbered by. In accordance with some embodiments, the gestures shown in FIGS. 9A-9E correspond to digit-to-digit gestures that the user 105 could perform to cause the same actions if the hand of the user 105 was not encumbered by the held object. In other words, the techniques shown in FIGS. 9A-9E increase the flexibility with which the user is able to interact with the example computing system 600d by allowing them to cause actions within the example computing system 600d while holding an object that would typically require an explicit digit-to-digit contact that the user may not be able to practicably perform while they are holding the object.

In some embodiments, the example computing system 600d supports instant actions that are triggered by detecting sequences of pulses of neuromuscular activity matching predetermined temporal patterns. These instant actions are available regardless of a specific object type of the object that is encumbering the hand of the user, providing always-available interaction capabilities. The temporal patterns can be effector-agnostic, allowing the user 105 to generate the required sequence using any finger or wrist muscle depending on preference and context. For example, the user 105 could trigger an instant action by subtly squeezing the can 810 in a rhythmic pattern, or by tapping a finger against the can 810 in the same rhythmic pattern. The flexibility of effector-agnostic temporal pattern detection allows interactions to be carried out at effort levels that are adapted to the user's current context and the object being held.

Turning to FIG. 9A, which illustrates the example computing system 600d at a first point in time (t₀), including a user 105, in accordance with some embodiments. In accordance with some embodiments, the example computing system 600d can include some or all of the components and/or devices of the example computing system 600a described with respect to FIGS. 6A to 6E. In accordance with some embodiments, the user 105 is listening to a first song 912a via audio output 910 from a head-wearable device 120 while holding a can 810 in front of them in the same hand that is wearing the wrist-wearable device 110. The example computing system 600d displays multiple visible outputs, as shown in the field-of-view 606.

In accordance with some embodiments, in accordance with a determination that the hand of the user is encumbered by an object (e.g., holding the can 810), the example computing system 600d may cause presentation of user interface elements related to detected user gestures or determined object type of the held objects. In some embodiments, outputs related to detected user gestures may include predetermined gesture (e.g., subtle gesture) types which may be based on force, rate, frequency, and finger(s) used in executing the gesture. In some embodiments, these outputs may comprise visual output components within the field-of-view 606 of the head-wearable device 120. These visual outputs may be visually anchored to the object detected to be held by the user 105, such that if the position of the object within the field-of-view 606 changes, the visual outputs'position will change accordingly to remain anchored to their respective positions with respect to the object being held, in accordance with some embodiments. In some embodiments, the purpose of this visual anchoring is to avoid impeding (occluding) the user's view of the object held in their hand, while still being able to view the visual output related to the held object and their detected gestures as they move the object around. In some embodiments, the anchor positions of the visual outputs correspond to respective predefined gestures that the user 105 can perform (e.g., subtle gestures) to cause execution of respective object-specific actions with respect to the object.

In accordance with some embodiments, the head-wearable device 120 is causing presentation of visual outputs (e.g., user interface elements) to facilitate the user's interaction with a held object (e.g., the can 810). For example, FIG. 9A illustrates object type output 920, which indicates that the object encumbering the user's hand has been identified by the example computing system 600d as a can (e.g., displaying the words “Object Held: can”). FIG. 9A further illustrates a gesture output 908a, which indicates that no gesture is currently being detected by the example computing system 600d (e.g., displaying the words “Gesture:”). In some embodiments, outputs representing detected gesture types may comprise the example computing system 600d mapping detected encumbered subtle gestures to corresponding unencumbered gestures (e.g., digit-to-digit gestures) and outputting the mapped unencumbered gesture (e.g., detecting a subtle gesture while the hand of the user is encumbered of a finger press, and that subtle gesture to an unencumbered pinch gesture and displaying a gesture output of “Gesture: Pinch Gesture”). By presenting information about the corresponding unencumbered gesture, or digit-to-digit gesture, that a user is performing while interacting with a held object, the example computing system 600d facilitates a more intuitive interaction domain for the user 105, by allowing them to quickly learn how to perform the corresponding encumbered gestures for causing actions that they would otherwise wish to perform while their hand is unencumbered.

FIG. 9A further illustrates EMG sensors graph 640-14 which indicates an example EMG signal amplitude detected by the EMG sensors at a respective point in time. For example, EMG sensors graph 640-14 indicates the detected EMG signal amplitude at the first point in time (t₀), when the hand of the user is encumbered by the can 810. EMG signal baselines are used to detect whether the user 105 has executed a gesture. Encumbered EMG signal baseline 642e represents an example threshold above which EMG signals must be detected for the wrist-wearable device to detect a gesture while the user's hand is encumbered by the can 810. Since the detected EMG signals are below the encumbered EMG signal baseline 642e, the example computing system 600d does not recognize the detected signals as corresponding to an action for interacting with the example computing system 600d. In some embodiments, the encumbered EMG signal baseline 642e is lower than a corresponding unencumbered (e.g., digit-to-digit) baseline for interacting with the gesture space of the example computing system 600d, which allows for the user to utilize more subtle gestures when they are holding an object.

FIG. 9B illustrates the example computing system 600d at a second point in time (t₁), in accordance with some embodiments. FIG. 9B further illustrates the user 105 still holding the can 810 in the same hand that is wearing the wrist-wearable device 110.

In some embodiments, in response to an indication, based on data from the wrist-wearable device, that the user 105 has performed a gesture using the hand that is holding an object that satisfies the encumbered EMG signal baseline 642e, the example computing system 600d presents an output to the user 105. In some embodiments, the gesture is a subtle gesture. In some embodiments, the output presented to the user may involve navigating a user interface and/or controlling the play of audio and/or visual media. In some embodiments, the navigation or control of the output presented to the user 105 is based upon a predetermined output corresponding to the particular type of subtle gesture detected (e.g., single tap corresponds to pause/play, double tap corresponds to skip). The type of subtle gesture may be differentiated based on factors such as force, duration, and number of repetitions. For example, in FIG. 9B, the wrist-wearable device detects that the user 105 has performed a subtle gesture wherein the user has tapped 912 their thumb against the can 810. Based on the detection of this gesture the example computer system 600d pauses the audio output and updated the visual display 906 of the wrist wearable device to show that the first song 912a has been paused.

In accordance with some embodiments, the gesture output 908b has also been updated by the example computing system 600d to indicate that the example computing system 600d is currently detecting a gesture (e.g., displaying the words “Gesture: Thumb Tap”) having a mapping to a corresponding unencumbered gesture, or digit-to-digit gesture, as described above with respect to FIG. 9A.

FIG. 9B further illustrates EMG sensors graph 640-15 which indicates the detected EMG signal amplitude at the second point in time (t₁), when the hand of the user is encumbered and performing a subtle gesture. The detected EMG signals resulting from the subtle gesture (e.g., the user performing a thumb tap 914 against the can 810) are above the encumbered EMG signal baseline 642e. In some embodiments, based on detecting the EMG signal above the encumbered EMG signal baseline 642e, the device recognizes the gesture as corresponding to an action for interacting with the example computing system 600d.

FIG. 9C illustrates the example computing system 600d at a third point in time (t₂), in accordance with some embodiments. The user 105 is holding the can 810 in the same hand that is wearing the wrist-wearable device 110 while they tilt, spin, and otherwise manipulate the can 810.

In accordance with some embodiments, the example computing system 600d is configured to ignore gestures and/or forgo performance of actions corresponding to gestures that result from users'interactions with the objects that are determined to not be intended to cause performance of actions at the example computing system 600d (e.g., that are not determined to be an intentional gesture (e.g., subtle gesture)), and instead are determined to be interactions with the object encumbering the user's hand in a real-world context, such the gesture caused by the user drinking from the can 810 as described with respect to FIG. 8D. For example, in FIG. 9C, the user 105 spins the can 810 around in their hand and audio output 910 remains paused, and no actions are executed by the example computing system 600d, which may be based on an inference by the example computing system 600d that the user's intent in performing the gesture is to read a portion of the label of the can 810 (e.g., turning the can 810 to observe the nutritional facts). Based on the determination that the user 105 is not intending to perform a gesture directed to the example computing system 600d, the gesture output 908 has been updated by the example computing system 600d to display that the example computing system 600d is not currently detecting a gesture (e.g., displaying the words “Gesture:”) as described above with respect to FIG. 9A.

FIG. 9C further illustrates EMG sensors graph 640-16 which indicates the detected EMG signal amplitude at the third point in time (t₂), when the hand of the user is encumbered and interacting with the can 810 by spinning and manipulating it. In accordance with some embodiments, the detected EMG signals resulting from the user 105 interacting with the object (e.g., the user 105 spinning the can 810) are below the encumbered EMG signal baseline 642e, so the example computing system 600d does not detect a gesture and therefore does not execute an action. The previously paused audio output 910 remains paused as the first song 912a is not being played, as shown on the visual display 906 of the wrist-wearable device 110. Although the EMG sensors graph 640-16 shows gesture data below the encumbered EMG signal baseline 642e, the gesture could have been ignored by the example computing system 600d anyway even if it were above the baseline, since the example computing system 600d recognized that the gesture was not intended to cause performance of an action at the example computing system 600d.

FIG. 9D illustrates the example computing system 600d at a fourth point in time (t₃), in accordance with some embodiments. The user 105 is holding the can 810 in the same hand that is wearing the wrist-wearable device 110.

In accordance with some embodiments, as described above with respect to FIG. 9B, in response to an indication, based on data from the wrist-wearable device, that the user 105 has performed a subtle gesture using the hand that is holding an object, the example computing system 600d executes actions that control the playback of audio output 910. For example, in FIG. 9D, the user 105 executes a subtle gesture (e.g., double thumb tap 916) and based on the example computing system 600d detecting this gesture, the example computing system 600d executes an action to resume playing the previously paused first song 912a and resume audio output at the head-wearable device. In accordance with some embodiments, the gesture output 908c has also been updated by the example computing system 600d to indicate that the example computing system 600d is currently detecting a gesture corresponding to an unencumbered gesture, or digit-to-digit gesture (e.g., displaying the words “Gesture: Double Thumb Tap”) as described above with respect to FIG. 9A-9C.

FIG. 9D further illustrates EMG sensors graph 640-17 which indicates the detected EMG signal amplitude at the fourth point in time (t₃), when the hand of the user is encumbered and interacting with the can 810 by double tapping 916 it with their thumb. In accordance with some embodiments, the detected EMG signals resulting from the user 105 interacting with the object (e.g., the user 105 double tapping 916 the can 810) are above the encumbered EMG signal baseline 642e, so the example computing system 600d recognizes the performance of the double tapping 916 gesture as corresponding to an action directed to the example computing system 600d. The previously paused audio output 910 is no longer paused as the first song 912a is now being played, as shown on the visual display 906 of the wrist-wearable device 110.

In some embodiments, in the context of FIGS. 9A-9E, different temporal patterns can be mapped to different instant actions. For example, a first temporal pattern (e.g., a single thumb tap pattern as shown by the thumb tap 914 in FIG. 9B) can trigger a first instant action (e.g., pausing audio playback), and a second temporal pattern (e.g., a double thumb tap pattern as shown by the double thumb tap 916 in FIG. 9D) can trigger a second instant action (e.g., resuming audio playback). These instant actions are available regardless of a specific object type of the object that is encumbering the hand of the user 105, such that the same temporal patterns trigger the same actions whether the user 105 is holding the can 810 or any other object. The flexibility of mapping different temporal patterns to different instant actions allows the example computing system 600d to provide a rich set of always-available interaction capabilities while the hand of the user 105 remains encumbered.

FIG. 9E illustrates the example computing system 600d at fifth point in time (t₄), in accordance with some embodiments. The user 105 is holding the can 810 in the same hand that is wearing the wrist-wearable device 110.

In accordance with some embodiments, as described above with respect to FIGS. 9B and 9D, in response to an indication, based on data from the wrist-wearable device, that the user 105 has performed a subtle gesture using the hand that is holding an object, the example computing system 600d executes actions that control the playback of audio output 910. For example, in FIG. 9E, the user 105 executes a subtle gesture (e.g., index finger tap 916) and based on the example computing system 600d detecting this gesture, the example computing system 600d executes an action to skip the previously playing first song 912a and start playing a second song 912b, via audio output 910 at the head-wearable device 120. In accordance with some embodiments, the object type output 908 has also been updated by the example computing system 600d to display the object type output 908d that the example computing system 600d is currently detecting a specific gesture (e.g., displaying the words “Gesture: Index Finger Tap”) as described above with respect to FIG. 9A-9D.

FIG. 9E further illustrates EMG sensors graph 640-18 which indicates the detected EMG signal amplitude at the fifth point in time (t₄), when the hand of the user is encumbered and interacting with the can 810 by tapping 918 it with their index finger. In accordance with some embodiments, the detected EMG signals resulting from the user 105 interacting with the object (e.g., the user 105 tapping 918 the can 810) are above the encumbered EMG signal baseline 642e, so the example computing system 600d recognizes the gesture as corresponding to an action to execute within the example computing system 600d. The audio output 910 has skipped the first song 912a and now plays the second song 912b, as shown on the visual display 906 of the wrist-wearable device 110.

In some embodiments, the techniques of FIGS. 9A-9E can also be applied to notification handling. For example, detecting a sequence of at least two EMG transients above the baseline level (e.g., the encumbered EMG signal baseline 642e) can cause the example computing system 600d to perform one of accepting, declining, or ignoring a notification presented to the user 105. A first sequence of two EMG transients can correspond to accepting a notification, while a different sequence of two or more EMG transients can correspond to declining or ignoring the notification. This allows the user 105 to manage notifications while their hand remains encumbered by the can 810 or other held object, without requiring the user 105 to release the object or perform overt gestures that may be impractical or socially unacceptable in certain contexts.

A skilled artisan will appreciate that while descriptions of FIGS. 6A to 9E describe techniques based on sensed EMG signals, the same or similar operations could be performed using other types of neuromuscular signals (e.g., surface mechanomyography (sMMG) signals).

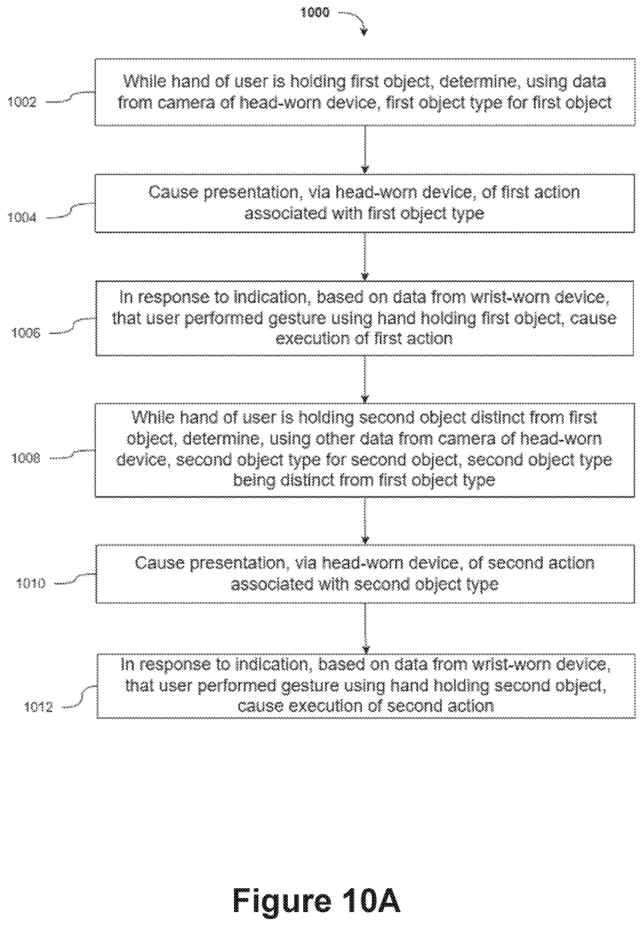

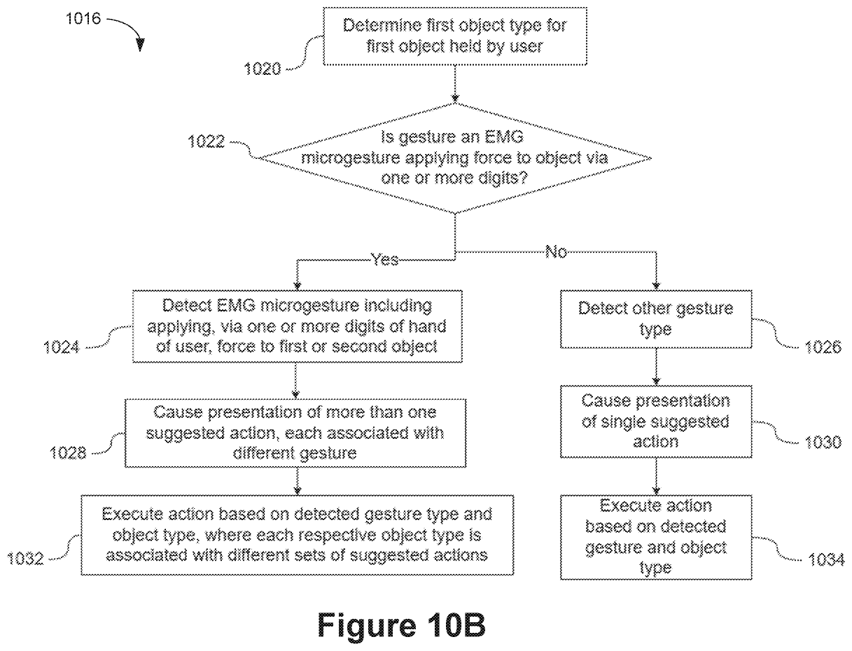

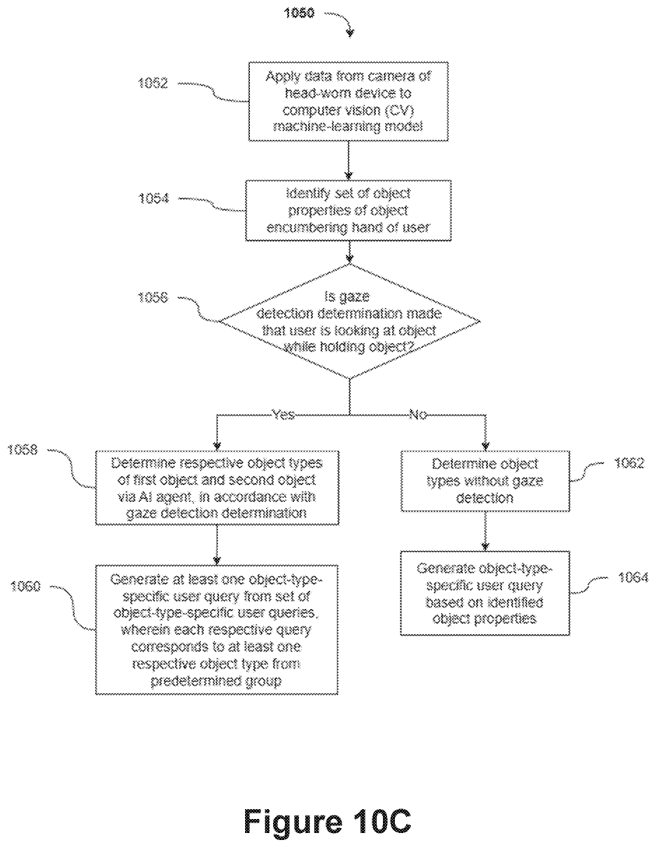

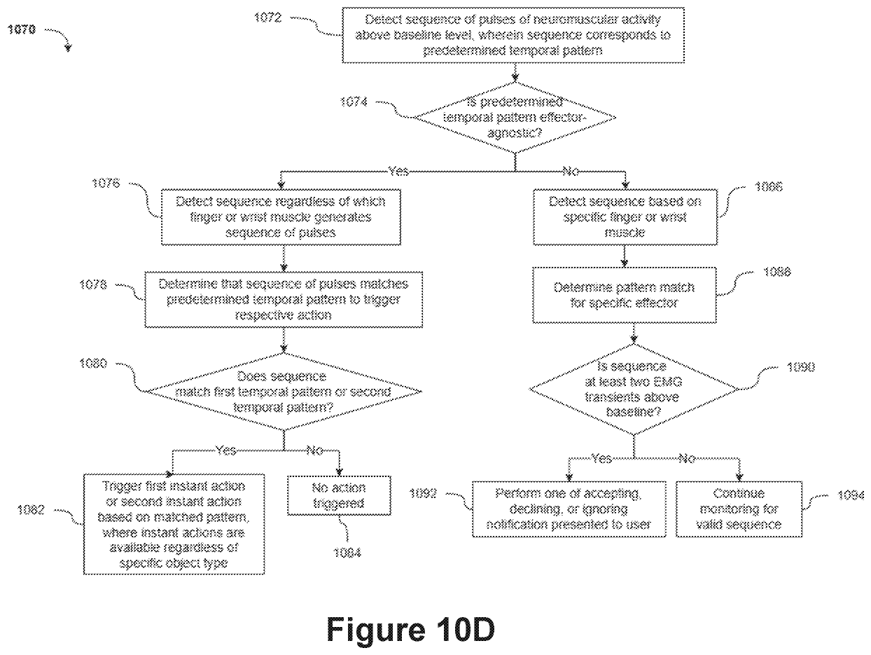

FIG. 10A illustrates a flowchart for a method 1000 for executing actions associated with an identified object type of an object held in the hand of a user, based on user performance of a gesture, in accordance with some embodiments. The method 1000 begins with step 1002, where while a hand of a user is holding a first object, the system determines, using data from a camera of a head-worn device, a first object type for the first object. The method 1000 then proceeds to step 1004, where the system causes presentation, via the head-worn device, of a first action associated with the first object type. The method 1000 then moves to step 1006, where in response to an indication, based on data from a wrist-wearable device, that the user performed a gesture using the hand holding the first object, the system causes execution of the first action. Following step 1006, the method 1000 continues to step 1008, where while the hand of the user is holding a second object distinct from the first object, the system determines, using other data from the camera of the head-worn device, a second object type for the second object, the second object type being distinct from the first object type. The method 1000 then proceeds to step 1010, where the system causes presentation, via the head-worn device, of a second action associated with the second object type. The method 1000 concludes with step 1012, where in response to an indication, based on data from the wrist-wearable device, that the user performed the gesture using the hand holding the second object, the system causes execution of the second action. The flowchart for the method 1000 illustrates the sequence of operations for determining object types using computer vision data from a head-worn device and executing object-type-specific actions based on gestures detected via a wrist-wearable device while the user holds different objects.

FIG. 10B illustrates a flowchart for a method 1016 for determining object type and executing actions based on gesture detection, in accordance with some embodiments. The method 1016 begins with step 1020, where the system determines a first object type for a first object held by the user. The method 1016 then proceeds to step 1022, where a determination is made whether the gesture is a subtle gesture (e.g., a microgesture) applying force to the object via one or more digits. If the gesture is a subtle gesture (Yes branch), the method 1016 proceeds to step 1024, where the system detects the subtle gesture including applying, via one or more digits of the hand of the user, force to the first or second object. If the gesture is not a subtle gesture (No branch), the method 1016 proceeds to step 1026, where the system detects another gesture type. Following step 1024, the method 1016 continues to step 1028, where the system causes presentation of more than one suggested action, each associated with a different gesture. Following step 1026, the method 1016 continues to step 1030, where the system causes presentation of a single suggested action. After step 1028, the method 1016 proceeds to step 1032, where the system executes an action based on the detected gesture type and object type, where each respective object type is associated with different sets of suggested actions. After step 1030, the method 1016 proceeds to step 1034, where the system executes an action based on the detected gesture and object type. The flowchart for the method 1016 illustrates the sequence of operations for determining object types held by a user and executing corresponding actions based on the type of gesture detected, enabling different action presentations and executions depending on whether a subtle gesture or other gesture type is performed.

FIG. 10C illustrates a flowchart for a method 1050 for determining object types using computer vision and gaze detection, in accordance with some embodiments. The method 1050 begins with step 1052, where data from a camera of a head-worn device is applied to a computer vision (CV) machine-learning model. The method 1050 then proceeds to step 1054, where a set of object properties of an object encumbering the hand of a user is identified. The method 1050 then moves to step 1056, where a determination is made whether a gaze detection determination indicates that the user is looking at the object while holding the object. If the gaze detection determination is made (Yes branch), the method 1050 proceeds to step 1058, where respective object types of a first object and a second object are determined via an AI agent, in accordance with the gaze detection determination. Following step 1058, the method 1050 continues to step 1060, where at least one object-type-specific user query is generated from a set of object-type-specific user queries, wherein each respective query corresponds to at least one respective object type from a predetermined group. If the gaze detection determination is not made (No branch), the method 1050 proceeds to step 1062, where object types are determined without gaze detection. Following step 1062, the method 1050 continues to step 1064, where an object-type-specific user query is generated based on the identified object properties. The flowchart for the method 1050 illustrates the sequence of operations for determining object types using computer vision data from a head-worn device and generating object-type-specific queries based on whether gaze detection confirms that the user is looking at the object while holding it.

FIG. 10D illustrates a flowchart for a method 1070 for detecting a sequence of pulses of neuromuscular activity and triggering actions based on predetermined temporal patterns, in accordance with some embodiments. The method 1070 begins with step 1072, where the system detects a sequence of pulses of neuromuscular activity above a baseline level, wherein the sequence corresponds to a predetermined temporal pattern. The method 1070 then proceeds to step 1074, where a determination is made whether the predetermined temporal pattern is effector-agnostic. If the predetermined temporal pattern is effector-agnostic (Yes branch), the method 1070 proceeds to step 1076, where the system detects the sequence regardless of which finger or wrist muscle generates the sequence of pulses. Following step 1076, the method 1070 continues to step 1078, where the system determines that the sequence of pulses matches the predetermined temporal pattern to trigger a respective action. The method 1070 then moves to step 1080, where a determination is made whether the sequence matches a first temporal pattern or a second temporal pattern. If the sequence matches the first or second temporal pattern (Yes branch), the method 1070 proceeds to step 1082, where the system triggers a first instant action or a second instant action based on the matched pattern, where the instant actions are available regardless of a specific object type. If the sequence does not match the first or second temporal pattern (No branch), the method 1070 proceeds to step 1084, where no action is triggered. If the predetermined temporal pattern is not effector-agnostic (No branch from step 1074), the method 1070 proceeds to step 1086, where the system detects the sequence based on a specific finger or wrist muscle. Following step 1086, the method 1070 continues to step 1088, where the system determines a pattern match for a specific effector. The method 1070 then moves to step 1090, where a determination is made whether the sequence includes at least two EMG transients above the baseline. If the sequence includes at least two EMG transients above the baseline (Yes branch), the method 1070 proceeds to step 1092, where the system performs one of accepting, declining, or ignoring a notification presented to the user. If the sequence does not include at least two EMG transients above the baseline (No branch), the method 1070 proceeds to step 1094, where the system continues monitoring for a valid sequence.

(A1) In accordance with some embodiments, a method 500 for detecting subtle gestures via a wearable device worn by a user is described. The method 500 includes detecting (502) a first set of neuromuscular signals via one or more neuromuscular-signal sensors of a wearable device that is donned on a body portion of a user (see, e.g., FIGS. 1A-1C, wrist-wearable device 110). The method 500 includes, in accordance with a first indication, based on the first set of neuromuscular signals, that the body portion of the user is in a first state (see, e.g., FIG. 1A, hand 107 resting on table 115; FIGS. 2A-2H, hand 107 in loose fist position; FIGS. 3A-3F, user 305 holding dumbbell 308; FIGS. 4A-4E, user 105 holding cup), monitoring (504) a second set of neuromuscular signals via the one or more neuromuscular-signal sensors of the wearable device. The method 500 includes, in accordance with a determination (506) that the second set of neuromuscular signals satisfy a gesture detection threshold, and one or more situational criteria are satisfied detecting (508) a gesture performed by the user (see, e.g., FIG. 1B, subtle phalange movements 140; FIG. 3B, double-press flexions of ring finger 310) and transmitting (510) instructions associated with the gesture to at least one communicatively coupled device. The method 500 further includes, in accordance with a second indication, based on the second set of neuromuscular signals, that the body portion of the user is in a second state, ceasing (512) to monitor the second set of neuromuscular signals (see, e.g., FIG. 2H, hand 107 movement causing transition to second state). For example, as described above in reference to FIGS. 1A-1C, a subtle gesture detection system 100 can detect subtle gestures performed by the user based on a current state of a body portion of the user and/or subsequent neuromuscular signals detected from the user while the body portion of the user is in a particular state.

(A2) In some embodiments of A1, the method 500 further includes, in accordance with a third indication, based on the first set of neuromuscular signals, that the body portion of the user is in the second state, forgoing to monitor the second set of neuromuscular signals via the one or more neuromuscular-signal sensors of the wearable device. In other words, when the body portion of the user does not enter the first state, the wrist-wearable device 110 does not monitor neuromuscular signals for detecting subtle gestures (see, e.g., FIG. 5, method 500 flow).

(A3) In some embodiments of any of A1-A2, the method 500 includes, before detecting the first set of neuromuscular signals, receiving a fourth indication of an event initiated at or an ongoing event performed at the wearable device (or other communicatively coupled device) (see, e.g., FIG. 1A, wrist-wearable device message notification 130 and head-wearable device message notification 132). In other words, the method 500 can include a determination that a context-based gate (describe above in reference to FIGS. 3A-3F) is satisfied before detecting a first set of neuromuscular signals via one or more neuromuscular-signal sensors of a wearable device and determining, based on the first set of neuromuscular signals, that the body portion of the user is in a first state. In other words, the one or more situational criteria can be implemented before detecting the first set of neuromuscular signals and/or the second set of neuromuscular signals.

(A4) In some embodiments of any of A1-A3, the first state includes one or more of i) muscle activation without changes in muscle length or joint angle (e.g., which can occur when a force is applied against a surface, resulting in muscle activation without changes in muscle length or joint angle (isometric contraction)); see, e.g., FIG. 1A, hand 107 on table 115), ii) muscle activation of a phalange flexor at a force magnitude (e.g., which can occur when holding something, the finger flexor muscles activate to close the fingers around the object (flexion) at a force level proportional to the weight of the object; see, e.g., FIGS. 3A-3F, user 305 holding dumbbell 308; FIGS. 4A-4E, user 105 holding cup), and/or iii) maintained position of the body portion of the user (e.g., which can occur when the user holds their hand in a loose fist position in the absence of an object for covert interactions: finger flexion is subtly and comfortably performed by pressing into the hand itself; see, e.g., FIGS. 2A-2H, hand 107 in loose fist position).

(A5) In some embodiments of any of A1-A4, the first state includes the body portion of the user disposed on a surface (e.g., resting the hand on a thigh, a table, etc. ; see, e.g., FIG. 1A, hand 107 resting on table 115).

(A6) In some embodiments of any of A1-A5, the first state includes the body portion of the user held in a predetermined position (e.g., the user holding their hand is a loose fist while the user is moving (e.g., walking, running, lifting, etc.) or stationary (e.g., sitting); see, e.g., FIGS. 2A-2H, hand 107 in loose fist position while on-the-go).

(A7) In some embodiments of any of A1-A6, the first state includes the body portion of the user applies a (proportional) force on an object (e.g., while the user is encumbered or holding an object and applying a force proportional to a weight of the object; see, e.g., FIGS. 3A-3F, user 305 holding dumbbell 308; FIGS. 4A-4E, user 105 holding cup; FIGS. 6A-6E, user 105 holding snack item 602). Different examples of the first state are described above in reference to FIGS. 1A-4E.

(A8) In some embodiments of any of A1-A7, the second state is muscle activation or a position of the body portion of the user that does not allow for the (accurate) detection of finger flexion. In some embodiments, the second state is any change of the body portion of the user from the first state. In some embodiments, the second state is a non-steady position (e.g., movement at a non-constant rate, sudden or sharp changes in position, etc.) of the body portion of the user (see, e.g., FIG. 2H, hand 107 movement causing transition to second state).

(A9) In some embodiments of any of A1-A8, the situational criteria includes one or more of i) presence of a context-based cue (e.g., AR context cues; see, e.g., FIG. 1A, message notification triggering gesture detection) and/or ii) detection of respective neuromuscular signals within a predetermined threshold period of time. (e.g., after the occurrence of a scenario or event (e.g., receiving a text, call, etc. ; see, e.g., FIGS. 1A-1C, responding to message notification). Additional detail on the situational criteria is provided above in reference to FIGS. 3A-3F.

(A10) In some embodiments of any of A1-A9, the second set of neuromuscular signals are representative of a flexion event performed by one or more phalanges (e.g., a subtle single press, a double press, and/or press-and-hold flexion events of the thumb, index finger, and middle finger that can be performed when the hand is empty or encumbered; see, e.g., FIG. 1B, subtle phalange movements 140; FIG. 2C, subtle movements of thumb 212 and pinky finger 210; FIG. 3B, double-press flexions of ring finger 310).

(A11) In some embodiments of any of A1-A10, the determination that the second set of neuromuscular signals satisfy the gesture detection threshold includes i) determining one or more weights for neuromuscular signals of the second set of neuromuscular signals, and ii) determining that a weighted neuromuscular signal of the second set of neuromuscular signals satisfies the gesture detection threshold. Different weights are discussed above in reference to FIGS. 3A-3F (see, e.g., FIG. 3B, gesture detection during physical activity with adjusted thresholds).

(A12) In some embodiments of any of A1-A11, the determination that the second set of neuromuscular signals satisfy the gesture detection threshold includes detecting at least two repeated neuromuscular signals of the second set of neuromuscular signals (see, e.g., FIG. 1B, subtle phalange movements 140 representing double press; FIG. 3B, double-press flexions of ring finger 310). Non-limiting examples of additional gestures are provided above in reference to FIGS. 1A-4E.

(A13) In some embodiments of any of A1-A12, the second set of neuromuscular signals are obtained while the body portion of the user is in the first state.

(A14) In some embodiments of any of A1-A13, the method 500 further includes receiving, from a communicatively coupled device, sensor data; and determining, based on the sensor data satisfaction of the one or more situational criteria are satisfied (see, e.g., FIG. 1A, head-wearable device 120 providing context data). For example, image data received from a head-wearable device and can be used to determine that a context-based cue is satisfied. For example, image data can be used to determine that the user is engaged in an activity (e.g., user is working out, the user is cooking, etc.), and initiate the subtle detection of gestures (e.g., using the second set of neuromuscular signals; see, e.g., FIGS. 3A-3F, workout activity detection; FIGS. 4A-4E, travel activity detection).

(B1) In accordance with some embodiments, a method for executing actions associated with an identified object type of an object held in the hand of a user is described (see, e.g., FIGS. 6A-7D; FIG. 10A, method 1000). The method includes, while a hand of a user is holding a first object (e.g., the snack item 602 shown in FIGS. 6A to 6E), determining, using data from a camera of a head-worn device (e.g., head-wearable device 120), a first object type for the first object. The method includes causing presentation, via the head-worn device, of a first action associated with the first object type. For example, in FIG. 6B, the head-wearable device 120 presents a user interface element 604a that correspond to a particular action associated with the object type of the food item 602.

The method includes, in response to an indication, based on data from a wrist-wearable device, that the user performed a gesture using the hand that is holding the first object, causing execution of the first action. The method further includes, while the hand of the user is holding a second object distinct from the first object, determining, using other data from the camera of the head-worn device, a second object type for the second object, the second object type being distinct from the first object type. The method includes causing presentation, via the head-worn device, of a second action associated with the second object type. The method includes, in response to an indication, based on data from the wrist-wearable device, that the user performed the gesture using the hand that is holding the second object, causing execution of the second action. For example, as described above in reference to FIGS. 6A-7D, a computing system can detect that a user is holding different objects and present object-type-specific actions that can be executed via gesture detection.

(B2) In some embodiments of B1, the gesture is a subtle gesture in which the user applies a force to the first or second object using one or more digits of the hand (see, e.g., FIG. 6D, thumb press 608 against snack item 602; FIG. 7B, index finger press 708 against book 710). For example, as described above in reference to FIG. 6D, the user may perform a thumb press against a food item to trigger execution of an associated action such as providing nutrition information.

(B3) In some embodiments of any of B1-B2, the method further includes, while the hand of the user is holding a third object distinct from the first and second objects, determining, using data from the camera of the head-worn device, a third object type for the third object, the third object type being distinct from the first object type and the second object type. The method includes causing presentation, via the head-worn device, of a third action associated with the third object type. The method includes, in response to an indication, based on data from the wrist-wearable device, that the user performed the gesture using the hand that is holding the third object, causing execution of the third action.

(B4) In some embodiments of any of B1-B3, the method further includes, while the hand of the user is holding a fourth object distinct from the first, second, and third objects, determining, using data from the camera of the head-worn device, a fourth object type for the fourth object, the fourth object type being distinct from the first, second, and third object types. The method includes causing presentation, via the head-worn device, of a fourth action associated with the fourth object type. The method includes, in response to an indication, based on data from the wrist-wearable device, that the user performed the gesture using the hand that is holding the fourth object, causing execution of the fourth action.

(B5) In some embodiments of any of B1-B4, the method further includes causing presentation of more than one suggested action, each associated with a different gesture (see, e.g., FIG. 7C, user interface element 604c corresponding to review action presented after transitioning from translation action; FIG. 10B, method 1016 showing presentation of multiple suggested actions at step 1028). For example, a user holding a book may be presented with both a translation action and a review action, where each action can be triggered by a different gesture type.

(B6) In some embodiments of any of B1-B5, each respective object type, including the first and second object types, are associated with different sets of suggested actions (see, e.g., FIGS. 6A-6E, food object type associated with nutrition action; FIGS. 7A-7D, book object type associated with translation and review actions). For example, as described above in reference to FIGS. 6A-7D, a book object type may be associated with actions such as translation and review information, while a food object type may be associated with actions such as nutrition information.

(B7) In some embodiments of any of B1-B6, the execution of the first or second action includes generating at least one object-type-specific user query from a set of object-type-specific user queries, wherein each respective object-type-specific user query corresponds to at least one respective object type selected from a predetermined group of object types.

(B8) In some embodiments of any of B1-B7, the first object type of the first object is determined by applying the data from the camera of the head-worn device to a computer vision (CV) machine-learning model to identify a set of object properties of the object that is encumbering the hand of the user (see, e.g., FIG. 10C, method 1050 showing CV model application at step 1052). For example, the properties may include the object's identity, visible labels, the language of visible labels, color, size, or shape.

(B9) In some embodiments of any of B1-B8, the user is wearing a wrist-wearable device that is configured to detect a set of neuromuscular-detectable gestures that meet or exceed a respective gesture detection threshold of a set of gesture detection thresholds. While the hand of the user is holding the first object, the wrist-wearable device is configured to detect another set of neuromuscular-detectable gestures directed towards the object that the hand of the user is holding, wherein the other set of neuromuscular-detectable gestures is associated with another respective gesture detection threshold of the set of gesture detection thresholds (see, e.g., FIGS. 6A-6E, EMG sensors graphs 640-1 through 640-5 showing different signal baselines; FIG. 6B, encumbered EMG signal baseline 642b compared to unencumbered EMG signal baseline 642a). For example, as described above in reference to FIGS. 6A-6E, the encumbered EMG signal baseline may differ from the unencumbered EMG signal baseline.

(B10) In some embodiments of any of B1-B9, the method further includes determining respective object types of the first object and the second object via an AI agent, in accordance with a determination via gaze detection that the user is looking at the object while the user is holding the object (see, e.g., FIG. 10C, method 1050 showing gaze detection determination at step 1056 and AI agent determination at step 1058).

(B11) In some embodiments of any of B1-B10, the execution of the first action or the second action includes altering at least one of a manipulatable display, audio output, or power of a communicatively coupled device (see, e.g., FIGS. 8A-8D, video selection and playback control; FIGS. 9A-9E, audio playback control via media player user interface element 906). For example, as described above in reference to FIGS. 8A-8D and 9A-9E, a user may control video playback or audio output while holding an object.

(B12) In some embodiments of any of B1-B11, the method further includes, prior to causing presentation of the first action, responsive to a user input distinct from the gesture, invoking an AI agent with respect to the object.

(B13) In some embodiments of any of B1-B12, the method further includes, before performing either the first action or the second action, presenting a user query to the user based on a detection of another gesture different than the gesture, wherein the user query is selected from a set of user queries associated with the object type.

(B14) In some embodiments of any of B1-B13, detecting the user input comprises detecting a sequence of pulses of neuromuscular activity above a baseline level, wherein the sequence of pulses corresponds to a predetermined temporal pattern, and determining that the sequence of pulses matches the predetermined temporal pattern to trigger a respective action of a set of actions that includes one or more of the first action and the second action (see, e.g., FIG. 10D, method 1070 showing temporal pattern detection at steps 1072-1078).

(B15) In some embodiments of B14, the predetermined temporal pattern is effector-agnostic such that the sequence of pulses is detectable regardless of which finger or wrist muscle of the user generates the sequence of pulses (see, e.g., FIG. 10D, step 1076 showing effector-agnostic detection).

(B16) In some embodiments of B14, the predetermined temporal pattern comprises a personalized rhythmic sequence associated with the user. In some embodiments, the user can manually define the personalized rhythmic sequence.

(B17) In some embodiments of B14, a length and complexity of the predetermined temporal pattern is configured based on a false positive requirement of an application associated with the respective action. For example, an entertainment or informational application such as a weather application or a content streaming application may have a first false positive requirement, and a business or otherwise protected application may have a second false positive requirement higher than the first false positive requirement.

(B18) In some embodiments of B14, the method further includes detecting a sequence of EMG pulses above a baseline level that matches a first temporal pattern to trigger a first instant action, and detecting another sequence of EMG pulses above the baseline level that matches a second temporal pattern, different from the first temporal pattern, to trigger a second instant action different from the first instant action (see, e.g., FIG. 10D, steps 1080-1082 showing first and second temporal pattern matching to trigger respective instant actions).

(B19) In some embodiments of B18, the first instant action and the second instant action are available regardless of a specific object type of the object that is encumbering the hand of the user.

(B20) In some embodiments of any of B1-B19, the method further includes detecting a sequence of at least two EMG transients above a baseline level, and in response to detecting the sequence of at least two EMG transients, performing one of accepting, declining, or ignoring a notification presented to the user (see, e.g., FIG. 10D, steps 1090-1092 showing EMG transient detection and notification handling; FIGS. 1A-1C, responding to message notification via subtle gestures).

(C1) In some embodiments, a method is provided for performing gestures directed to held objects that correspond to respective digit-to-digit gestures is described herein (see, e.g., FIGS. 9A-9E, gestures directed to can 810 corresponding to digit-to-digit gestures). The method includes, while a hand of a user is holding a physical object having a surface, in accordance with a determination, using data from one or more biopotential-signal sensors of a wrist-wearable device worn by the user, that the user is performing a gesture on the surface (see, e.g., FIG. 9B, thumb tap 914 against can 810), causing performance of an action at the wrist-wearable device or a communicatively coupled device. And the method includes, in accordance with a determination, using additional data from the one or more biopotential-signal sensors of the wrist-wearable device worn by the user, that the user is performing a digit-to-digit gesture using the hand, causing performance of the same action at the wrist-wearable device or the communicatively coupled device (see, e.g., FIGS. 9A-9E, gesture output 908a-908d showing mapping between encumbered gestures and corresponding digit-to-digit gestures).

(C2) In some embodiments of C1, the communicatively coupled device is a pair of smart glasses or AR glasses.

(C3) In some embodiments of C1 or C2, the action is caused to be performed at the wrist-wearable device (e.g., at a user interface of the wrist-wearable device).

(C4) In some embodiments of any one of C1 to C3, the communicatively coupled device is display-less smart glasses, the action is caused to be performed at the display-less smart glasses, and an audio indication is provided, at the display-less smart glasses, indicating that the action was performed based on the gesture on the surface of the object (see, e.g., FIGS. 9A-9E, audio output 910 providing feedback for gesture-triggered actions).

(C5) In some embodiments of any one of C1 to C4, the method further includes, while a hand of the user is in contact with a surface of a stationary object external to the hand of the user (see, e.g., FIG. 1A, hand 107 resting on table 115), in accordance with a determination, using data from the one or more biopotential-signal sensors of the wrist-wearable device worn by the user, that the user is performing a gesture on the surface of the stationary object external to the hand of the user, causing performance of the action at the wrist-wearable device or a communicatively coupled device. In other words, the same action that is triggered by a gesture directed to a surface of a held object or by a digit-to-digit gesture can also be triggered by a gesture directed to a stationary external surface, such as a table, a thigh, or an armrest (see, e.g., FIGS. 1A-1C, subtle phalange movements 140 and 145 performed while hand 107 rests on table 115).

(C6) In some embodiments of any one of C1 to C5, the method further includes, while the hand of the user is holding the physical object having a surface: determining, using data from a camera of a head-worn device worn by the user, a first object type of the physical object (see, e.g., FIGS. 6A-6E, determining object type of snack item 602; FIGS. 7A-7D, determining object type of book 710; FIG. 10A, method 1000 at step 1002; FIG. 10C, method 1050 at steps 1052-1058); causing presentation via the head-worn device, of a first object-type-specific action, different than the action, associated with the first object type (see, e.g., FIG. 6C, user interface element 604a corresponding to nutrition action; FIG. 7B, user interface element 604b corresponding to translation action); and in accordance with a determination, using data from the one or more biopotential-signal sensors of the wrist-wearable device worn by the user, that the user is performing another gesture on the surface of the physical object, the other gesture corresponding to the first object-type-specific action associated with the first object type, and further based on a determination that the user is performing the other gesture on the surface while the first object-type-specific action is being presented via the head-worn device, causing performance of the first object-type-specific action at the wrist-wearable device or a communicatively coupled device (see, e.g., FIG. 6D, thumb press 608 against snack item 602 causing execution of nutrition action; FIG. 7D, tap gesture 714 against book 710 causing execution of review action).

(C7) In some embodiments of C6, the method further includes, while the hand of the user is holding another physical object having another surface: determining, using data from a camera of a head-worn device worn by the user, a second object type of the other physical object, the second object type being distinct from the first object type (see, e.g., FIGS. 6A-7D, transitioning from holding snack item 602 to holding book 710; FIG. 10A, method 1000 at step 1008); causing presentation via the head-worn device, of a second object-type-specific action associated with the second object type (see, e.g., FIG. 7B, user interface element 604b corresponding to translation action for book object type; FIG. 10A, method 1000 at step 1010); and in accordance with a determination, using data from the one or more biopotential-signal sensors of the wrist-wearable device worn by the user, that the user is performing the other gesture on the other surface and that the user is performing the other gesture on the surface while the second object-type-specific action is being presented via the head-worn device, causing performance of the second object-type-specific action at the wrist-wearable device or a communicatively coupled device (see, e.g., FIG. 10A, method 1000 at step 1012).

(C8) In some embodiments of any one of C1 to C7, the method further includes, while the hand of the user is holding the physical object, in accordance with a determination, using data from the one or more biopotential-signal sensors of the wrist-wearable device worn by the user, that the user is performing an encumbered gesture comprising one or more finger movements of: a flexion of one or more digits against a palm of the hand (see, e.g., FIGS. 2A-2H, phalange flexion performed by pressing into the hand 107 itself while in loose fist position), a press of one or more digits against the physical object (see, e.g., FIG. 6D, thumb press 608 against snack item 602; FIG. 7B, index finger press 708 against book 710), a tap of one or more digits against the physical object (see, e.g., FIG. 9B, thumb tap 914 against can 810; FIG. 9E, index finger tap 918 against can 810), or a squeeze of the physical object using two or more digits (see, e.g., FIG. 4D, subtle hand squeeze performed by flexions 413a and 413b): causing performance of another action, different from the action, at the wrist-wearable device or the communicatively coupled device, wherein the other action is the same action that would be caused to be performed if the user performed an unencumbered gesture comprising the one or more finger movements of the encumbered gesture (see, e.g., FIGS. 9A-9E, gesture output 908a-908d showing mapping between encumbered gestures and corresponding unencumbered digit-to-digit gestures).

(C9) In some embodiments of any one of C1 to C8, the determination that the user is performing a gesture on the surface of the physical object is further based on: detecting a sequence of pulses of neuromuscular activity data from the one or more biopotential-signal sensors of the wrist-wearable device that are above a baseline level, wherein the sequence of pulses corresponds to a predetermined temporal pattern (see, e.g., FIG. 10D, method 1070 at step 1072); and determining that the sequence of pulses matches the predetermined temporal pattern associated with the action (see, e.g., FIG. 10D, method 1070 at steps 1078-1082). In some embodiments, the determination that the user is performing a digit-to-digit gesture using the hand is further based on: detecting the sequence of pulses of neuromuscular activity data from the one or more biopotential-signal sensors of the wrist-wearable device that are above the baseline level, wherein the sequence of pulses corresponds to the predetermined temporal pattern; and determining that the sequence of pulses matches the predetermined temporal pattern associated with the action. In other words, the same predetermined temporal pattern can be used to detect both a gesture directed to a surface of a held object and a digit-to-digit gesture, such that the same action is triggered regardless of whether the user's hand is encumbered or unencumbered (see, e.g., FIGS. 9A-9E, different gesture types triggering corresponding actions while holding can 810).

(C10) In some embodiments of C9, the digit-to-digit gesture and the gesture directed to the surface are effector-specific such that they require at least one specific finger to be used for a respective portion of each gesture (see, e.g., FIG. 9B, thumb tap 914 requiring the thumb; FIG. 9E, index finger tap 918 requiring the index finger), and the predetermined temporal pattern is effector-agnostic such that the sequence of pulses is detectable regardless of which finger or wrist muscle of the user generates the sequence of pulses (see, e.g., FIG. 10D, step 1076 showing effector-agnostic detection). In other words, while the gesture directed to the surface and the digit-to-digit gesture each require specific digits to perform, the temporal pattern matching can be satisfied by pulses generated by any finger or wrist muscle, providing the user with flexibility in how they generate the required temporal pattern.

(C11) In some embodiments of any one of C1 to C10, the action is caused to be performed at the wrist-wearable device (see, e.g., FIGS. 3A-3F, actions performed at display 302 of wrist-wearable device 110, such as selection of pause user interface element 312 and check box user interface element 324) and/or at a head-wearable device communicatively coupled to the wrist-wearable device (see, e.g., FIGS. 2C-2G, actions performed at media player user interface element 208 presented via head-wearable device 120; FIGS. 8A-8D, actions performed at display component 812 presented via head-wearable device 120).

(D1) In accordance with some embodiments, a method is provided for performing object-type agnostic gestures while a hand of user is encumbered (see, e.g., FIGS. 8A-8D, cursor navigation and video selection; FIGS. 9A-9E, media playback control). The method includes, while a hand of a user that an unencumbered (e.g., while the user is not holding an object, while the user's hand is free), the hand including a wrist-wearable device: determining, using data from one or more biopotential-signal sensors (e.g., EMG sensors) of the wrist-wearable device of the user, that the user is performing a gesture having a gesture signature (e.g., a pinch between two digits, a tap between two digits, or a swipe of a digit); identifying, based on the gesture signature of the gesture, an action to perform within an augmented-reality (AR) environment (e.g., a ray-tracing operation to move a cursor within a user interface presented by AR glasses, as shown in FIG. 8B); and in accordance with determining that the gesture having the gesture signature satisfies an unencumbered gesture threshold (see, e.g., FIG. 6A, unencumbered EMG signal baseline 642a), cause execution of the first action. The method further includes, while the hand of the user is encumbered by a physical object (e.g., the can 810): determining, using other data from the one or more biopotential-signal sensors of the wrist-wearable device, that the user is performing another gesture having a different gesture signature; identifying, based on the different gesture signature of the other gesture, the action (i.e., the same action as caused by the unencumbered gesture) to perform within an augmented-reality environment (e.g., a selection of video content to initiate playback of at AR glasses, as shown in FIG. 8C); and in accordance with determining that the other gesture having the different gesture signature satisfies an encumbered gesture threshold (see, e.g., FIG. 6B, encumbered EMG signal baseline 642b), cause execution of the action. In other words, the techniques described herein allow users to perform actions while they are holding objects (or their hands are otherwise encumbered by objects) that they would otherwise cause performance of via hand gestures (e.g., in-air hand gestures, force-based gestures directed to peripheral components of AR glasses, etc.).

(D2) In some embodiments of D1, the encumbered gesture threshold is lower than the unencumbered gesture threshold. In other words, as shown in FIGS. 6A and 6B, once a user's hand becomes encumbered by, for instance, picking up an object, the computing system (e.g., computing system 600a) may be configured to recognize EMG signals having a lower signal amplitude as corresponding to gesture interactions with an AR environment of the computing system.

(D3) In some embodiments of D2, the other gesture with the different gesture signature is a subtle gesture that includes less movement of digits of the user than the gesture with the gesture signature.

(D4) In some embodiments of any one of D1 to D3, the action to be performed within the AR environment is directed to audio content configured to be presented by one or more speakers of AR glasses (see, e.g., FIGS. 9A-9E, audio output 910 presenting music content). For example, in FIGS. 9A to 9E, the user is performing gestures directed to the can 810 to cause playback of audio output 910 associated with a music application available within the AR environment.

(D5) In some embodiments of D4, a computing system causing presentation of the AR environment includes display-less AR glasses. That is, as described herein, an AR environment does not require presentation of visual content from a presentation component of AR glasses.

(D6) In some embodiments of D1 to D5, the method further includes, in accordance with determining that the hand of the user has become encumbered by the physical object, presenting a user interface element (e.g., a visual indicator, an audio output), indicating a status identifier of the hand of the user holding the object (see, e.g., FIG. 6B, visual overlay 605 indicating encumbered status; FIGS. 9A-9E, object type output 920 indicating held object type). For example, the object type output 920 in FIGS. 9A to 9E indicates that the user is holding the can 810, thereby indicating to the user that the encumbered gesture threshold must be met in order for the device to recognize gestures directed to the object.

(D7) In some embodiments of D6, the method further includes, after the hand of the user has become encumbered by the physical object, in accordance with detecting the other gesture, presenting another user interface element (e.g., another visual indicator adjacent to the visual indicator), the other user interface element indicating that the user has performed a respective gesture that is recognizable for causing operations within the AR environment (see, e.g., FIGS. 9A-9E, gesture indicator 908b, 908c, 908d showing detected gesture types). For example, FIGS. 9A to 9E show a user interface element 908 that indicates when the user 105 performs respective gestures directed to the held object (e.g., the can 810).

(D8) In some embodiments of D7, the other user interface element includes an indication that the other gesture corresponds to the gesture that the user performed when the hand of the user was unencumbered (see, e.g., FIG. 9B, gesture indicator 908b displaying “Gesture: Thumb Tap” to indicate correspondence with unencumbered thumb tap gesture). For example, in FIG. 9B, the user interface element 908b indicates that the thumb tap 914 that the user 105 performed against the can 810 corresponds to a thumb tap gesture.

(D9) In some embodiments of D1 to D8, the method further includes, while the hand of the user is still encumbered by the physical object: determining, using yet other data from the one or more biopotential-signal sensors of the wrist-wearable device, that the user is performing yet another gesture having another different gesture signature; identifying, based on the other different gesture signature of the yet other gesture, another action to perform within an augmented-reality environment; and, in accordance with determining that the other different gesture signature corresponds to a function of the physical object (e.g., that the user is drinking from the can 810; see, e.g., FIG. 8D, user drinking from can 810; FIG. 9C, user spinning can 810), forgoing performance of the other action.

(D10) In some embodiments of D1 to D9, the method further includes, in accordance with determining that the hand of the user has become encumbered by the physical object, presenting a visual overlay on the hand of the user (e.g., the visual overlay 605 shown in FIG. 6B), the visual overlay indicating an encumbered status of the hand of the user. In some embodiments, a different visual overlay can be presented on the hand of the user when it becomes unencumbered by the physical object that was encumbering it (see, e.g., FIG. 6E, user no longer holding snack item 602).

(E1) In accordance with some embodiments, a system including one or more of a wrist wearable device, a head-wearable device, and/or a handheld intermediary processing device, the system configured to perform operations corresponding to any of A1-A14 or any of B1-B20.

(F1) In accordance with some embodiments, a non-transitory computer readable storage medium including instructions that, when executed by a computing device in communication with one or more of a wrist-wearable device and a pair of augmented-reality glasses, cause the computer device to perform operations corresponding to any of A1-A14, B1-B20, C1-C4, or D1-D9.

(G1) In accordance with some embodiments, a wrist-wearable device including one or more neuromuscular-signal sensors, one or more processors, and memory storing one or more instructions, that when executed by the one or more processors, cause performance of operations corresponding to any of A1-A14, B1-B20, C1-C4, or D1-D9.

(H1) In accordance with some embodiments, a means on a wrist-wearable device, a head-wearable device, and/or a handheld intermediary processing device for performing or causing performance of operations corresponding to any of A1-A14, B1-B20, C1-C4, or D1-D9.

(I1) In accordance with some embodiments, a head-wearable device, including one or more processors, and memory storing one or more instructions, that when executed by the one or more processors, cause performance of operations corresponding to any of A1-A14, B1-B20, C1-C4, or D1-D9.

(J1) In accordance with some embodiments, an intermediary processing device configured to perform or cause performance of operations corresponding to any of A1-A14, B1-B20, C1-C4, or D1-D9.

(K1) In accordance with some embodiments, features from any of the embodiments described herein may be combined with features from any other embodiment. For example, features from any of embodiments A1-A14 may be combined with features from any of embodiments B1-B20, C1-C4, and/or D1-D10. As one example, the gesture detection thresholds and situational criteria described in embodiments A1-A14 (see, e.g., FIGS. 1A-4E) may be combined with the object-type-specific actions described in embodiments B1-B20 (see, e.g., FIGS. 6A-7D). As another example, the digit-to-digit gesture equivalence described in embodiments C1-C4 (see, e.g., FIGS. 9A-9E) may be combined with the encumbered and unencumbered gesture thresholds described in embodiments D1-D10 (see, e.g., FIGS. 6A-6E and 9A-9E). As yet another example, the temporal pattern detection described in embodiments B14-B19 may be combined with the subtle gesture detection during physical activity described in embodiments A1-A14 (see, e.g., FIGS. 3A-3F). As a further example, the object-type agnostic actions described in embodiments D1-D10 (see, e.g., FIGS. 8A-8D and 9A-9E) may be combined with the object-type specific actions described in embodiments B1-B13 (see, e.g., FIGS. 6A-7D). These combinations are provided as non-limiting examples, and other combinations of features across the various embodiments are contemplated and within the scope of this disclosure.

(K2) In some embodiments, the subtle gesture detection during different states described in embodiments A1-A14 may be combined with the object-type detection and associated actions described in embodiments B1-B20. For example, the determination that a body portion of the user is in a first state (e.g., holding an object, maintaining a loose fist position, or resting a hand on a surface as described in FIGS. 1A-2H) may be used to trigger object-type detection via a camera of a head-worn device (as described in FIGS. 6A-7D), such that object-type-specific actions are presented and executable via subtle gestures detected while the body portion remains in the first state. In this combination, the gesture detection thresholds, and situational criteria of embodiments A1-A14 may be applied to determine when to detect gestures for causing execution of the object-type-specific actions of embodiments B1-B20.

(K3) In some embodiments, the encumbered gesture thresholds described in embodiments D1-D10 may be applied to the object-type-specific actions described in embodiments B1-B20. For example, when a user is holding an object and an object type is determined for that object (as described in FIGS. 6A-7D), the encumbered EMG signal baseline (see, e.g., encumbered EMG signal baseline 642b in FIGS. 6B-6D) may be used to detect gestures for triggering object-type-specific actions associated with the determined object type. In this combination, the permissive gesture baseline for encumbered hands described in embodiments D1-D10 enables more subtle gestures to trigger the object-type-specific actions of embodiments B1-B20, allowing users to interact with held objects using lower-amplitude gestures than would be required when their hands are unencumbered.

(K4) In some embodiments, the temporal pattern detection described in embodiments B14-B19 may be combined with the digit-to-digit gesture equivalence described in embodiments C1-C4. For example, a predetermined temporal pattern (e.g., a sequence of pulses of neuromuscular activity) may be detected regardless of whether the user performs the pattern via a gesture directed to a surface of a held object or via a digit-to-digit gesture (as described in FIGS. 9A-9E). In this combination, the effector-agnostic nature of the temporal pattern detection allows the same action to be triggered by matching temporal patterns generated through either encumbered gestures directed to held objects or unencumbered digit-to-digit gestures, providing users with flexibility in how they interact with the system based on their current context and hand availability.

(K5) In some embodiments, the object-type agnostic actions described in embodiments D1-D10 may be available concurrently with the object-type-specific actions described in embodiments B1-B20. For example, while a user is holding an object and object-type-specific actions are presented based on the determined object type (as described in FIGS. 6A-7D), the user may also perform gestures that trigger object-type agnostic actions such as media playback control (as described in FIGS. 9A-9E) or cursor navigation (as described in FIGS. 8A-8D). In this combination, different gesture types or temporal patterns may be mapped to object-type-specific actions versus object-type agnostic actions, allowing users to access both categories of functionality while their hands remain encumbered by the held object.

### Example Extended-Reality Systems

FIGS. 11A-11C-2 illustrate example XR systems that include AR and MR systems, in accordance with some embodiments. FIG. 11A shows a first XR system 1100a and first example user interactions using a wrist-wearable device 1126, a head-wearable device (e.g., AR device 1128), and/or an HIPD 1142. FIG. 11B shows a second XR system 1100b and second example user interactions using a wrist-wearable device 1126, AR device 1128, and/or an HIPD 1142. FIGS. 11C-1 and 11C-2 show a third MR system 1100c and third example user interactions using a wrist-wearable device 1126, a head-wearable device (e.g., an MR device such as a VR device), and/or an HIPD 1142. As the skilled artisan will appreciate upon reading the descriptions provided herein, the above-example AR and MR systems (described in detail below) can perform various functions and/or operations.

The wrist-wearable device 1126, the head-wearable devices, and/or the HIPD 1142 can communicatively couple via a network 1125 (e.g., cellular, near field, Wi-Fi, personal area network, wireless LAN). Additionally, the wrist-wearable device 1126, the head-wearable device, and/or the HIPD 1142 can also communicatively couple with one or more servers 1130, computers 1140 (e.g., laptops, computers), mobile devices 1150 (e.g., smartphones, tablets), and/or other electronic devices via the network 1125 (e.g., cellular, near field, Wi-Fi, personal area network, wireless LAN). Similarly, a smart textile-based garment, when used, can also communicatively couple with the wrist-wearable device 1126, the head-wearable device(s), the HIPD 1142, the one or more servers 1130, the computers 1140, the mobile devices 1150, and/or other electronic devices via the network 1125 to provide inputs.

Turning to FIG. 11A, a user 1102 is shown wearing the wrist-wearable device 1126 and the AR device 1128 and having the HIPD 1142 on their desk. The wrist-wearable device 1126, the AR device 1128, and the HIPD 1142 facilitate user interaction with an AR environment. In particular, as shown by the first AR system 1100a, the wrist-wearable device 1126, the AR device 1128, and/or the HIPD 1142 cause presentation of one or more avatars 1104, digital representations of contacts 1106, and virtual objects 1108. As discussed below, the user 1102 can interact with the one or more avatars 1104, digital representations of the contacts 1106, and virtual objects 1108 via the wrist-wearable device 1126, the AR device 1128, and/or the HIPD 1142. In addition, the user 1102 is also able to directly view physical objects in the environment, such as a physical table 1129, through transparent lens(es) and waveguide(s) of the AR device 1128. Alternatively, an MR device could be used in place of the AR device 1128 and a similar user experience can take place, but the user would not be directly viewing physical objects in the environment, such as table 1129, and would instead be presented with a virtual reconstruction of the table 1129 produced from one or more sensors of the MR device (e.g., an outward facing camera capable of recording the surrounding environment).

The user 1102 can use any of the wrist-wearable device 1126, the AR device 1128 (e.g., through physical inputs at the AR device and/or built-in motion tracking of a user's extremities), a smart-textile garment, externally mounted extremity tracking device, the HIPD 1142 to provide user inputs, etc. For example, the user 1102 can perform one or more hand gestures that are detected by the wrist-wearable device 1126 (e.g., using one or more EMG sensors and/or IMUs built into the wrist-wearable device) and/or AR device 1128 (e.g., using one or more image sensors or cameras) to provide a user input. Alternatively, or additionally, the user 1102 can provide a user input via one or more touch surfaces of the wrist-wearable device 1126, the AR device 1128, and/or the HIPD 1142, and/or voice commands captured by a microphone of the wrist-wearable device 1126, the AR device 1128, and/or the HIPD 1142. The wrist-wearable device 1126, the AR device 1128, and/or the HIPD 1142 include an artificially intelligent digital assistant to help the user in providing a user input (e.g., completing a sequence of operations, suggesting different operations or commands, providing reminders, confirming a command). For example, the digital assistant can be invoked through an input occurring at the AR device 1128 (e.g., via an input at a temple arm of the AR device 1128). In some embodiments, the user 1102 can provide a user input via one or more facial gestures and/or facial expressions. For example, cameras of the wrist-wearable device 1126, the AR device 1128, and/or the HIPD 1142 can track the user 1102's eyes for navigating a user interface.

The wrist-wearable device 1126, the AR device 1128, and/or the HIPD 1142 can operate alone or in conjunction to allow the user 1102 to interact with the AR environment. In some embodiments, the HIPD 1142 is configured to operate as a central hub or control center for the wrist-wearable device 1126, the AR device 1128, and/or another communicatively coupled device. For example, the user 1102 can provide an input to interact with the AR environment at any of the wrist-wearable device 1126, the AR device 1128, and/or the HIPD 1142, and the HIPD 1142 can identify one or more back-end and front-end tasks to cause the performance of the requested interaction and distribute instructions to cause the performance of the one or more back-end and front-end tasks at the wrist-wearable device 1126, the AR device 1128, and/or the HIPD 1142. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 1142 can perform the back-end tasks and provide the wrist-wearable device 1126 and/or the AR device 1128 operational data corresponding to the performed back-end tasks such that the wrist-wearable device 1126 and/or the AR device 1128 can perform the front-end tasks. In this way, the HIPD 1142, which has more computational resources and greater thermal headroom than the wrist-wearable device 1126 and/or the AR device 1128, performs computationally intensive tasks and reduces the computer resource utilization and/or power usage of the wrist-wearable device 1126 and/or the AR device 1128.

In the example shown by the first AR system 1100a, the HIPD 1142 identifies one or more back-end tasks and front-end tasks associated with a user request to initiate an AR video call with one or more other users (represented by the avatar 1104 and the digital representation of the contact 1106) and distributes instructions to cause the performance of the one or more back-end tasks and front-end tasks. In particular, the HIPD 1142 performs back-end tasks for processing and/or rendering image data (and other data) associated with the AR video call and provides operational data associated with the performed back-end tasks to the AR device 1128 such that the AR device 1128 performs front-end tasks for presenting the AR video call (e.g., presenting the avatar 1104 and the digital representation of the contact 1106).

In some embodiments, the HIPD 1142 can operate as a focal or anchor point for causing the presentation of information. This allows the user 1102 to be generally aware of where information is presented. For example, as shown in the first AR system 1100a, the avatar 1104 and the digital representation of the contact 1106 are presented above the HIPD 1142. In particular, the HIPD 1142 and the AR device 1128 operate in conjunction to determine a location for presenting the avatar 1104 and the digital representation of the contact 1106. In some embodiments, information can be presented within a predetermined distance from the HIPD 1142 (e.g., within five meters). For example, as shown in the first AR system 1100a, virtual object 1108 is presented on the desk some distance from the HIPD 1142. Similar to the above example, the HIPD 1142 and the AR device 1128 can operate in conjunction to determine a location for presenting the virtual object 1108. Alternatively, in some embodiments, presentation of information is not bound by the HIPD 1142. More specifically, the avatar 1104, the digital representation of the contact 1106, and the virtual object 1108 do not have to be presented within a predetermined distance of the HIPD 1142. While an AR device 1128 is described working with an HIPD, an MR headset can be interacted with in the same way as the AR device 1128.

User inputs provided at the wrist-wearable device 1126, the AR device 1128, and/or the HIPD 1142 are coordinated such that the user can use any device to initiate, continue, and/or complete an operation. For example, the user 1102 can provide a user input to the AR device 1128 to cause the AR device 1128 to present the virtual object 1108 and, while the virtual object 1108 is presented by the AR device 1128, the user 1102 can provide one or more hand gestures via the wrist-wearable device 1126 to interact and/or manipulate the virtual object 1108. While an AR device 1128 is described working with a wrist-wearable device 1126, an MR headset can be interacted with in the same way as the AR device 1128.

### Integration of Artificial Intelligence With XR Systems

FIG. 11A illustrates an interaction in which an artificially intelligent virtual assistant can assist in requests made by a user 1102. The AI virtual assistant can be used to complete open-ended requests made through natural language inputs by a user 1102. For example, in FIG. 11A the user 1102 makes an audible request 1144 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 11A also illustrates an example neural network 1152 used in Artificial Intelligence applications. Uses of Artificial Intelligence (AI) are varied and encompass many distinct aspects of the devices and systems described herein. AI capabilities cover a diverse range of applications and deepen interactions between the user 1102 and user devices (e.g., the AR device 1128, an MR device 1132, the HIPD 1142, the wrist-wearable device 1126). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein, that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 1102 can interact with an AI model through natural language inputs captured by a voice sensor, text inputs, or any other input modality that accepts natural language and/or a corresponding voice sensor module. In another instance, input is provided by tracking the eye gaze of a user 1102 via a gaze tracker module. Additionally, the AI model can also receive inputs beyond those supplied by a user 1102. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors'data can be retrieved entirely from a single device (e.g., AR device 1128) or from multiple devices that are in communication with each other (e.g., a system that includes at least two of an AR device 1128, an MR device 1132, the HIPD 1142, the wrist-wearable device 1126, etc.). The AI model can also access additional information (e.g., one or more servers 1130, the computers 1140, the mobile devices 1150, and/or other electronic devices) via a network 1125.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 1128, an MR device 1132, the HIPD 1142, the wrist-wearable device 1126) via the one or more networks. The cloud-computing platforms provide scalable computing resources, distributed computing, managed AI services, interference acceleration, pre-trained models, APIs, and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 1128, an MR device 1132, the HIPD 1142, the wrist-wearable device 1126), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 1142), haptic feedback can provide information to the user 1102. An AI model can also use the inputs described above to determine the appropriate modality and device(s) to present content to the user (e.g., a user walking on a busy road can be presented with an audio output instead of a visual output to avoid distracting the user 1102).

### Example Augmented Reality Interaction

FIG. 11B shows the user 1102 wearing the wrist-wearable device 1126 and the AR device 1128 and holding the HIPD 1142. In the second AR system 1100b, the wrist-wearable device 1126, the AR device 1128, and/or the HIPD 1142 are used to receive and/or provide one or more messages to a contact of the user 1102. In particular, the wrist-wearable device 1126, the AR device 1128, and/or the HIPD 1142 detect and coordinate one or more user inputs to initiate a messaging application and prepare a response to a received message via the messaging application.

In some embodiments, the user 1102 initiates, via a user input, an application on the wrist-wearable device 1126, the AR device 1128, and/or the HIPD 1142 that causes the application to initiate on at least one device. For example, in the second AR system 1100b the user 1102 performs a hand gesture associated with a command for initiating a messaging application (represented by messaging user interface 1112); the wrist-wearable device 1126 detects the hand gesture; and, based on a determination that the user 1102 is wearing the AR device 1128, causes the AR device 1128 to present a messaging user interface 1112 of the messaging application. The AR device 1128 can present the messaging user interface 1112 to the user 1102 via its display (e.g., as shown by user 1102's field-of-view 1110). In some embodiments, the application is initiated and can be run on the device (e.g., the wrist-wearable device 1126, the AR device 1128, and/or the HIPD 1142) that detects the user input to initiate the application, and the device provides another device operational data to cause the presentation of the messaging application. For example, the wrist-wearable device 1126 can detect the user input to initiate a messaging application, initiate, and run the messaging application, and provide operational data to the AR device 1128 and/or the HIPD 1142 to cause presentation of the messaging application. Alternatively, the application can be initiated and run at a device other than the device that detected the user input. For example, the wrist-wearable device 1126 can detect the hand gesture associated with initiating the messaging application and cause the HIPD 1142 to run the messaging application and coordinate the presentation of the messaging application.

Further, the user 1102 can provide a user input provided at the wrist-wearable device 1126, the AR device 1128, and/or the HIPD 1142 to continue and/or complete an operation initiated at another device. For example, after initiating the messaging application via the wrist-wearable device 1126 and while the AR device 1128 presents the messaging user interface 1112, the user 1102 can provide an input at the HIPD 1142 to prepare a response (e.g., shown by the swipe gesture performed on the HIPD 1142). The user 1102's gestures performed on the HIPD 1142 can be provided and/or displayed on another device. For example, the user 1102's swipe gestures performed on the HIPD 1142 are displayed on a virtual keyboard of the messaging user interface 1112 displayed by the AR device 1128.

In some embodiments, the wrist-wearable device 1126, the AR device 1128, the HIPD 1142, and/or other communicatively coupled devices can present one or more notifications to the user 1102. The notification can be an indication of a new message, an incoming call, an application update, a status update, etc. The user 1102 can select the notification via the wrist-wearable device 1126, the AR device 1128, or the HIPD 1142 and cause presentation of an application or operation associated with the notification on at least one device. For example, the user 1102 can receive a notification that a message was received at the wrist-wearable device 1126, the AR device 1128, the HIPD 1142, and/or other communicatively coupled device and provide a user input at the wrist-wearable device 1126, the AR device 1128, and/or the HIPD 1142 to review the notification, and the device detecting the user input can cause an application associated with the notification to be initiated and/or presented at the wrist-wearable device 1126, the AR device 1128, and/or the HIPD 1142.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 1128 can present to the user 1102 game application data and the HIPD 1142 can use a controller to provide inputs to the game. Similarly, the user 1102 can use the wrist-wearable device 1126 to initiate a camera of the AR device 1128, and the user can use the wrist-wearable device 1126, the AR device 1128, and/or the HIPD 1142 to manipulate the image capture (e.g., zoom in or out, apply filters) and capture image data.

While an AR device 1128 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances, an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in an analogous manner to an MR headset, which is described below in the proceeding sections.

### Example Mixed Reality Interaction

Turning to FIGS. 11C-1 and 11C-2, the user 1102 is shown wearing the wrist-wearable device 1126 and an MR device 1132 (e.g., a device capable of providing either an entirely VR experience or an MR experience that displays object(s) from a physical environment at a display of the device) and holding the HIPD 1142. In the third MR system 1100c, the wrist-wearable device 1126, the MR device 1132, and/or the HIPD 1142 are used to interact within an MR environment, such as a VR game or other MR/VR application. While the MR device 1132 presents a representation of a VR game (e.g., MR game environment 1120) to the user 1102, the wrist-wearable device 1126, the MR device 1132, and/or the HIPD 1142 detect and coordinate one or more user inputs to allow the user 1102 to interact with the VR game.

In some embodiments, the user 1102 can provide a user input via the wrist-wearable device 1126, the MR device 1132, and/or the HIPD 1142 that causes an action in a corresponding MR environment. For example, the user 1102 in the third MR system 1100c (shown in FIG. 11C-1) raises the HIPD 1142 to prepare for a swing in the MR game environment 1120. The MR device 1132, responsive to the user 1102 raising the HIPD 1142, causes the MR representation of the user 1122 to perform a similar action (e.g., raise a virtual object, such as a virtual sword 1124). In some embodiments, each device uses respective sensor data and/or image data to detect the user input and provide an accurate representation of the user 1102's motion. For example, image sensors (e.g., SLAM cameras or other cameras) of the HIPD 1142 can be used to detect a position of the HIPD 1142 relative to the user 1102's body such that the virtual object can be positioned appropriately within the MR game environment 1120; sensor data from the wrist-wearable device 1126 can be used to detect a velocity at which the user 1102 raises the HIPD 1142 such that the MR representation of the user 1122 and the virtual sword 1124 are synchronized with the user 1102's movements; and image sensors of the MR device 1132 can be used to represent the user 1102's body, boundary conditions, or real-world objects within the MR game environment 1120.

In FIG. 11C-2, the user 1102 performs a downward swing while holding the HIPD 1142. The user 1102's downward swing is detected by the wrist-wearable device 1126, the MR device 1132, and/or the HIPD 1142 and a corresponding action is performed in the MR game environment 1120. In some embodiments, the data captured by each device is used to improve the user's experience within the MR environment. For example, sensor data of the wrist-wearable device 1126 can be used to determine a speed and/or force at which the downward swing is performed and image sensors of the HIPD 1142 and/or the MR device 1132 can be used to determine a location of the swing and how it should be represented in the MR game environment 1120, which, in turn, can be used as inputs for the MR environment (e.g., game mechanics, which can use detected speed, force, locations, and/or aspects of the user 1102's actions to classify a user's inputs (e.g., user performs a light strike, hard strike, critical strike, glancing strike, miss) or calculate an output (e.g., amount of damage)).

FIG. 11C-2 further illustrates that a portion of the physical environment is reconstructed and displayed at a display of the MR device 1132 while the MR game environment 1120 is being displayed. In this instance, a reconstruction of the physical environment 1146 is displayed in place of a portion of the MR game environment 1120 when object(s) in the physical environment are potentially in the path of the user (e.g., a collision with the user and an object in the physical environment are likely). Thus, this example MR game environment 1120 includes (i) an immersive VR portion 1148 (e.g., an environment that does not have a corollary counterpart in a nearby physical environment) and (ii) a reconstruction of the physical environment 1146 (e.g., table 1151 and cup 1162). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 1126, the MR device 1132, and/or the HIPD 1142 are described as detecting user inputs, in some embodiments, user inputs are detected at a single device (with the single device being responsible for distributing signals to the other devices for performing the user input). For example, the HIPD 1142 can operate an application for generating the MR game environment 1120 and provide the MR device 1132 with corresponding data for causing the presentation of the MR game environment 1120, as well as detect the user 1102's movements (while holding the HIPD 1142) to cause the performance of corresponding actions within the MR game environment 1120. Additionally, or alternatively, in some embodiments, operational data (e.g., sensor data, image data, application data, device data, and/or other data) of one or more devices is provided to a single device (e.g., the HIPD 1142) to process the operational data and cause respective devices to perform an action associated with processed operational data.

In some embodiments, the user 1102 can wear a wrist-wearable device 1126, wear an MR device 1132, wear smart textile-based garments 1138 (e.g., wearable haptic gloves), and/or hold an HIPD 1142 device. In this embodiment, the wrist-wearable device 1126, the MR device 1132, and/or the smart textile-based garments 1138 are used to interact within an MR environment (e.g., any AR or MR system described above in reference to FIGS. 11A-11B). While the MR device 1132 presents a representation of an MR game (e.g., MR game environment 1120) to the user 1102, the wrist-wearable device 1126, the MR device 1132, and/or the smart textile-based garments 1138 detect and coordinate one or more user inputs to allow the user 1102 to interact with the MR environment.

In some embodiments, the user 1102 can provide a user input via the wrist-wearable device 1126, an HIPD 1142, the MR device 1132, and/or the smart textile-based garments 1138 that causes an action in a corresponding MR environment. In some embodiments, each device uses respective sensor data and/or image data to detect the user input and provide an accurate representation of the user 1102's motion. While four different input devices are shown (e.g., a wrist-wearable device 1126, an MR device 1132, an HIPD 1142, and a smart textile-based garment 1138) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 1138) sensor fusion can be utilized to ensure inputs are correct. While multiple input devices are described, it is understood that other input devices can be used in conjunction or on their own instead, such as but not limited to external motion-tracking cameras, other wearable devices fitted to distinct parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 1138 can be used in conjunction with an MR device and/or an HIPD 1142.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a separate set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 11A-1C-2 provided above are intended to augment the description provided in reference to FIGS. 1A-10D. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

1. A method, comprising:
while a hand of a user is holding a physical object having a surface:
in accordance with a determination, using data from one or more biopotential-signal sensors of a wrist-wearable device worn by the user, that the user is performing a gesture on the surface:
causing performance of an action at the wrist-wearable device or a communicatively coupled device; and
in accordance with a determination, using additional data from the one or more biopotential-signal sensors of the wrist-wearable device worn by the user, that the user is performing a digit-to-digit gesture using the hand:
causing performance of the action at the wrist-wearable device or the communicatively coupled device.

2. The method of claim 1, further comprising:
while a hand of a user is in contact with a surface of a stationary object external to the hand of the user:
in accordance with a determination, using data from the one or more biopotential-signal sensors of the wrist-wearable device worn by the user, that the user is performing a gesture on the surface of the stationary object external to the hand of the user:
causing performance of the action at the wrist-wearable device or a communicatively coupled device.

3. The method of claim 1, wherein:
the communicatively coupled device is display-less smart glasses,
the action is caused to be performed at the display-less smart glasses, and
an audio indication is provided, at the display-less smart glasses, indicating that the action was performed based on the gesture on the surface of the physical object.

4. The method of claim 1, further comprising:
while the hand of the user is holding the physical object:
determining, using data from a camera of a head-worn device worn by the user, a first object type of the physical object;
causing presentation via the head-worn device, of a first object-type-specific action, different than the action, associated with the first object type; and
in accordance with a determination, using data from the one or more biopotential-signal sensors of the wrist-wearable device worn by the user, that the user is performing another gesture on the surface of the physical object, the other gesture corresponding to the first object-type-specific action associated with the first object type, while the first object-type-specific action is being presented via the head-worn device:
causing performance of the other action at the wrist-wearable device or a communicatively coupled device.

5. The method of claim 4, further comprising:
while the hand of the user is holding another physical object having another surface:
determining, using data from the camera of the head-worn device worn by the user, a second object type of the other physical object, the second object type is distinct from the first object type;
causing presentation via the head-worn device, of a second object-type-specific action associated with the second object type; and
in accordance with a determination, using data from the one or more biopotential-signal sensors of the wrist-wearable device worn by the user, that the user is performing the other gesture on the other surface of the other physical object, while the second object-type-specific action is being presented via the head-worn device:
causing performance of the second object-type-specific action at the wrist-wearable device or a communicatively coupled device.

6. The method of claim 1, further comprising:
wherein the gesture on the surface of the physical object comprises one or more finger movements of:
a flexion of one or more digits,
a press of one or more digits,
a tap of one or more digits, or
a squeeze using two or more digits, and
the digit-to-digit gesture using the hand comprises the one or more finger movements.

7. The method of claim 1 wherein:
the determination that the user is performing a gesture on the surface of the physical object is further based on:
detecting a sequence of pulses of neuromuscular activity data from the one or more biopotential-signal sensors of the wrist-wearable device that are above a baseline level, wherein the sequence of pulses corresponds to a predetermined temporal pattern; and
determining that the sequence of pulses matches the predetermined temporal pattern associated with the action; and
wherein the determination that the user is performing a digit-to-digit gesture using the hand is further based on:
detecting the sequence of pulses of neuromuscular activity data from the one or more biopotential-signal sensors of the wrist-wearable device that are above the baseline level, wherein the sequence of pulses corresponds to the predetermined temporal pattern; and
determining that the sequence of pulses matches the predetermined temporal pattern associated with the action.

8. The method of claim 7, wherein:
the digit-to-digit gesture and the gesture on the surface are effector-specific such that they require at least one specific finger to be used for a respective portion of each gesture, and
the predetermined temporal pattern is effector-agnostic such that the sequence of pulses is detectable regardless of which finger or wrist muscle of the user generates the sequence of pulses.

9. A non-transitory, computer-readable storage medium including instructions that, when executed by a wearable device, cause the wearable device to perform:
while a hand of a user is holding a physical object having a surface:
in accordance with a determination, using data from one or more biopotential-signal sensors of a wrist-wearable device worn by the user, that the user is performing a gesture on the surface:
causing performance of an action at the wrist-wearable device or a communicatively coupled device; and
in accordance with a determination, using additional data from the one or more biopotential-signal sensors of the wrist-wearable device worn by the user, that the user is performing a digit-to-digit gesture using the hand:
causing performance of the action at the wrist-wearable device or the communicatively coupled device.

10. The non-transitory, computer-readable storage medium of claim 9, further comprising instructions for:
while a hand of a user is in contact with a surface of a stationary object external to the hand of the user:
in accordance with a determination, using data from the one or more biopotential-signal sensors of the wrist-wearable device worn by the user, that the user is performing a gesture on the surface of the stationary object external to the hand of the user:
causing performance of the action at the wrist-wearable device or a communicatively coupled device.

11. The non-transitory, computer-readable storage medium of claim 9, wherein:
the communicatively coupled device is display-less smart glasses,
the action is caused to be performed at the display-less smart glasses, and
an audio indication is provided, at the display-less smart glasses, indicating that the action was performed based on the gesture on the surface of the physical object.

12. The non-transitory, computer-readable storage medium of claim 9, further comprising instructions for:
while the hand of the user is holding the physical object:
determining, using data from a camera of a head-worn device worn by the user, a first object type of the physical object;
causing presentation via the head-worn device, of a first object-type-specific action, different than the action, associated with the first object type; and
in accordance with a determination, using data from the one or more biopotential-signal sensors of the wrist-wearable device worn by the user, that the user is performing another gesture on the surface of the physical object, the other gesture corresponding to the first object-type-specific action associated with the first object type, while the first object-type-specific action is being presented via the head-worn device:
causing performance of the other action at the wrist-wearable device or a communicatively coupled device.

13. The non-transitory, computer-readable storage medium of claim 12, further comprising instructions for:
while the hand of the user is holding another physical object having another surface:
determining, using data from the camera of the head-worn device worn by the user, a second object type of the other physical object, the second object type is distinct from the first object type;
causing presentation via the head-worn device, of a second object-type-specific action associated with the second object type; and
in accordance with a determination, using data from the one or more biopotential-signal sensors of the wrist-wearable device worn by the user, that the user is performing the other gesture on the other surface of the other physical object, while the second object-type-specific action is being presented via the head-worn device:
causing performance of the second object-type-specific action at the wrist-wearable device or a communicatively coupled device.

14. The non-transitory, computer-readable storage medium of claim 9, further comprising instructions for:
wherein the gesture on the surface of the physical object comprises one or more finger movements of:
a flexion of one or more digits,
a press of one or more digits,
a tap of one or more digits, or
a squeeze using two or more digits, and
the digit-to-digit gesture using the hand comprises the one or more finger movements.

15. The non-transitory, computer-readable storage medium of claim 9, wherein:
the determination that the user is performing a gesture on the surface of the physical object is further based on:
detecting a sequence of pulses of neuromuscular activity data from the one or more biopotential-signal sensors of the wrist-wearable device that are above a baseline level, wherein the sequence of pulses corresponds to a predetermined temporal pattern; and
determining that the sequence of pulses matches the predetermined temporal pattern associated with the action; and
wherein the determination that the user is performing a digit-to-digit gesture using the hand is further based on:
detecting the sequence of pulses of neuromuscular activity data from the one or more biopotential-signal sensors of the wrist-wearable device that are above the baseline level, wherein the sequence of pulses corresponds to the predetermined temporal pattern; and
determining that the sequence of pulses matches the predetermined temporal pattern associated with the action.

16. The non-transitory, computer-readable storage medium of claim 15, wherein:
the digit-to-digit gesture and the gesture on the surface are effector-specific such that they require at least one specific finger to be used for a respective portion of each gesture, and
the predetermined temporal pattern is effector-agnostic such that the sequence of pulses is detectable regardless of which finger or wrist muscle of the user generates the sequence of pulses.

17. A wrist-wearable device, comprising:
one or more biopotential-signal sensors;
one or more processors; and
memory storing one or more instructions, that when executed by the one or more processors, cause performance of operations corresponding to:
while a hand of a user is holding a physical object having a surface:
in accordance with a determination, using data from the one or more biopotential-signal sensors of the wrist-wearable device worn by the user, that the user is performing a gesture on the surface:
causing performance of an action at the wrist-wearable device or a communicatively coupled device; and
in accordance with a determination, using additional data from the one or more biopotential-signal sensors of the wrist-wearable device worn by the user, that the user is performing a digit-to-digit gesture using the hand:
causing performance of the action at the wrist-wearable device or the communicatively coupled device.

18. The wrist-wearable device of claim 17, further comprising instruction causing performance of operations corresponding to:
while a hand of a user is in contact with a surface of a stationary object external to the hand of the user:
in accordance with a determination, using data from the one or more biopotential-signal sensors of the wrist-wearable device worn by the user, that the user is performing a gesture on the surface of the stationary object external to the hand of the user:
causing performance of the action at the wrist-wearable device or a communicatively coupled device.

19. The wrist-wearable device of claim 17, wherein:
the communicatively coupled device is display-less smart glasses,
the action is caused to be performed at the display-less smart glasses, and
an audio indication is provided, at the display-less smart glasses, indicating that the action was performed based on the gesture on the surface of the physical object.

20. The wrist-wearable device of claim 17, further comprising instruction causing performance of operations corresponding to:
while the hand of the user is holding the physical object:
determining, using data from a camera of a head-worn device worn by the user, a first object type of the physical object;
causing presentation via the head-worn device, of a first object-type-specific action, different than the action, associated with the first object type; and
in accordance with a determination, using data from the one or more biopotential-signal sensors of the wrist-wearable device worn by the user, that the user is performing another gesture on the surface of the physical object, the other gesture corresponding to the first object-type-specific action associated with the first object type, while the first object-type-specific action is being presented via the head-worn device:
causing performance of the other action at the wrist-wearable device or a communicatively coupled device.
